(19) United States
(12) Patent Application Publication
(10) Pub. No.: US 2022/0329900 A1
(43) Pub. Date: Oct. 13, 2022

(54) Optical Data Interconnect System

(71) Applicant: WINGCOMM Co. Ltd., Nantong (CN)

(72) Inventors: Yun Bai, Beijing (CN); Wei Mao, Palo Alto, CA (US); Zuodong Wang, Beijing (CN); Jianming Yu, Nantong (CN)

(21) Appl. No.: 17/853,379

(22) Filed: Jun. 29, 2022

Related U.S. Application Data
(63) Continuation-in-part of application No. 17/553,437, filed on Dec. 16, 2021.
Application No. 17/553,437 is a continuation-in-part of application No. 16/817,219, filed on Mar. 12, 2020, now Pat. No. 11,233,569.
(60) Provisional application No. 62/817,225, filed on Mar. 12, 2019.

(51) Int. Cl. H04N 21/4363; H04B 10/50; H04B 10/60

(52) U.S. Cl. CPC H04N 21/43635; H04B 10/50; H04B 10/60

(57) ABSTRACT

Systems and methods for optical data interconnection are described. One aspect includes detecting a first HDMI connection of a first terminal of an optical connector. A second HDMI connection of a second terminal of the optical connector may be detected. One aspect includes determining that the first HDMI connection is associated with an HDMI source, and determining that the second HDMI connection is associated with an HDMI sink. Responsive to determining that the first HDMI connection is associated with the HDMI source, an HDMI transmission mode is selected for the first terminal. Responsive to determining that the second HDMI connection is associated with the HDMI sink, an HDMI reception mode is selected for the second terminal. The first terminal and the second terminal may perform HDMI optical communication via an optical communication channel.

### CROSS-REFERENCE TO RELATED APPLICATIONS

This application is a continuation-in-part of U.S. patent application Ser. No. 17/553,437, filed Dec. 16, 2021, titled “Optical Data Interconnect System” which is incorporated herein by reference in its entirety.

That application is a continuation-in-part of U.S. patent application Ser. No. 16/817,219, now U.S. Pat. No. 11,233,569, filed Mar. 12, 2020, titled “Optical Data Interconnect System” which is incorporated herein by reference in its entirety.

That application claims priority to U.S. Provisional Patent Application Ser. No. 62/817,225, filed Mar. 12, 2019, titled “Optical Data Interconnect System” which is incorporated herein by reference in its entirety, including but not limited to those portions that specifically appear hereinafter The incorporation by reference is made with the following exception: In the event that any portion of the above-referenced application is inconsistent with this application, this application supersedes the above-referenced application.

### TECHNICAL FIELD

The present disclosure relates to system for optical interconnect. In particular, a system and method for emulating electrical HDMI interconnects with an optical system is described.

### BACKGROUND

High Definition (HD) signals are typically transmitted from one system to another using cables carrying DVI (Digital Video Interface) or HDMI (High Definition Multimedia Interface) signals. Conventionally, DVI/HDMI signals are conveyed over copper cables using a form of differential signaling called Transition Minimized Differential Signaling (TMDS). In TMDS, video, audio, and control data can be carried on three TMDS data channels with a separate TMDS channel for clock information. Recently HDMI 2.1 introduced another differential signaling form called Fixed Rate Link (FRL) to replace TMDS for delivering higher uncompressed resolutions such as 8K60 Hz. Unfortunately, when cable length reaches or exceeds a specified distance (e.g., 5 meters or greater), the impedance of copper cable can cause sufficient signal loss resulting in artifacts, such as, pixelation, optical flashing or sparkling, or even loss of picture. Artifacts due to signal loss can be mitigated by passive connection designs that include large or well-shielded copper cables. However, these types of copper cables can be costly, bulky, and can limit cable flexibility. Alternatively, active electronic modules such as signal boosters can be used to reduce signal loss, but these techniques are also costly and can introduce other signal errors.

### SUMMARY

One embodiment implements an optical communication cable (or other communication apparatus). The optical communication cable can include a first electrical connector configured to receive first electrical signals from an HDMI source. The first electrical signals can include first high-speed HDMI electrical signals and first low-speed HDMI electrical signals. The optical cable can include a first signal converter configured to receive the first high-speed HDMI electrical signals. The first signal converter can convert the first high-speed HDMI electrical signals into high-speed HDMI optical signals and transmit the high-speed HDMI optical signals over a first optical communication channel. The first optical communication channel can include a plurality of optical fibers.

The optical communication cable can include a second signal converter configured to receive the first low-speed HDMI electrical signals. The second signal converter can encode the first low-speed HDMI electrical signals, convert the encoded first low-speed HDMI electrical signals into low-speed HDMI optical signals, and transmit the low-speed HDMI optical signals over a second optical communication channel. The second optical communication channel can include a plurality of optical fibers.

The optical communication cable can include a third signal converter configured to receive the high-speed HDMI optical signals via the first optical communication channel, and convert the high-speed HDMI optical signals to second high-speed HDMI electrical signals;

The optical communication cable can include a fourth signal converter configured to receive the low-speed HDMI optical signals via the second optical communication channel, convert the low-speed HDMI optical signals to second low-speed HDMI electrical signals, and decode the second low-speed HDMI electrical signals.

The optical communication cable includes a second electrical connector configured to receive the second high-speed HDMI electrical signals and the decoded second low-speed HDMI electrical signals, and collectively transmit these signals to an HDMI sink as second HDMI electrical signals.

Some embodiments may include methods to implement the above apparatus embodiment.

Another embodiment implements a method to perform HDMI optical communication. One aspect includes detecting a first HDMI connection of a first terminal of an optical connector. The first terminal may be configured to be selectable between a transmission mode and a reception mode. A second HDMI connection of a second terminal of the optical connector may be detected. The second terminal may be configured to be selectable between a transmission mode and a reception mode.

The method may include determining that the first HDMI connection is associated with an HDMI source, and that the second HDMI connection is associated with an HDMI sink. Responsive to determining that the first HDMI connection is associated with the HDMI source, an HDMI transmission mode may be selected for the first terminal. Responsive to determining that the second HDMI connection is associated with the HDMI sink, an HDMI reception mode may be selected for the second terminal. HDMI optical communication may be performed between the first terminal and the second terminal via an optical communication channel.

Some embodiments may include apparatuses to implement the above method embodiment.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates an optical interconnect system;

FIG. 2 illustrates a method of operating an optical interconnect system;

FIG. 3 illustrates an optical interconnect system with external power; and

FIG. 4 illustrates a bi-directional optical interconnect system.

FIG. 5A illustrates one embodiment of an optical interconnect system that converts HDMI standard TMDS or FRL signals to optical signals and includes a rechargeable battery;

FIG. 5B illustrates one embodiment of an optical interconnect system that converts HDMI standard TMDS or FRL signals to optical signals that includes a power tapping circuit without a battery;

FIG. 5C illustrates one embodiment of an optical interconnect system that converts control or other signals to optical signals;

FIG. 6A illustrates all optical connections for data and control connections for an HDMI compatible interconnect;

FIG. 6B illustrates optical data connections, electrical control connections, and an electrical power connection for an HDMI compatible interconnect;

FIG. 6C illustrates all optical data and control connections and an electrical power connection for an HDMI compatible interconnect; and

FIG. 7 illustrates one embodiment of an HDMI connector according to the disclosure.

FIG. 8 illustrates one embodiment of an optical interconnect system.

FIG. 9 illustrates one embodiment of an HDMI optical receiver interface.

FIG. 10 illustrates one embodiment of an HDMI optical receiver interface.

FIG. 11 is a flow diagram illustrating an embodiment of a method to connect a power signal.

FIG. 12 is a flow diagram illustrating an embodiment of a method to connect a power signal.

FIG. 13 is a block diagram depicting an embodiment of an optical transmitter interface.

FIG. 14 is a block diagram depicting an embodiment of an optical receiver interface.

FIG. 15 is a block diagram depicting an embodiment of an optical transmitter interface.

FIG. 16 is a block diagram depicting an embodiment of an optical receiver interface.

FIG. 17 is a block diagram depicting an embodiment of an optical connector.

FIG. 18 is a block diagram depicting an embodiment of a direction control circuit low-speed interface.

FIG. 19 is a block diagram depicting an embodiment of a direction control circuit high-speed interface.

FIG. 20 is a block diagram depicting an embodiment of a direction control circuit low-speed interface.

FIG. 21 is a block diagram depicting an embodiment of a direction control circuit high-speed interface.

FIG. 22 is a block diagram depicting an embodiment of a direction control circuit low-speed interface.

FIG. 23 is a block diagram depicting an embodiment of a direction control circuit low-speed interface.

FIG. 24 is a block diagram depicting an embodiment of a direction control circuit low-speed interface.

FIG. 25 is a block diagram depicting an embodiment of a direction control circuit low-speed interface.

FIG. 26 is a block diagram depicting an embodiment of a direction control circuit low-speed interface.

FIG. 27 is a block diagram depicting an embodiment of a direction control circuit low-speed interface.

FIG. 28 is a flow diagram depicting a method to transmit high-speed HDMI optical signals and low-speed HDMI optical signals.

FIG. 29 is a flow diagram depicting a method to receive high-speed HDMI optical signals and low-speed HDMI optical signals.

FIG. 30 is a flow diagram depicting a method to perform HDMI communication via an optical communication channel.

### DETAILED DESCRIPTION

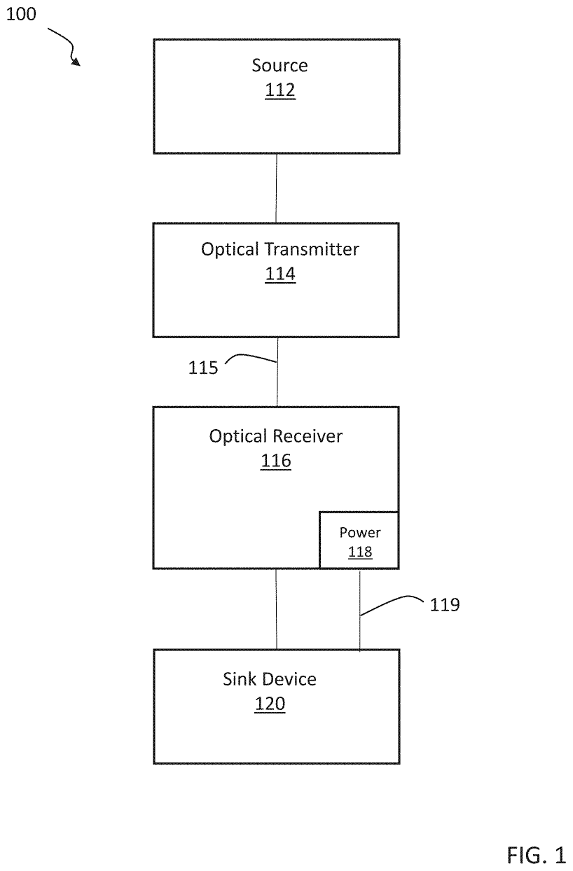

As seen in FIG. 1, an optical interconnect system 100 capable of supporting conversion of electrical signals to optical signals, and back to electrical signals is illustrated. A signal source 112 is connected to an optical transmitter 114 that acts as a first signal converter to convert electrical signals received from the signal source 112 into optical signals. One or more optical fibers 115 are used to transfer optically encoded data to an optical receiver 116. The optical receiver decodes and acts as a second signal converter to convert the data to electrical signals that are provided to a sink device 120. The optical receiver 116 can include a separate power module 118, which in at least one embodiment is connected via electrical power connection 119 to the sink device.

Various signaling protocols are supported by the optical interconnect system. In some embodiments, electrical signals can be provided in a first protocol by source 112 and converted to a second protocol by the optical receiver 116. In other embodiments, electrical signals can be provided in a first protocol by source 112 and converted back to the same protocol by the optical receiver 116.

In one particular embodiment, HDMI 1.4b/1.4, HDMI 2.0b/2.0, HDMI 2.1, or other suitable HDMI protocols can be supported. HDMI 1.4b/1.4 supports 4K (3840×2160 pixels) video at 30 frames per second, while HDMI 2.0b/2.0 supports 4K video at 60 frames per second, with a bit rate of up to 18 Gbps. The latest HDMI 2.1 supports 8K video at 60 frames per second and 4K video at 120 frames per second, with a bit rate of up to 48 Gbps. HDMI is based on HDMI standard TMDS or FRL serial links for transmitting video and audio data. Typically, the HDMI interface is provided for transmitting digital television audiovisual signals from DVD players, game consoles, set-top boxes and other audiovisual source devices to other HDMI compatible devices, such as television sets, displays, projectors and other audiovisual devices. HDMI can also carry control and status information in both directions.

In other embodiments, other connectors and protocols can be supported, including but not limited to serial or parallel connectors, Digital Video Interface (DVI), other suitable connectors such as those based on LVDS, DisplayPort, USB-C or SATA In some embodiments, alternative encoding systems can be used. For example, TMDS serial links can be replaced with low density parity check (LDPC) code for video data. Alternatively, or in addition, a variable length and rate Reed-Solomon (RS) code can be used for audio and control information to provide error protection. Advantageously, such codes require no additional overhead for DC-balancing or transition minimization, resulting in an increased data rate as compared to TMDS encoded signals.

In one embodiment, source 112 can include, for example, DVD players, game consoles, smartphones, set-top boxes, telephones, computers, audio systems, or other network client devices. Source 112 can playback media data stored in a hard drive, a spinnable disk (e.g. Blu-ray or DVD), or held in solid state storage. In other embodiments, the source 112 can receive data through wired or wireless connection to cable providers, satellite systems, or phone networks. Similarly, sink device 120 can also be televisions, monitors, displays, audio systems, projectors, or other network client devices.

In one embodiment, the optical transmitter 114 can convert HDMI standard TMDS or FRL electrical signals using an optical conversion device connected to ground to reduce noise. Typically, this can be a laser diode driver (LDD). The optical conversion driver device can include an infrared or optical LED, semiconductor laser, or VCSEL device.

Advantageously, use of optical fiber 115 and elimination of electrical wired connection both provides electrical isolation and greatly improved signal. The optical fiber 115 is well suited for using consumer or household environments, as well as in electrically active, wet, or moist environments such as are found in industrial, manufacturing, automobile, trucking, shipping, and avionics. In one embodiment, the optical fiber 115 includes one or more multi-mode optical fibers protected by braided fiber or plastic sheathing or other suitable covering. If complete electrical isolation is not required, in another embodiment one or more low voltage electrical wires are also supported to provide power or control signals.

In one embodiment, the optical receiver 116 can convert optical signals to HDMI standard TMDS or FRL or other suitable electrical signals. The optical receiver 116 can include a photo detector and an optical receiver that convert light impulses to an electrical signal. In some embodiments, a transimpedance amplifier (TIA) or other suitable signal amplification system can be used to increase signal power, and a PD (photodiode) or an APD (avalanche photodiode) can be used to convert optical signals to electrical currents.

Power from power module 118 to operate the optical receiver 116 can be provided by connection to the sink device 120, by connection to a second power port or another external power source (not shown), or by an internal battery source. In some embodiments, a sink device can support multiple connector types (HDMI, DisplayPort, USB, USB-C, DC power connector) that can be used as external secondary power sources and/or internal battery charging stations. In those embodiments that support source HDMI to sink HDMI connections, both power to operate optical receiver 116 and additional power to emulate an electrical HDMI connection can be required since conventional HDMI connectable devices require a DC connection between the source 112 and a grounded sink device 120 to complete the circuit. This DC connection creates a current return path from the sink device 120 to the source 112. Since this connection is typically provided through internal shields covering the individual twisted wire pairs and a covering braid shield that are not available in a dedicated optical interconnect system, an additional power source is needed.

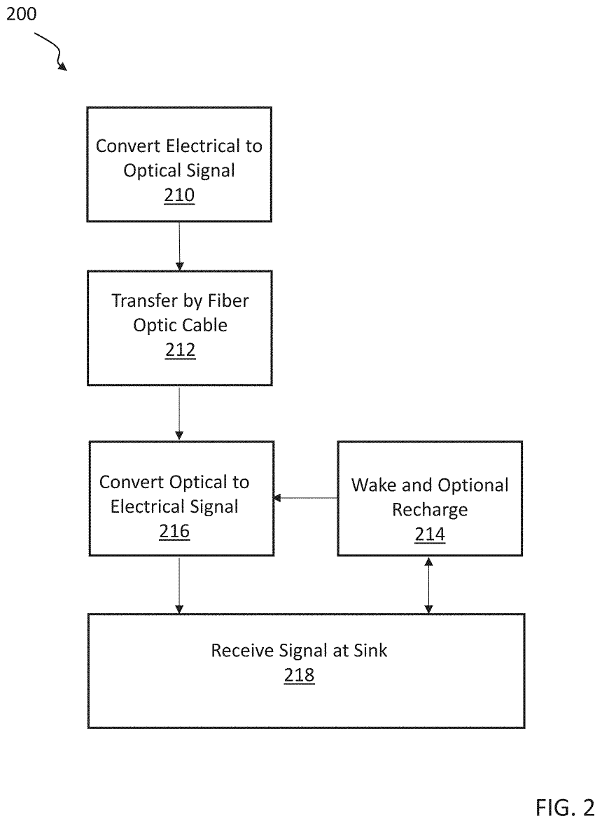

FIG. 2 illustrates a method 200 for interconnecting a source and a sink. Electrical signals from the source are converted to an optical signal (step 210) using a driver device for an infrared or optical LED, semiconductor laser, or VCSEL device. The optical signal is injected into a fiber optic cable and transferred (step 212). The transferred optical system is converted to an electrical signal (step 216) that is received by a sink (step 218). In order to ensure conversion of the electrical signal, plugging into the sink or connection to another external power source can supply power, wake signal conversion microprocessors or other electronics, and charge optional batteries (step 214).

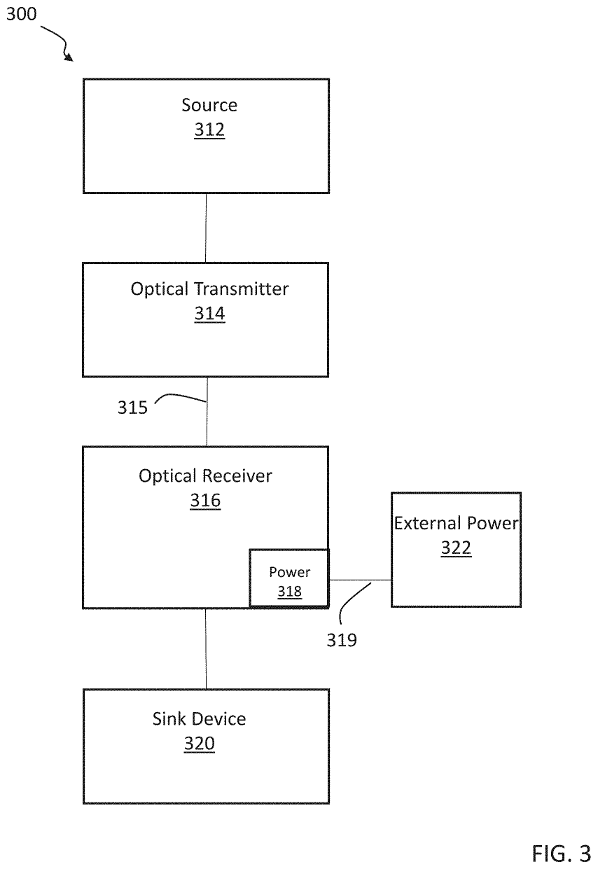

FIG. 3 illustrates an optical interconnect system with external power. In this embodiment a signal source 312 is connected to an optical transmitter 314 that converts electrical signals received from the signal source 312. One or more optical fibers 315 are used to transfer optically encoded data to an optical receiver 316. The optical receiver decodes and converts the data to electrical signals that are provided to a sink device 320. The optical receiver 316 can include a separate power module 318, which in at least one embodiment is provided by electrical power connection 319 to an external power module 322. In some embodiments the power module can be provided via other ports or power supplies on the sink device (e.g. a USB port), while in other embodiments power can be supplied by another device (e.g. a power over ethernet connection from a network switch) or a suitable direct power supply.

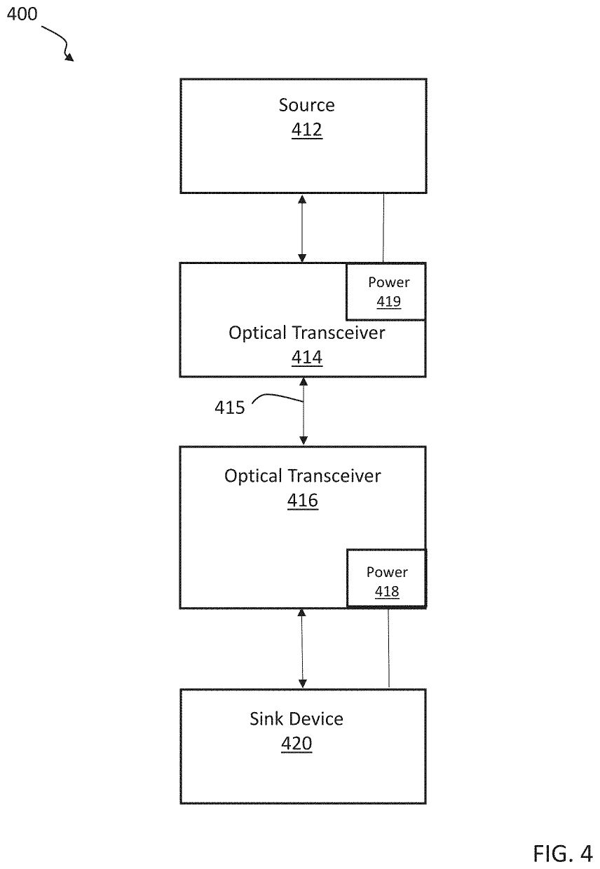

FIG. 4 illustrates a bi-directional optical interconnect system 400 capable of supporting conversion of electrical signals to optical signals, and back to electrical signals. In a first direction of data transfer, signal source 412 is connected to an optical transceiver 414 that converts electrical signals received from the signal source 412. One or more optical fibers 415 are used to transfer optically encoded data to an optical transceiver 416. The optical transceiver 416 decodes and converts the data to electrical signals that are provided to a sink device 420. A return signal from the sink device 420 to source 412 is also supported.

Both the optical transceiver 414 and 416 can include a respective separate power module 419 and 418. In at least one embodiment an electrical power connection can be made from power module 418 to the sink device 420. Similarly, an electrical power connection can be made to the source device 412 from the power module 419.

In one embodiment optical fiber can used for data transmission from the source device to the sink device. Additional optical fiber can be used for the transmission of a return signal from the sink device 420 to the source device 412. Such bi-directional signal functionality allows fuller support of the HDMI specification, including channels supporting low data-rate remote control commands, audio return from sink device to source, ethernet communication, and hot plug detection. Such data channels can include, but not limited to, a Consumer Electronics Control (CEC), an Audio Return Channel (ARC) or Enhanced Audio Return Channel (eARC), a HDMI Ethernet Channel (HEC) and a Hot Plug Detect (HPD). CEC allows a user to use a single remote to control multiple devices coupled together via HDMI cables. More specifically, a unique address is assigned to the connected group of devices, which is used for sending remote control commands to the devices. ARC or eARC is an audio link meant to replace other cables between sink device and source that allows source to reproduce the audio output from the sink device without using other cables. HEC enables IP-based applications over HDMI and provides a bidirectional Ethernet communication. HPD allows the source to sense the presence of sink device and reinitiates link if necessary.

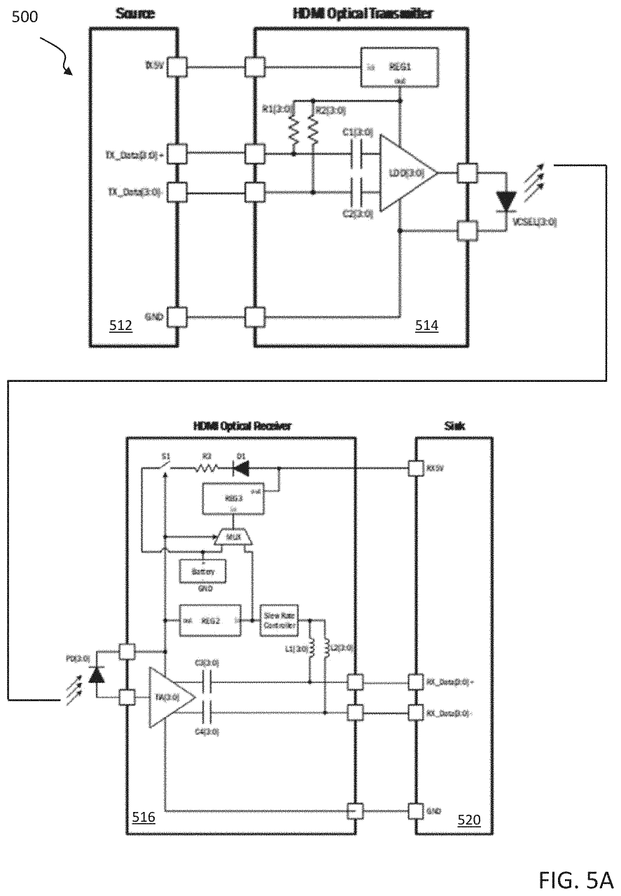

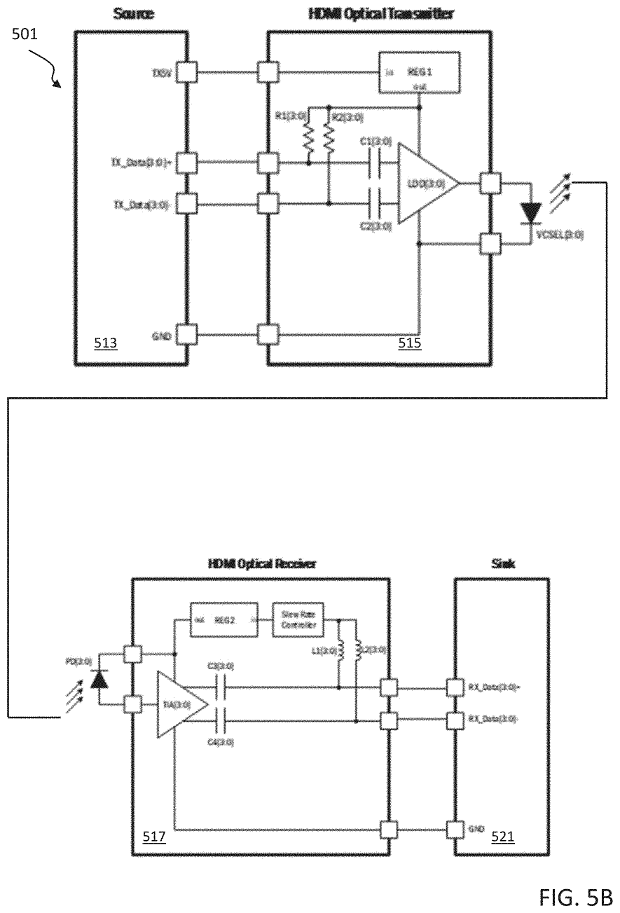

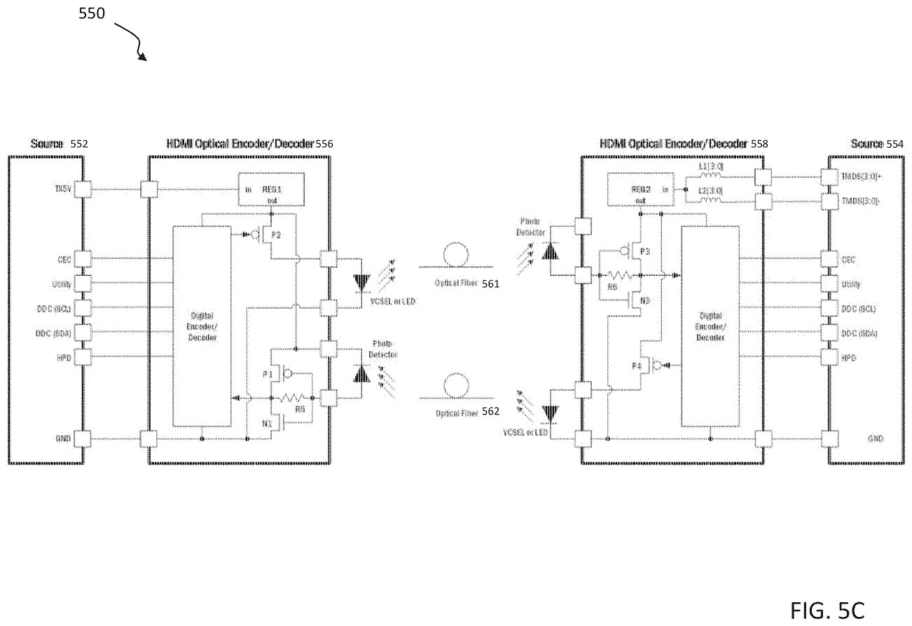

FIG. 5A illustrates one embodiment of HDMI optical fiber data connection system 500 that includes electrical to optical, and subsequent optical to electrical conversion. This embodiment can substantially replace a conventional electrical HDMI interface having two identical connectors attached to opposite ends of a cable. Such cables typically include four shielded twisted pairs of copper wires and seven separate copper wires for communicating various information. Four of the shielded twisted wire pairs are adapted to communicate relatively high-speed data and clock in the form of Transition Minimized Differential Signaling (HDMI standard TMDS or FRL). In HDMI 2.0b and previous HDMI standards, three pairs are used for communicating video, audio, and auxiliary data, and are typically referred to as D0-D2. The last pair is used for transmitting a clock associated with the data, and is typically referred to as CLK. In HDMI 2.1, all four pairs are used for communicating video, audio and auxiliary data, and are typically referred to as D0-D3. The speed of the high-speed data may range from 3 to 12 gigabits per second (Gbps) per lane. The remaining seven separate wires are used for communicating relatively low-speed data, such as in the range of 100 kilobits per second (kbit/s) to 400 kbit/s. Two of such wires are referred to as Display Data Channel (DDC) for providing communication between devices using a communication channel that adheres to an I²C bus specification. One of the DDC wire pair, typically referred to as DDC DATA, is used to communicate data between the devices. The other DDC wire pair, typically referred to as DDC CLK, is used to transmit a clock associated with the data. The other five of the seven separate wires are CEC, utility, HPD, 5V power and ground.

In operation, the respective HDMI standard TMDS or FRL, DDC, and other electrical signals from source 512 are provided to a transmitter 514 housed in an HDMI compatible connector. Using a laser diode driver (LDD) and a semiconductor laser or LED diode powered by voltage regulator REG1, an optical signal is generated and transferred to a photodetector and HDMI standard TMDS or FRL receiver 516 housed in another HDMI compatible connector. The HDMI standard TMDS or FRL receiver includes a transimpedance amplifier (TIA) connected to amplify the photodetector signal. The amplified electrical signals corresponding to the originally provided HDMI standard TMDS or FRL, DDC, and other electrical signals are sent to a television, display, or other suitable sink 520.

In one embodiment, electrical power is supplied to the HDMI standard TMDS or FRL receiver through an electrical tap of the HDMI standard TMDS or FRL port by inductors L1 and L2 (or other suitable electrical filtering circuit element such as ferrite beads) connected to a voltage regulator (REG2). The voltage regulator REG2 is connected to ground to reduce noise and acts to convert the voltage to the required operating voltage or voltages for a transimpedance amplifier that receives optical signals and converts them to electrical signals.

In some commercially available embodiments however, this mechanism will not work unassisted, since application of a specific voltage power is required to enable or otherwise trigger provision of power to the HDMI connection and connected electronics from sink 520.

For embodiments that require power triggering of the HDMI connection, a rechargeable battery, supercapacitor, or similar charge bank can be used to supply an initial 5-volt charge via regulator (REG3) to the 5V pin on the HDMI port (RX5V) of the sink 520. After triggering activation of the HDMI port, the electrical tap by inductors L1 and L2 (or other suitable electrical filtering circuit element such as ferrite beads) can be used to charge the battery or other power source. In operation, when the HDMI connector is not plugged into the sink 520, an enable pin “en” of REG3 is kept as open circuit and pulled to ground by resistor R4. Therefore, REG3 is turned off and thus does not draw current from the battery. When the HDMI connector is plugged into the sink 520 (e.g. a TV or display), the CEC pin or other appropriate pins, such as DDC, is connected to REG3 “en”, which has certain voltage, e.g. 3.3V. REG3 is turned on and up-converts the battery voltage, e.g. 1.5V, to 5V. When the “5V” pin of the sink 520 is pulled to 5V, it starts to power the HDMI standard TMDS or FRL + and HDMI standard TMDS or FRL − ports. Inductors L1 and L2 block the AC signal provided by HDMI standard TMDS or FRL data connections and pass through the DC voltage (e.g. 2V) from HDMI standard TMDS or FRL ports to REG2 “in”. REG2 up-converts or down-converts this voltage to the necessary voltage or voltages for the TIA to operate. Once REG2 starts to output a voltage, it switches the MUX input so that REG3 “in” is connected to REG2 “in”. It also closes switch Si and REG3 “out” starts to charge the battery.

Effectively, operation of the described circuit allows for the rechargeable battery supplying power to the 5V pin on the HDMI port of the sink 520 (RX5V) to be controlled to prevent battery dissipation when HDMI connector is unplugged. The rechargeable battery only operates when the cable is first plugged into the sink 520. After the sink 520 starts to power the HDMI standard TMDS or FRL ports, the rechargeable battery stops output current and instead is switched into a recharge mode.

Alternatively, FIG. 5B illustrates one embodiment of an optical interconnect system 501 similar to that discussed with respect to FIG. 5A that converts HDMI standard TMDS or FRL signals to optical signals that includes a power tapping circuit without a battery. In operation, the respective HDMI standard TMDS or FRL, DDC, and other electrical signals from source 513 are provided to a transmitter 515 housed in an HDMI compatible connector. Using a laser diode driver (LDD) and a semiconductor laser or LED diode powered by voltage regulator REG1, an optical signal is generated and transferred to a photodetector and HDMI standard TMDS or FRL receiver 517 housed in another HDMI compatible connector. The HDMI standard TMDS or FRL receiver includes a transimpedance amplifier (TIA) connected to amplify the photodetector signal. The amplified electrical signals corresponding to the originally provided HDMI standard TMDS or FRL, DDC, and other electrical signals are sent to a television, display, or other suitable sink 521. In addition, the described circuit includes a slew rate controller to control ramp up time of current draw of REG2 from the power taps on the high speed differential signal RX_Data[3:0]. If this ramp up time is too short, the DC voltage on RX_Data[3:0] can drop to such a low level that REG2 stops working. This is prevented by the slew rate controller regulating the ramp up time to be slow enough to ensure the proper power tapping on RX_Data[3:0].

FIG. 5C illustrates one embodiment of an optical interconnect system 550 that converts both HDMI standard TMDS or FRL and control or other non− HDMI standard TMDS or FRL signals to optical signals. HDMI protocol requires bi-directional communication channels between source 552 and sink 554 for successful video/audio transmission and reception, which include but not limited to CEC, Utility, DDC (SCL), DDC (SDA), Ground, 5V Power and HPD. In the embodiment of FIG. 5B, all communication channels between source 552 and sink 554 are aggregated onto two optical fibers. An optical fiber 561 carries data from source 552 to sink 554, while an optical fiber 562 carries data from sink 554 to source 552, thus establishing bidirectional communication. Digital signal processing are realized by Digital Encoder/Decoder 1 (DED1 556) on the source side and Digital Encoder/Decoder 2 (DED 558) on the sink side. DED1 556 and 558 can either combine multiple communication channels into single aggregated channel or separate single aggregated channel into multiple communication channels. As illustrated, P2 is a current source that is powered by REG1 “out” and modulated by DED1 and drives a VCSEL or LED diode. REG1 in FIG. 5B operates in a manner similar to REG 1 as seen in FIG. 5A. P1, N1 and R5 form a transimpedance amplifier that is powered by REG1 “out” and buffers a photodetector's output into DED1. Similarly, P4 is a current source that is powered by REG2 “out” and modulated by DED2 and drives a VCSEL or LED diode. REG2 in FIG. 5B operates in a manner similar to REG2 as seen in FIG. 5A that utilizes inductive power tapping from the HDMI standard TMDS or FRL ports. P3, N3 and R6 form a transimpedance amplifier that is powered by REG2 “out” and buffers a photodetector's output into DED2. In this embodiment, multiple HDMI communication channels are replicated on both source and sink sides using only two optical fibers.

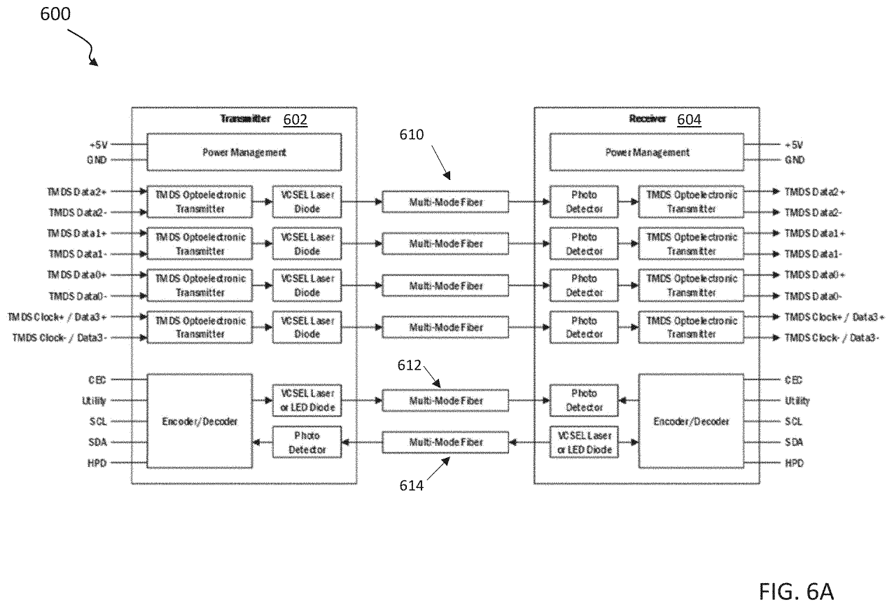

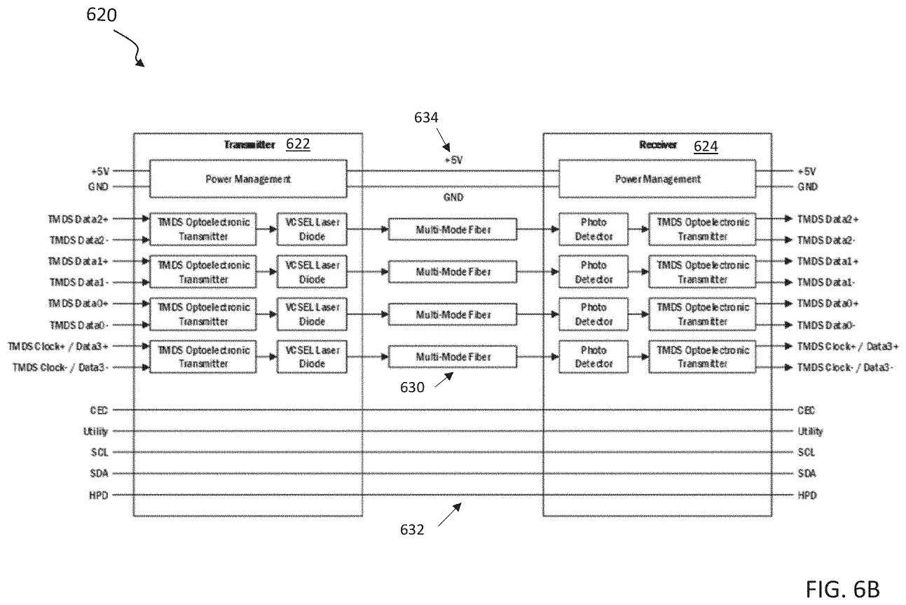

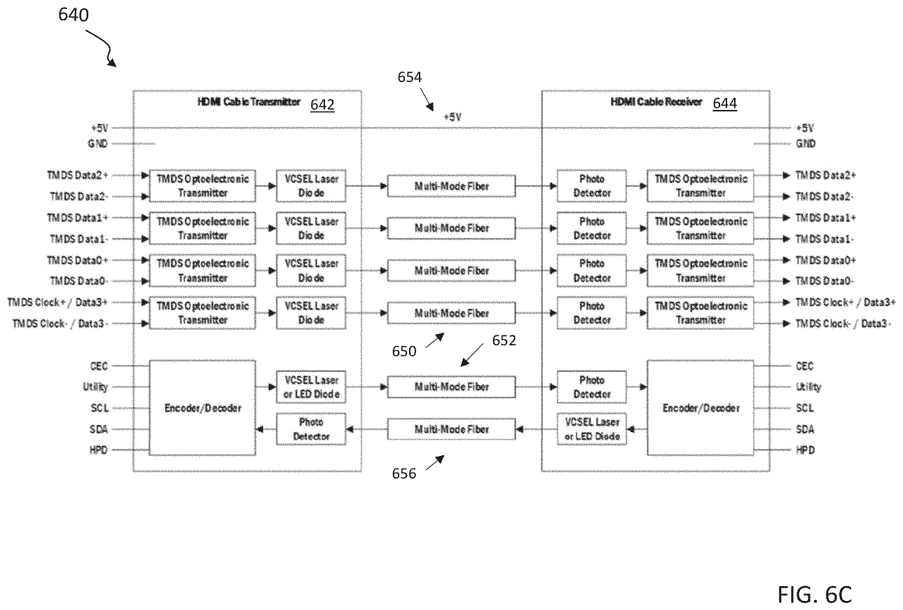

FIG. 6A illustrates one embodiment of a HDMI compatible fully optical interconnect system 600. As illustrated, multiple multi-mode optical fiber cables 610 and 612 are used to transmit data from a transmitter 602 to a receiver 604, and at least one multi-mode optical fiber 614 that transmits signals back from the receiver 604 to the transmitter 602. In the transmitter 602, electrical HDMI standard TMDS or FRL and non-HDMI standard TMDS or FRL data are converted to optical pulses using VCSEL laser or LED diodes. A photodetector and associated circuits are used to convert received optical pulses from optical fiber 614 to electrical signals that can be processed by a connected source (not shown). The receiver 604 has multiple photodetectors and respectively connected HDMI standard TMDS or FRL optoelectronic transmitters to convert received optical pulses from optical fiber 610 and 612 to electrical signals that can be processed by a connected sink (not shown). The receiver 604 also includes a VCSEL laser or LED diode connected to an encoder/decoder to convert electrical signals to optical signals that can be sent to the transmitter 602.

FIG. 6B illustrates one embodiment of a HDMI compatible hybrid electrical and optical interconnect system 620. As illustrated, multiple multi-mode optical fiber cables 630 are used to transmit data from a transmitter 622 to a receiver 624. In the transmitter 622, electrical HDMI standard TMDS or FRL data is converted to optical pulses using VCSEL laser or other laser diodes. A photodetector and associated circuits are used to convert received optical pulses from optical fiber 634 to electrical signals that can be processed by a connected source (not shown). The receiver 624 has multiple photodetectors and respectively connected HDMI standard TMDS or FRL optoelectronic transmitters to convert received optical pulses from optical fiber 630 to electrical signals that can be processed by a connected sink (not shown). In addition to the optical connections, the system 620 also supports electrical wired connection 632 for various control and data signals. As will be understood, these connections can be unidirectional or bidirectional between transmitter 622 and receiver 624. In addition, the system includes an electrical power connection 634 connecting respective power management units of transmitter 622 and receiver 624. Advantageously, because power is available, power triggering of the HDMI connection and their associated electronics and battery systems such as described with respect to the embodiment illustrated in FIG. 5 are not necessary.

FIG. 6C illustrates all optical data connections and an electrical power connection for an HDMI compatible interconnect system 640. As illustrated, multiple multi-mode optical fiber cables 650 and 652 are used to respectively transmit data and control data from a transmitter 642 to a receiver 644, and as well as at least one multi-mode optical fiber 656 that transmits signals back from the receiver 644 to the transmitter 642. In the transmitter 642, electrical HDMI standard TMDS or FRL data is converted to optical pulses using VCSEL laser or LED diodes. The receiver 644 has multiple photodetectors and respectively connected HDMI standard TMDS or FRL optoelectronic transmitters to convert received optical pulses from optical fiber 650 and 652 to electrical signals that can be processed by a connected sink (not shown). The receiver 644 also includes a VCSEL laser or LED diode connected to an encoder/decoder to convert electrical signals to optical signals that can be sent to the transmitter 642 along multi-mode optical fiber 656. In addition, the system includes an electrical power connection 654 connecting transmitter 642 and receiver 644. Advantageously, because power is available, power triggering of the HDMI connection and their associated electronics and battery systems such as described with respect to the embodiment illustrated in FIG. 5 are not necessary. However, in certain embodiments, a power tap on HDMI standard TMDS or FRL ports (e.g. using inductors and regulators) can still be used to power the HDMI standard TMDS or FRL receiver or other associated circuitry.

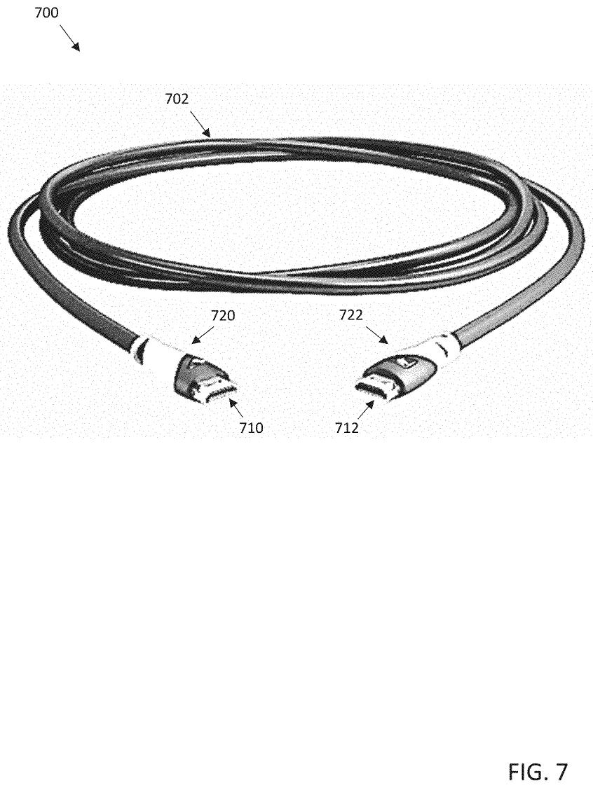

FIG. 7 illustrates one embodiment of a HDMI compatible interconnect system 700 including bundled and loosely looped optical cables 702, and source 710 and sink 712 HDMI connectors. Signal converters 720 and 722 include housing and board layout for HDMI standard TMDS or FRL receiver, as well as other electronics supporting electrical to optical conversion or optical to electrical conversion and are located adjacent to respective HDMI connector 710 and 712.

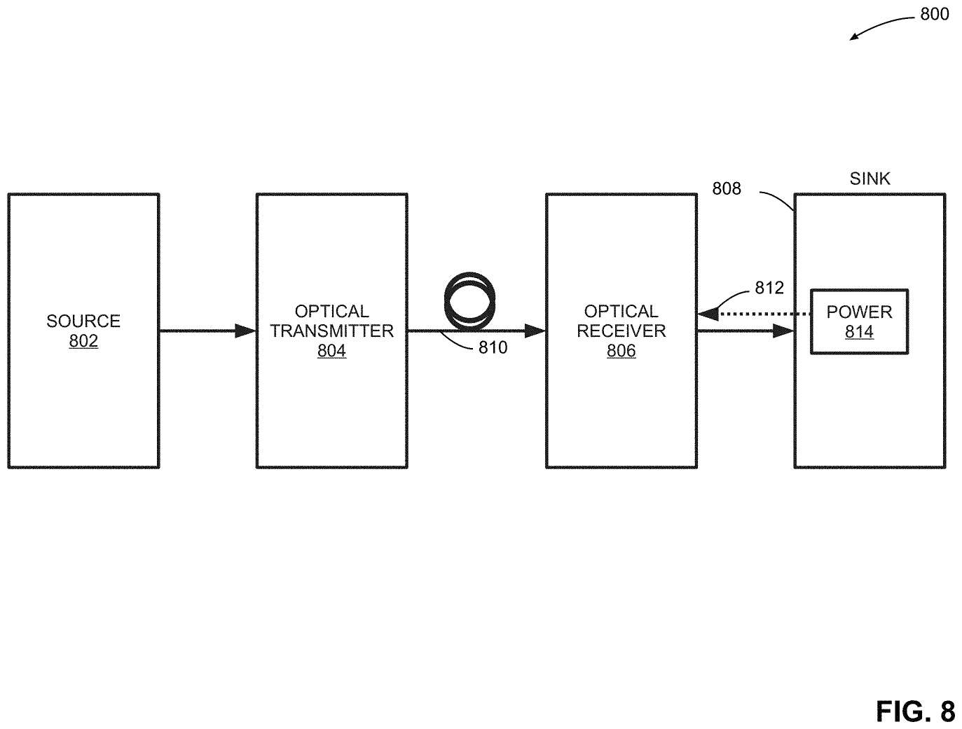

FIG. 8 illustrates one embodiment of an optical interconnect system 800. As depicted, optical interconnect system 800 includes a source 802, an optical transmitter 804 connected to an optical receiver 806 via an optical communication channel 810, and a sink 808. Sink 808 may further include a power module, depicted as power 814. In general, power 814 can be configured to supply electrical power to optical receiver 806.

Source 802 may be similar to source 112, optical transmitter 802 may be similar to optical transmitter 114, optical receiver 806 may be similar to optical receiver 116, sink 808 may be similar to sink 120, and optical communication channel 810 may be similar to optical fiber(s) 115.

Optical interconnect system 800 may be configured such that source 802 is connected to an optical transmitter 804 that acts as a first signal converter to convert electrical signals received from source 802 into optical signals. Source 802 may be a source of one or more HDMI electrical signals. Optical communication channel 810 used to transfer optically encoded data to optical receiver 806. Optical receiver 806 may act as a second signal converter to convert the data to electrical signals that are provided sink 808. In one aspect, power 814 is configured to supply electrical power to optical receiver 806.

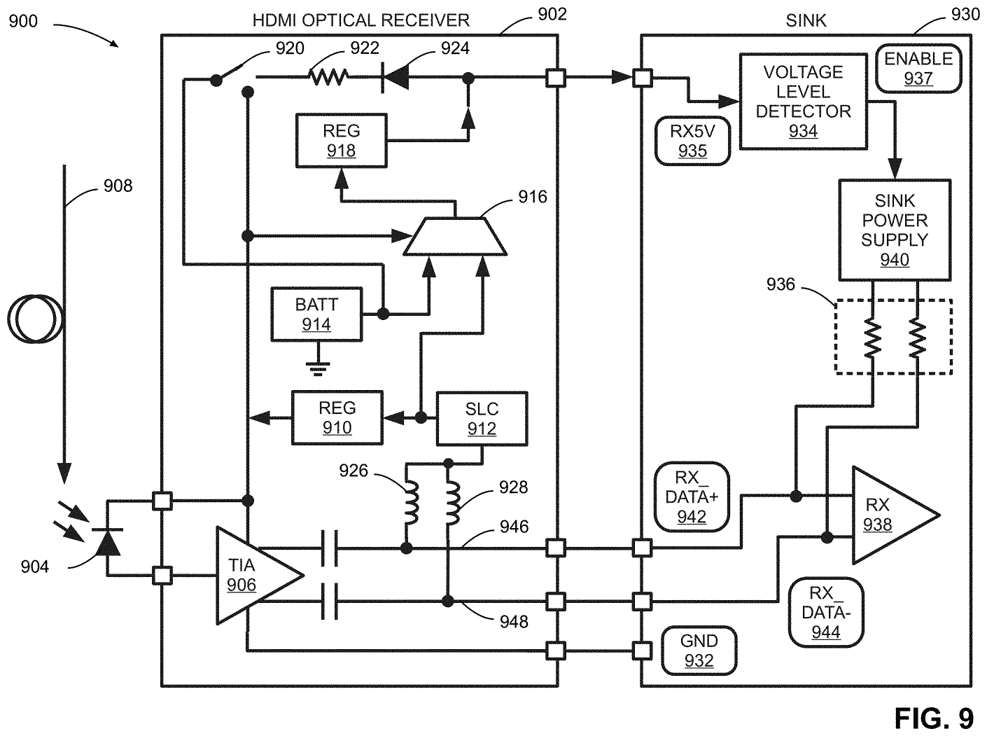

FIG. 9 illustrates one embodiment of an HDMI optical receiver interface 900. As depicted, HDMI optical receiver interface 900 includes an optical communication channel 908, an HDMI optical receiver 902, and a sink 930. HDMI optical receiver 902 further includes a photodetector 904, a transimpedance amplifier TIA 906, a regulator REG 910, a slew rate converter SLC 912, a battery BATT 914, a multiplexer 916 a regulator REG 918, a switch 920, a resistor 922, a diode 924, an inductor 926, an inductor 928, a conductor 946, and a conductor 948. Sink 930 further includes a voltage level detector 934, a sink power supply 940, a resistor network 936, and an amplifier RX 938.

As depicted HDMI optical receiver 902 and sink 930, may represent an internal structure of optical receiver 806 and sink 808, respectively. Optical communication channel 908 may correspond to optical communication channel 810. Sink power supply 940 may correspond to power 814.

Photodetector 904 may be implemented using a photodiode. In one aspect, photodetector 904 receives one or more HDMI optical signals via optical communication channel 908. These optical signals may be comprised of one or more optical HDMI signals. Photodetector 904 converts these optical signals into a corresponding set of electrical signals. These electrical signals are amplified and converted into a corresponding set of differential electrical signals by transimpedance amplifier 906. The differential electrical signals output by transimpedance amplifier 906 are RX_data+ 942 and RX_data− 944. These signals are received by amplifier 938 and processed according to the HDMI receiver protocol. A common electrical ground GND 932 is shared between HDMI optical receiver 902 and sink 930.

In one aspect, transimpedance amplifier 906 needs electrical power to perform any amplification operations. Power may be supplied to transimpedance amplifier 906 from sink power supply 940. To enable sink power supply 940, sink 930 may require a triggering signal RX5V 935 to be supplied from HDMI optical receiver 902. An example of such an HDMI sink device is a television manufactured by Samsung.

When HDMI optical receiver 902 and sink 930 are initially connected, RX5V 935 may be triggered via battery 914, via multiplexer 916. Switch 920 may be configured such that multiplexer 916 routes a 5V voltage from regulator 918, which can boost an output voltage of battery 914, to voltage level detector 934 as RX5V, via the appropriate connecting pins. At the same time, switch 920 can connect resistor 922 and diode 924 between an output of regulator 918 and a power input terminal of transimpedance amplifier 906, so that transimpedance amplifier 906 can be powered by battery 914.

When voltage level detector 934 detects the RX5V voltage 935, voltage level detector 934 may output an enable signal 937 that enables sink power supply 940. Sink power supply 940 may then output a (DC) power signal via resistor network 936. In one aspect, resistor 936 network may be a part of an open drain interface. The output power is routed via resistor network 936, to amplifier 938. Amplifier 938 is a part of the HDMI receiver signal chain, and enables HDMI signal reception by sink 930.

At the same time, the power signal output by resistor network 936 may be received by conductor 946 and 948. In one aspect, each of conductor 946 and 948 is an electrical conductor (e.g., a copper wire or a copper terminal). The power signal from conductor 946 and 948 may be received by inductor 928 and inductor 926, respectively. Since the power signal is a DC signal, each of inductor 926 and 928 behaves as a substantially zero-resistance conductor for the power signal. The power signal is transmitted from inductors 926 and 928 to slew rate controller 912. Slew rate controller 912 may be similar to any of the slew rate controllers depicted in FIGS. 5A and 5B. Slew rate controller 912 may be configured to limit a ramp-up rate of the power signal during a transient phase, when the power signal is initially transmitted from sink power supply 940 to HDMI optical receiver 902. Limiting the ramp-up rate of the power signal, for example, by slew rate controller 912, facilitates appropriate operation of sink 930 and mitigates the possibility of sink 930 entering a shut down or a non-working state.

In one aspect, an output of slew rate controller 912 is a power signal that is routed to regulator 910 and to multiplexer 916. Regulator 910 converts the power signal output by slew rate controller 912 to a power signal at a voltage appropriate to power transimpedance amplifier 906. In this way, transimpedance amplifier 906 is powered by a power signal sourced from sink power supply 940. In other words, the power supply distribution to transimpedance amplifier 906 may be switched to being powered from the power signal sourced from sink power supply 940, after initially being powered by a power signal sourced from battery 914. At the same time, switch 920 is switched so that the output of regulator 910 is also used to charge battery 914. Also, multiplexer 916 is switched such that output of slew rate controller 912 is routed as the RX5V signal 935. At the same time, switch 920 can connect resistor 922 and diode 924 between regulator 918 and battery 914, so that battery 914 can be recharged. The DC power signal output by regulator 910 may also be used to recharge battery 914 for a subsequent initial triggering operation (e.g., when HDMI optical receiver 902 and sink 930 are disconnected and reconnected).

Once transimpedance amplifier 906 is powered up, transimpedance amplifier 906 begins to output HDMI electrical differential signals (i.e., RX_data+ 942 and RX_data− 944 signals) that are transmitted via conductors 946 and 948 respectively, to amplifier 938. These signals are time-varying signals. Along with outputting signals RX_data+ 942 and RX_data− 944, conductors 946 and 948 simultaneously conduct the DC power signal generated by sink power supply 940. Therefore, based at least in part on the superposition principle, a composite time-varying signal is carried by conductors 946 and 948. This composite time-varying signal may be comprised of the HDMI electrical differential signals and the DC power signal. In one aspect, inductors 926 and 928 perform a low-pass filtering action on this composite time-varying signal to extract a substantially DC power signal from the time-varying signal. This substantially DC power signal may be transmitted to slew rate controller 912, and then to regulator 910 and to multiplexer 916. The substantially DC power signal may be used to power transimpedance amplifier 906 and routed through multiplexer 916 as RX5V signal 935.

When using battery 914 to power the transimpedance amplifier, the resistor 922 and diode 924 can further regulate a 5V output voltage of regulator 918 to a desired voltage level required by the transimpedance amplifier 906. When charging battery 914 through power tapping, resistor 920 and diode 924 can regulate the 5V output voltage of regulator 918 to a desired voltage level required by the battery 914.

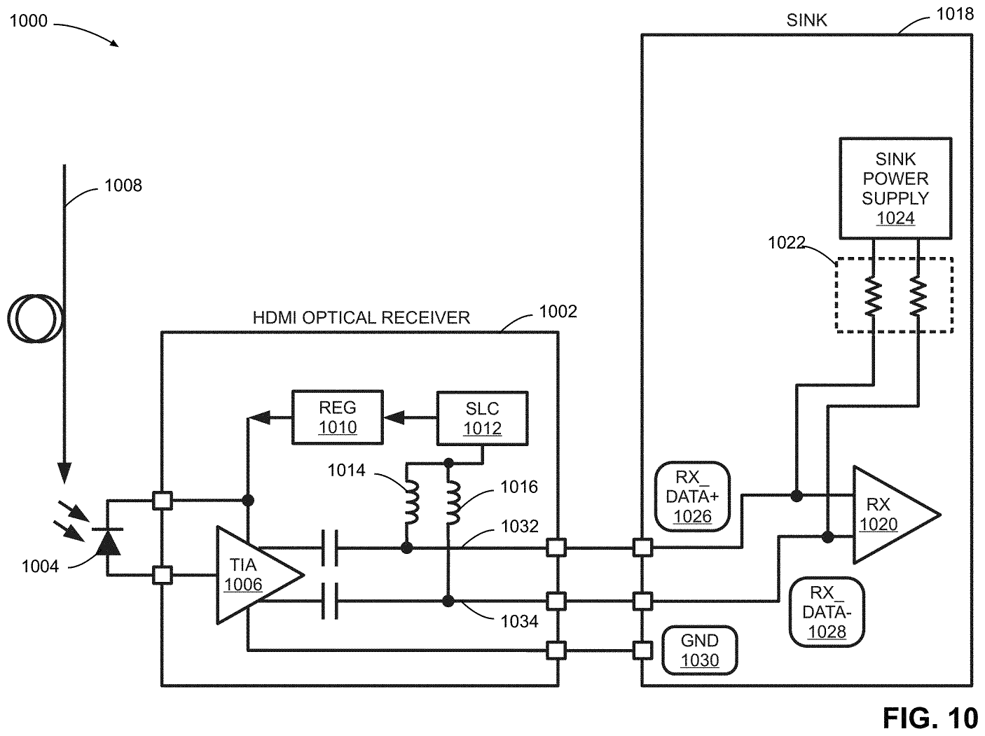

FIG. 10 illustrates one embodiment of an HDMI optical receiver interface 1000. As depicted, HDMI optical receiver interface 1000 includes an optical communication channel 1008, an HDMI optical receiver 1002, and a sink 1018. HDMI optical receiver 1002 further includes a photodetector 1004, a transimpedance amplifier TIA 1006, a regulator REG 1010, a slew rate converter SLC 1012, an inductor 1014, an inductor 1016, a conductor 1032, and a conductor 1034. Sink 1018 further includes a sink power supply 1024, a resistor network 1022, and an amplifier RX 1020.

As depicted HDMI optical receiver 1002 and sink 1018, may represent an internal structure of optical receiver 806 and sink 808, respectively. Optical communication channel 1008 may correspond to optical communication channel 810. Sink power supply 1024 may correspond to power 814.

Photodetector 1004 may be implemented using a photodiode. In one aspect, photodetector 1004 receives one or more HDMI optical signals via optical communication channel 1008. These optical signals may be comprised of one or more optical HDMI signals. Photodetector 1004 converts these optical signals into a corresponding set of electrical signals. These electrical signals are amplified and converted into a corresponding set of differential electrical signals by transimpedance amplifier 1006. The differential electrical signals output by transimpedance amplifier 1006 are RX_data+ 1026 and RX_data− 1028. These signals are received by amplifier 1020 and processed according to the HDMI receiver protocol. A common electrical ground GND 1030 is shared between HDMI optical receiver 1002 and sink 1018.

In one aspect, transimpedance amplifier 1006 needs electrical power to perform any amplification operations. Power may be supplied to transimpedance amplifier 1006 from sink power supply 1024. Sink power supply 1024 may output a (DC) power signal via resistor network 1022. In one aspect, resistor 1022 may be a part of an open drain interface. The output power is routed via resistor network 1022, to amplifier 1020. Amplifier 1020 is a part of the HDMI receiver signal chain, and enables HDMI signal reception by sink 1018.

At the same time, the power signal output by resistor network 1022 may be received by conductor 1032 and 1034. In one aspect, each of conductor 1032 and 1034 is an electrical conductor (e.g., a copper wire or a copper terminal). The power signal from conductor 1032 and 1034 may be received by inductor 1014 and inductor 1016, respectively. Since the power signal is a DC signal, each of inductor 1014 and 1016 behaves as a substantially zero-resistance conductor for the power signal. The power signal is transmitted from inductors 1014 and 1016 to slew rate controller 1012. Slew rate controller 1012 may be similar to any of the slew rate controllers depicted in FIGS. 5A and 5B. Slew rate controller 1012 may be configured to limit a ramp-up rate of the power signal during a transient phase, when the power signal is initially transmitted from sink power supply 1024 to HDMI optical receiver 1002. Limiting the ramp-up rate of the power signal, for example, by slew rate controller 1012, facilitates appropriate operation of sink 930 and mitigates the possibility of sink 1018 entering a shut down or a non-working state.

In one aspect, an output of slew rate controller 1012 is a power signal that is routed to regulator 1010. Regulator 1010 converts the power signal output by slew rate controller 1012 to a power signal at a voltage appropriate to power transimpedance amplifier 1006. In this way, transimpedance amplifier 1006 is powered by a power signal from sink power supply 940.

Once transimpedance amplifier 1006 is powered up, transimpedance amplifier 1006 begins to output HDMI electrical differential signals (i.e., RX_data+ 1026 and RX_data− 1028 signals) that are transmitted via conductors 1032 and 1034 respectively, to amplifier 1020. These signals are time-varying signals. Along with outputting signals RX_data+ 1026 and RX_data− 1028, conductors 1032 and 1034 simultaneously conduct the DC power signal generated by sink power supply 1024. Therefore, based at least in part on the superposition principle, a composite time-varying signal is carried by conductors 1032 and 1034. This composite time-varying signal may be comprised of the HDMI electrical differential signals and the DC power signal. In one aspect, inductors 1032 and 1034 perform a low-pass filtering action on this composite time-varying signal to extract a substantially DC power signal from the time-varying signal. This substantially DC power signal may be transmitted to slew rate controller 1012, and then to regulator 1010. The substantially DC power signal may be used to power transimpedance amplifier 1006.

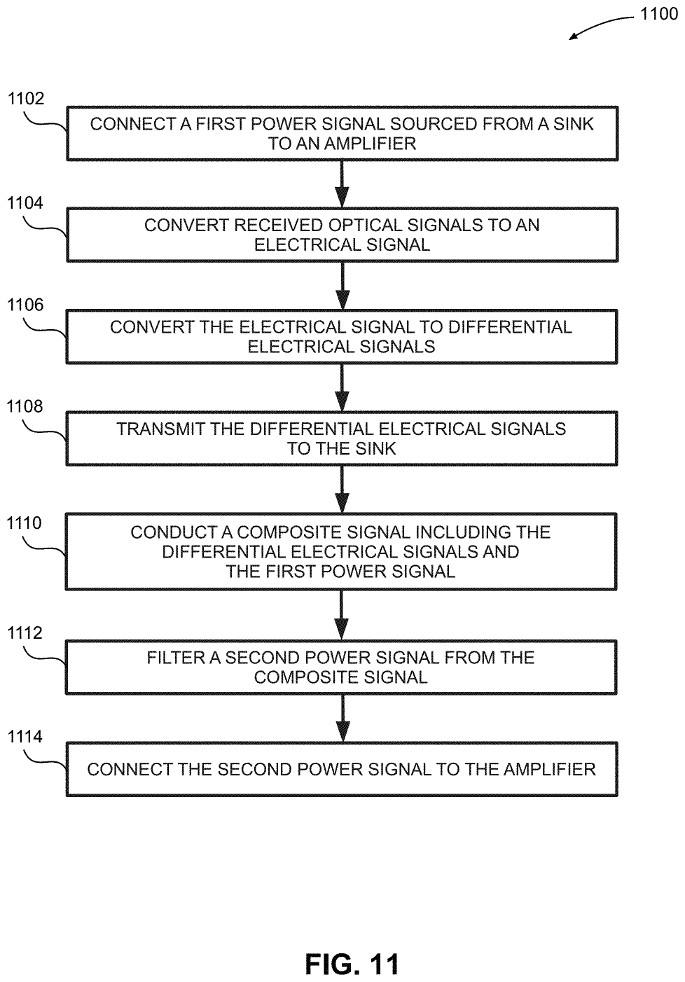

FIG. 11 is a flow diagram illustrating an embodiment of a method to connect a power signal 1100.

Method 1100 may include connecting a first power signal sourced from a sink to an amplifier (1102). For example, a DC power signal sourced from sink power supply 1024 may be routed to transimpedance amplifier 1006. This DC power signal may be routed to the amplifier via a combination of resistor network 1022, inductor 1014, and inductor 1016.

Method 1100 may include converting received optical signals to an electrical signal (1104). For example, photodetector 1004 may convert one or more optical HDMI signals received over optical communication channel 1008 to a corresponding set of one or more electrical signals.

Method 1100 may include converting the electrical signal to differential electrical signals (1106). For example, after being powered up, amplifier 1006 may convert each electrical signal received from photodetector 1004 to a pair of differential electrical signals—RX_data+ 1026 and RX_data− 1028.

Method 1100 may include transmitting the differential electrical signals to the sink (1108). For example, amplifier 1006 may transmit the differential electrical signals to amplifier 1020 via a combination of conductors 1032 and 1034. In one aspect, conductor 1032 conducts the RX_data+ 1026 signal, while conductor 1034 conducts the RX_data− 1028 signal.

Method 1100 may include conducting a composite signal including the differential electrical signals and the first power signal (1110). For example, based at least in part on superposition, conductors 1032 and 1034 may conduct a composite signal comprised of RX_data+ 1026 and RX_data− 1028 signals, and the DC power signal generated by sink power supply 1024.

Method 1100 may include filtering a second power signal from the composite signal (1112). For example, inductors 1014 and 1016 may filter out (i.e., extract) the substantially DC power signal from the composite signal via low-pass filtering.

Method 1100 may include connecting the second power signal to the amplifier (1114). For example, the substantially DC power signal may be routed to transimpedance amplifier 1006.

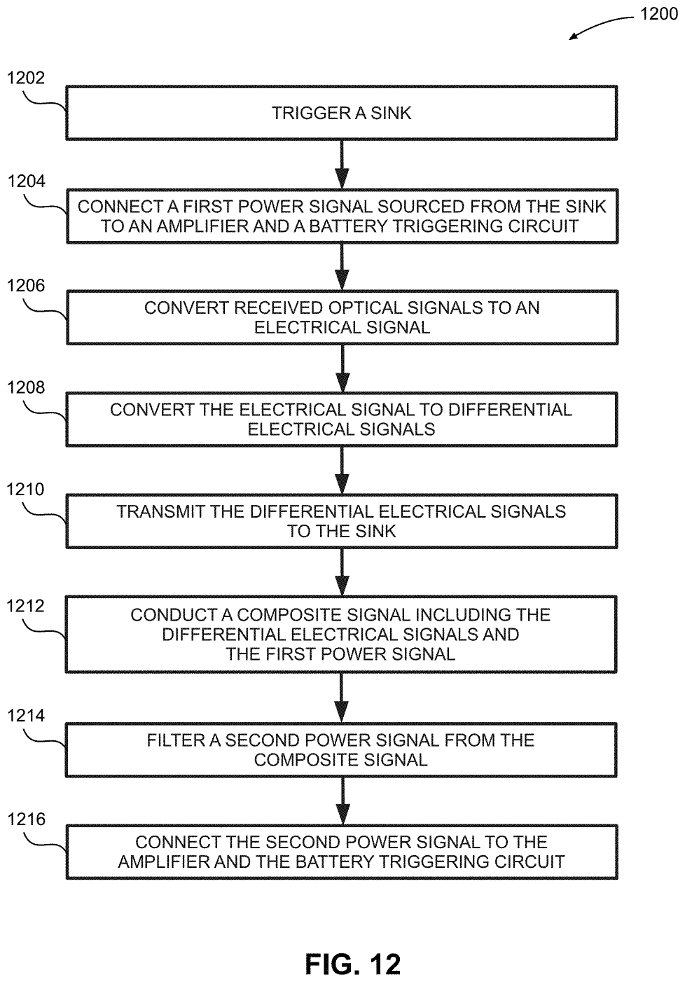

FIG. 12 is a flow diagram illustrating an embodiment of a method 1200 to connect a power signal. Method 1200 may include triggering a sink (1202). For example, HDMI optical receiver 902 may trigger sink 930 using RX5V signal 935. RX5V signal 935 may be generated by battery 914.

Method 1200 may include connecting a first power signal sourced from the sink to an amplifier and a battery triggering circuit (1204). For example, a DC power signal sourced from sink power supply 940 may be routed to transimpedance amplifier 906, and to battery 914, multiplexer 916, switch 920, resistor 922, and diode 924. This DC power signal may be routed to amplifier 906 and an associated battery triggering circuit (comprising battery 914, multiplexer 916, switch 920, resistor 922, and diode 924) via a combination of resistor network 936, inductor 926, and inductor 928.

Method 1200 may include converting received optical signals to an electrical signal (1206). For example, photodetector 904 may convert one or more optical HDMI signals received over optical communication channel 908 to a corresponding set of one or more electrical signals.

Method 1200 may include converting the electrical signal to differential electrical signals (1208). For example, after being powered up, amplifier 906 may convert each electrical signal received from photodetector 904 to a pair of differential electrical signals—RX_data+ 942 and RX_data− 944.

Method 1200 may include transmitting the differential electrical signals to the sink (1210). For example, amplifier 906 may transmit the differential electrical signals to RX amplifier 938 via a combination of conductors 946 and 948. In one aspect, conductor 946 conducts the RX_data+ 942 signal, while conductor 948 conducts the RX_data− 944 signal.

Method 1200 may include conducting a composite signal including the differential electrical signals and the first power signal (1212). For example, based at least in part on superposition, conductors 946 and 948 may conduct a composite signal comprised of RX_data+ 942 signal, RX_data− 944 signal, and the DC power signal generated by sink power supply 940.

Method 1200 may include filtering a second power signal from the composite signal (1214). For example, inductors 926 and 928 may filter out (i.e., extract) the DC power signal (or at least a portion thereof) from the composite signal via low-pass filtering.

Method 1200 may include connecting the second power signal to the amplifier and the battery triggering circuit (1216). For example, the DC power signal (or at least a portion thereof) may be routed to transimpedance amplifier 906, and to battery 914, multiplexer 916, switch 920, resistor 922, and diode 924.

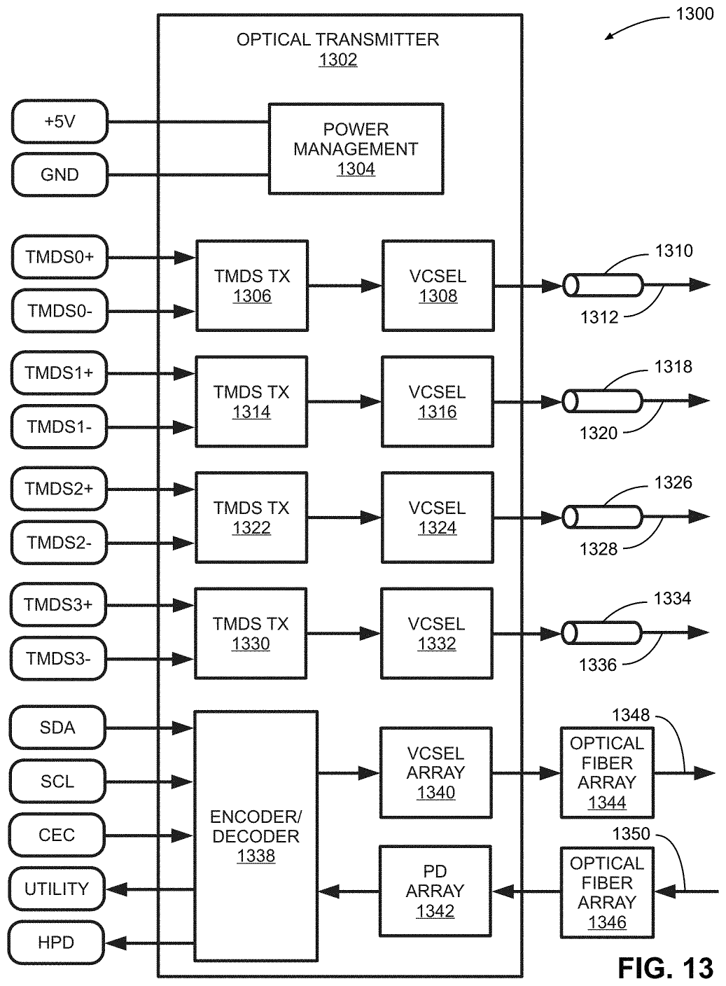

FIG. 13 is a block diagram depicting an embodiment of an optical transmitter interface 1300. As depicted, optical transmitter interface 1300 includes optical transmitter 1302, power management 1304, TMDS optoelectronic transmitters TMDS TX 1306, TMDS TX 1314, TMDS TX 1322, and TMDS TX 1330, vertical cavity surface-emission lasers VCSEL 1308, VCSEL 1316, VCSEL 1324, and VCSEL 1332, encoder/decoder 1338, VCSEL array 1340, and photodetector PD array 1342. Optical transmitter 1302 can also interface with (e.g., may be connected to) and/or may include optical communication channels 1310, 1318, 1326 and 1334, optical fiber array 1344, and optical fiber array 1346.

In one aspect, each of optical communication channel 1310 through 1334 is implemented using one or more optical fibers, and comprises a unidirectional optical communication channel. In one aspect, each of optical fiber array 1344 and 1346 is comprised of multiple optical fibers, capable supporting multiple optical low-speed HDMI signals.

In one aspect, optical transmitter 1302 interfaces with (e.g., may be connected to) an HDMI source (e.g., source 802), and can receive high-speed and low-speed HDMI signals from the HDMI source. High speed HDMI signals may have a larger bandwidth as compared to low-speed HDMI signals. Examples of high-speed HDMI signals are TMDS signals. Examples of low-speed HDMI signals are SDA, SCL, CEC, Utility, and HPD signals. These high-speed and low-speed HDMI signals may be electrical signals. Specifically, optical transmitter 1302 may receive high-speed HDMI differential signals TMDS0+/− via TMDS TX 1306, TMDS1+/− via TMDS TX 1314, TMDS2+/− via TMDS TX 1322, and TMDS3+/− via TMDS TX 1330. Optical transmitter 1302 may receive low-speed HDMI signals SDA, SCL, and CEC, via encoder/decoder 1338.

TMDS TX 1306 may transmit the TMDS0+/− electrical signal to VCSEL 1308. VCSEL 1308 may convert the TMDS0+/− electrical signal into a TMDS0+/− optical signal, and transmit the TMDS0+/− optical signal over optical communication channel 1310 as TMDS0+/− optical signal 1312. TMDS TX 1314 may transmit the TMDS1+/− electrical signal to VCSEL 1316. VCSEL 1316 may convert the TMDS1+/− electrical signal into a TMDS1+/− optical signal, and transmit the TMDS1+/− optical signal over optical communication channel 1318 as TMDS1+/− optical signal 1320. TMDS TX 1322 may transmit the TMDS2+/− electrical signal to VCSEL 1324. VCSEL 1324 may convert the TMDS2+/− electrical signal into a TMDS2+/− optical signal, and transmit the TMDS2+/− optical signal over optical communication channel 1326 as TMDS2+/− optical signal 1328. TMDS TX 1330 may transmit the TMDS3+/− electrical signal to VCSEL 1332. VCSEL 1332 may convert the TMDS3+/− electrical signal into a TMDS3+/− optical signal, and transmit the TMDS3+/− optical signal over optical communication channel 1334 as TMDS3+/− optical signal 1336.

In one aspect, encoder/decoder 1338 encodes low-speed HDMI electrical signals SDA, SCL and CEC and transmits these encoded signals to VCSEL array 1340. In one aspect, the encoding may include multiplexing (i.e., combining the low-speed HDMI electrical signals onto a single transmission channel), or encoding these signals onto two or more multiple, parallel transmission channels. VCSEL array 1340 may include one or more VCSELs corresponding to the number of transmission channels associated with the low-speed electrical signals. VCSEL array 1340 may convert the low-speed electrical signals into corresponding optical signals and transmit these optical signals over optical fiber array 1344 as low-speed optical signals 1348. In one aspect, optical fiber array 1344 includes an optical fiber for each VCSEL in VCSEL array 1340, and may include an arbitrarily large number of optical fibers necessary to provide an appropriate transmission bandwidth for the low-speed HDMI signals.

Optical transmitter 1302 may be configured to receive one or more optical low-speed HDMI signals via optical fiber array 1346. Specifically, optical transmitter 1302 may receive a Utility signal (e.g., an ARC or an eARC signal) and HPD signal via optical fiber array 1346. These signals may be optical signals that are transmitted by an optical receiver using an encoding format suitable for optical fiber communication. Optical fiber array 1346 may be comprised of two or more optical fibers configured to support signal transmission in the encoding format. Each optical fiber may be terminated in a unique photodetector (PD) in PD array 1342.

In one aspect, each photodetector in PD array 1342 converts a received optical signal into a corresponding electrical signal. PD array 1342 collectively transmits all converted electrical signals (still in an encoded format) to encoder/decoder 1338. Encoder/decoder 1338 decodes the electrical signals received from PD array 1342, and outputs a Utility electrical signal (e.g., an ARC signal or an eARC signal transmitted through a corresponding Utility port) and an HPD electrical signal, both of which are transmitted to the HDMI source. In one aspect, the decoding process corresponds to the encoding process that is in a format that is suitable for optical fiber communication.

In terms of functionality, optical transmitter 1302 functions similar to transmitter 602, with one difference being that optical fiber array 1344 and 1346 are used instead of multi-mode optical fiber cables 612 and 614. Another difference between transmitter 602 and optical transmitter 1302 is that the individual VCSEL or LED diode and photodetector transmitter 602 uses to handle low-speed HDMI signals are replaced by VCSEL array 1340 and PD array 1342, respectively. These arrays enable optical transmitter 1302 to support a larger bandwidth for low-speed HDMI signaling. Other low-speed HDMI signals supported by optical transmitter 1302 may include signals associated with an audio return channel (e.g., ARC or eARC).

Power management 1304 may be configured to interface with +5V triggering circuitry associated with the HDMI source. Power management 1304 may also function to stabilize a voltage supply for optical transmitter 1302.

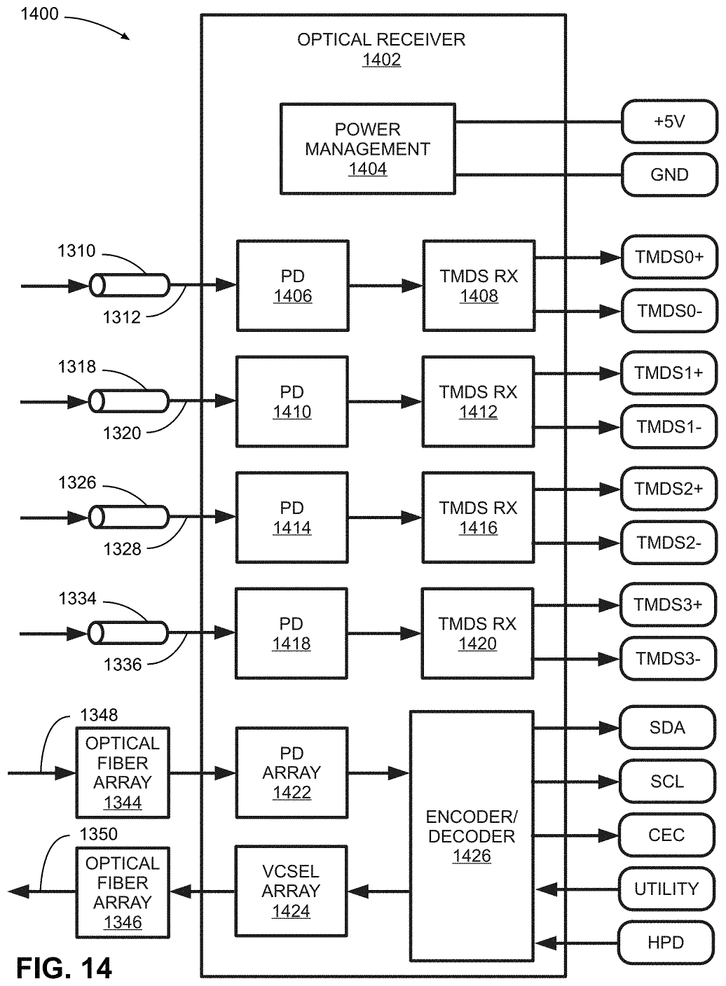

FIG. 14 is a block diagram depicting an embodiment of an optical receiver interface 1400. As depicted, optical transmitter interface 1400 includes optical receiver 1402, power management 1404, TMDS optoelectronic receivers TMDS RX 1408, TMDS RX 1412, TMDS RX 1416, and TMDS RX 1420, photodetectors PD 1406, PD 1410, PD 1414, and PD 1418, encoder/decoder 1426, PD array 1422, and VCSEL array 1424. Optical receiver 1402 can also interface with (e.g., may be connected to) and/or may include optical communication channels 1310, 1318, 1326 and 1334, optical fiber array 1344, and optical fiber array 1346.

In one aspect, optical receiver 1402 receives high-speed and low-speed optical HDMI signals from an optical transmitter such as optical transmitter 1302. More specifically, optical receiver 1402 may receive TMDS0+/− optical signal 1312 via optical communication channel 1310, TMDS1+/− optical signal 1320 via optical communication channel 1318, TMDS2+/− optical signal 1328 via optical communication channel 1326, TMDS3+/− optical signal 1336 via optical communication channel 1334, and low-speed optical signals 1348 via optical fiber array 1344.

In one aspect, PD 1406 converts TMDS0+/− optical signal 1312 to a TMDS0+/− electrical signal and transmits this electrical signal to TMDS RX 1408. TMDS RX 1408 transmits the TMDS0+/− electrical signal as a differential electrical signal (e.g., as differential signal pair RX_data+ 942 and RX_data− 944) to an HDMI sink (e.g., sink 808) connected to optical receiver 1402. PD 1410 converts TMDS1+/− optical signal 1320 to a TMDS1+/− electrical signal and transmits this electrical signal to TMDS RX 1412. TMDS RX 1412 transmits the TMDS1+/− electrical signal as a differential electrical signal to the HDMI sink. PD 1414 converts TMDS2+/− optical signal 1328 to a TMDS2+/− electrical signal and transmits this electrical signal to TMDS RX 1416. TMDS RX 1416 transmits the TMDS2+/− electrical signal as a differential electrical signal to the HDMI sink. PD 1418 converts TMDS3+/− optical signal 1334 to a TMDS3+/− electrical signal and transmits this electrical signal to TMDS RX 1420. TMDS RX 1420 transmits the TMDS3+/− electrical signal as a differential electrical signal to the HDMI sink. Each differential electrical signal pair may be transmitted to the HDMI sink in a manner similar to RX_data+ 942 and RX_data− 944.

In one aspect, low-speed optical signals 1348 (comprising an optical SDA signal, an optical SCL signal, and an optical CEC signal in a specified encoding format) are received by PD array 1422. In one aspect, PD array 1422 includes a plurality of photodetectors, with at least one photodetector corresponding to each optical fiber in optical fiber array 1344. PD array 1422 converts the set of encoded optical signals into a set of encoded electrical signals. This set of encoded electrical signals is decoded by encoder/decoder 1416, which extracts the electrical SDA signal, the electrical SCL signal, and the electrical CEC signal from the set of encoded electrical signals, and transmits these three decoded electrical signals to the HDMI sink.

In one aspect, encoder/decoder 1426 encodes low-speed HDMI electrical signals Utility and HPD, and transmits these encoded signals to VCSEL array 1424. In one aspect, the encoding may include multiplexing (i.e., combining the low-speed HDMI electrical signals onto a single transmission channel), or encoding these signals onto two or more multiple, parallel transmission channels. VCSEL array 1424 may include one or more VCSELs corresponding to the number of transmission channels associated with the low-speed electrical signals. VCSEL array 1424 may convert the low-speed electrical signals into corresponding optical signals and transmit these optical signals over optical fiber array 1346 as low-speed optical signals 1350. In one aspect, optical fiber array 1346 includes an optical fiber for each VCSEL in VCSEL array 1424, and may include an arbitrarily large number of optical fibers necessary to provide an appropriate transmission bandwidth for the low-speed HDMI signals.

In terms of functionality, optical receiver 1402 functions similar to receiver 604, with the difference being that multi-mode optical fiber cables 612 and 614 are replaced by optical fiber array 1344 and 1346, respectively. The individual VCSEL or LED diode and photodetector associated with the low-speed portion of receiver 604 are replaced by VCSEL array 1424 and PD array 1422, respectively. These arrays enable optical receiver 1402 to support a larger bandwidth for low-speed HDMI signaling. Other low-speed HDMI signals supported by optical receiver 1402 may include signals associated with an audio return channel (e.g., ARC or eARC).

Power management 1404 may be configured to interface with +5V triggering circuitry associated with the HDMI sink. In one aspect power management 1404 may be similar to or perform functions similar to the triggering and/or power harvesting circuitry of HDMI optical receiver 902 or 1002. Power management 1404 may also function to stabilize a voltage supply for optical receiver 1402.

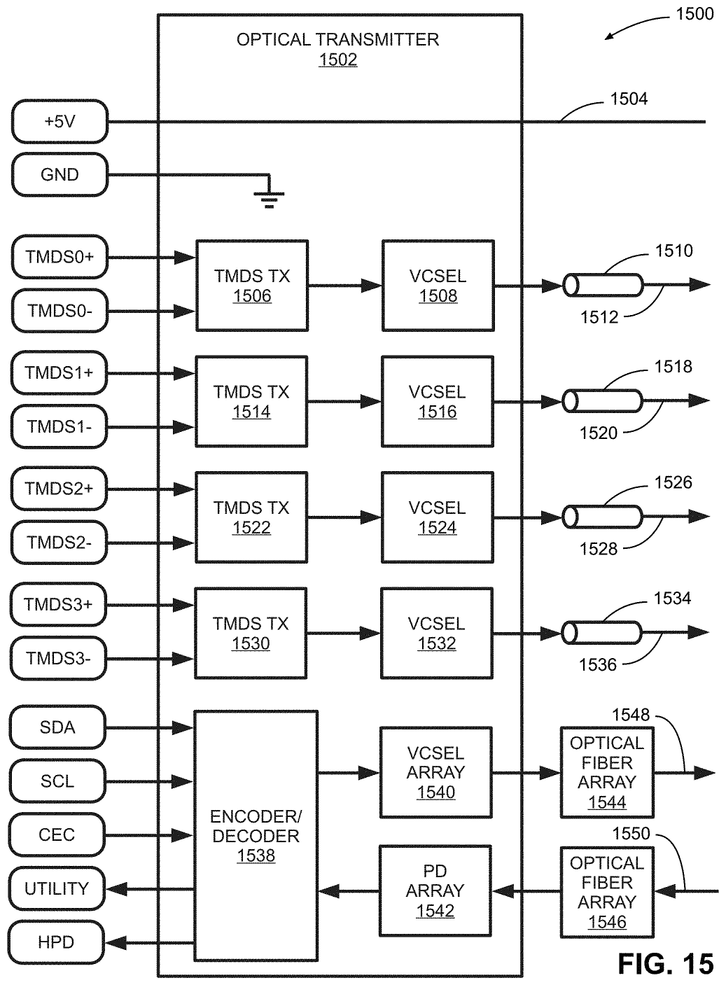

FIG. 15 is a block diagram depicting an embodiment of an optical transmitter interface 1500. As depicted, optical transmitter interface 1500 includes optical transmitter 1502, TMDS optoelectronic transmitters TMDS TX 1506, TMDS TX 1514, TMDS TX 1522, and TMDS TX 1530, vertical cavity surface-emission lasers VCSEL 1508, VCSEL 1516, VCSEL 1524, and VCSEL 1532, encoder/decoder 1538, VCSEL array 1540, and photodetector PD array 1542. Optical transmitter 1502 can also interface with (e.g., may be connected to) and/or may include optical communication channels 1510, 1518, 1526 and 1534, optical fiber array 1544, and optical fiber array 1546.

In one aspect, each of optical communication channel 1510 through 1534 is implemented using one or more optical fibers, and comprises a unidirectional optical communication channel. In one aspect, each of optical fiber array 1544 and 1546 is comprised of multiple optical fibers, capable supporting multiple optical low-speed HDMI signals.

In one aspect, optical transmitter 1502 interfaces with (e.g., may be connected to) an HDMI source (e.g., source 802), and receives high-speed and low-speed HDMI signals from the HDMI source. High speed HDMI signals may have a larger bandwidth as compared to low-speed HDMI signals. Examples of high-speed HDMI signals are TMDS signals. Examples of low-speed HDMI signals are SDA, SCL, CEC, Utility, and HPD signals. These high-speed and low-speed HDMI signals may be electrical signals. Specifically, optical transmitter 1502 may receive high-speed HDMI differential signals TMDS0+/− via TMDS TX 1506, TMDS1+/− via TMDS TX 1514, TMDS2+/− via TMDS TX 1522, and TMDS3+/− via TMDS TX 1530. Optical transmitter 1502 may receive low-speed HDMI signals SDA, SCL, and CEC, via encoder/decoder 1538.

TMDS TX 1506 may transmit the TMDS0+/− electrical signal to VCSEL 1508. VCSEL 1508 may convert the TMDS0+/− electrical signal into a TMDS0+/− optical signal, and transmit the TMDS0+/− optical signal over optical communication channel 1510 as TMDS0+/− optical signal 1512. TMDS TX 1514 may transmit the TMDS1+/− electrical signal to VCSEL 1516. VCSEL 1516 may convert the TMDS1+/− electrical signal into a TMDS1+/− optical signal, and transmit the TMDS1+/− optical signal over optical communication channel 1518 as TMDS1+/− optical signal 1520. TMDS TX 1522 may transmit the TMDS2+/− electrical signal to VCSEL 1524. VCSEL 1524 may convert the TMDS2+/− electrical signal into a TMDS2+/− optical signal, and transmit the TMDS2+/− optical signal over optical communication channel 1526 as TMDS2+/− optical signal 1528. TMDS TX 1530 may transmit the TMDS3+/− electrical signal to VCSEL 1532. VCSEL 1532 may convert the TMDS3+/− electrical signal into a TMDS3+/− optical signal, and transmit the TMDS3+/− optical signal over optical communication channel 1534 as TMDS3+/− optical signal 1536.

In one aspect, encoder/decoder 1538 encodes low-speed HDMI electrical signals SDA, SCL and CEC and transmits these encoded signals to VCSEL array 1540. In one aspect, the encoding may include multiplexing (i.e., combining the low-speed HDMI electrical signals onto a single transmission channel), or encoding these signals onto two or more multiple, parallel transmission channels. VCSEL array 1540 may include one or more VCSELs corresponding to the number of transmission channels associated with the low-speed electrical signals. VCSEL array 1540 may convert the low-speed electrical signals into corresponding optical signals and transmit these optical signals over optical fiber array 1544 as low-speed optical signals 1548. In one aspect, optical fiber array 1544 includes an optical fiber for each VCSEL in VCSEL array 1540, and may include an arbitrarily large number of optical fibers necessary to provide an appropriate transmission bandwidth for the low-speed HDMI signals.

Optical transmitter 1502 may be configured to receive one or more optical low-speed HDMI signals via optical fiber array 1546. Specifically, optical transmitter 1502 may receive a Utility signal and HPD signal via optical fiber array 1546. These signals may be optical signals that are transmitted by an optical receiver using an encoding format suitable for optical fiber communication. Optical fiber array 1546 may be comprised of two or more optical fibers configured to support signal transmission in the encoding format. Each optical fiber may be terminated in a unique photodetector (PD) in PD array 1542.

In one aspect, each photodetector in PD array 1542 converts a received optical signal into a corresponding electrical signal. PD array 1542 collectively transmits all converted electrical signals (still in an encoded format) to encoder/decoder 1538. Encoder/decoder 1538 decodes the electrical signals received from PD array 1542, and outputs a Utility electrical signal and an HPD electrical signal, both of which are transmitted to the HDMI source.

In terms of functionality, optical transmitter 1502 functions similar to transmitter 642, with one difference being that optical fiber array 1544 and 1546 are used instead of multi-mode optical fiber cables 652 and 656. Another difference between transmitter 642 and optical transmitter 1502 is that the individual VCSEL or LED diode and photodetector uses to handle low-speed HDMI signals are replaced by VCSEL array 1540 and PD array 1542, respectively. These arrays enable optical transmitter 1502 to support a larger bandwidth for low-speed HDMI signaling. Other low-speed HDMI signals supported by optical transmitter 1502 may include signals associated with an audio return channel (e.g., ARC or eARC).

In one aspect, a +5V DC triggering voltage signal 1504 is routed from the source, through optical transmitter 1502, to an optical receiver. A ground signal GND establishes a common ground between the source and optical transmitter 1502.

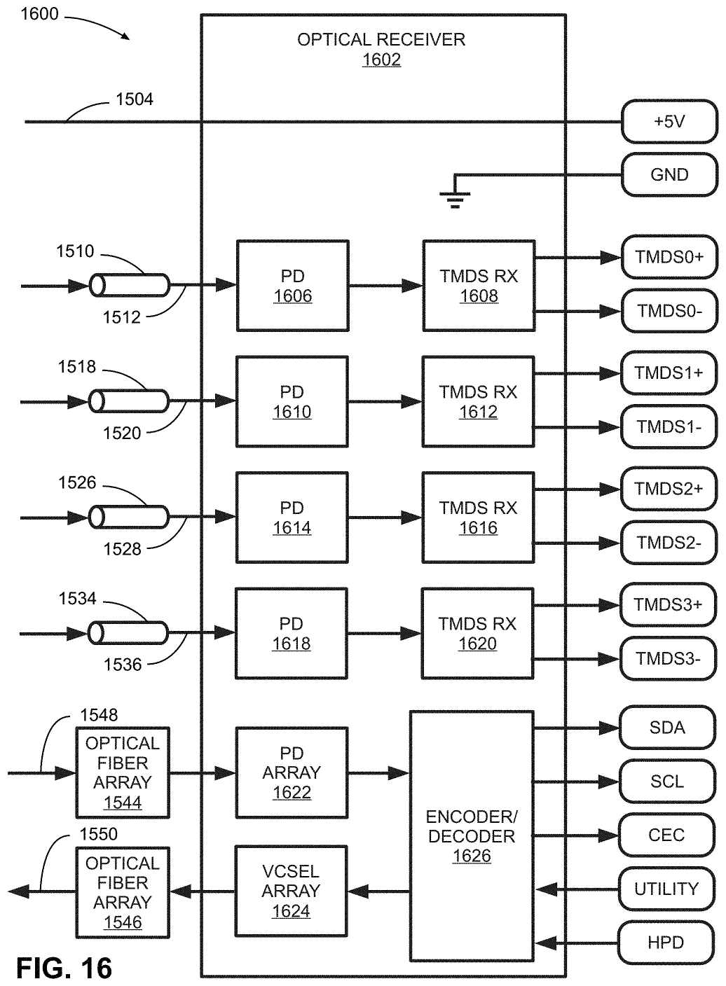

FIG. 16 is a block diagram depicting an embodiment of an optical receiver interface 1600. As depicted, optical transmitter interface 1600 includes optical receiver 1602, TMDS optoelectronic receivers TMDS RX 1608, TMDS RX 1612, TMDS RX 1616, and TMDS RX 1620, photodetectors PD 1606, PD 1610, PD 1614, and PD 1618, encoder/decoder 1626, PD array 1622, and VCSEL array 1624. Optical receiver 1602 can also interface with (e.g., may be connected to) and/or may include optical communication channels 1510, 1518, 1526 and 1534, optical fiber array 1544, and optical fiber array 1546.

In one aspect, optical receiver 1602 receives high-speed and low-speed optical HDMI signals from an optical transmitter such as optical transmitter 1502. More specifically, optical receiver 1602 may receive TMDS0+/− optical signal 1512 via optical communication channel 1510, TMDS1+/− optical signal 1520 via optical communication channel 1518, TMDS2+/− optical signal 1528 via optical communication channel 1526, TMDS3+/− optical signal 1536 via optical communication channel 1534, and low-speed optical signals 1548 via optical fiber array 1544.

In one aspect, PD 1606 converts TMDS0+/− optical signal 1512 to a TMDS0+/− electrical signal and transmits this electrical signal to TMDS RX 1608. TMDS RX 1608 transmits the TMDS0+/− signal as a differential electrical signal (e.g., as differential signal pair RX_data+ 942 and RX_data− 944) to an HDMI sink (e.g., sink 808) connected to optical receiver 1602. PD 1610 converts TMDS1+/− optical signal 1520 to a TMDS1+/− electrical signal and transmits this electrical signal to TMDS RX 1612. TMDS RX 1612 transmits the TMDS1+/− signal as a differential electrical signal to the HDMI sink. PD 1614 converts TMDS2+/− optical signal 1528 to a TMDS2+/− electrical signal and transmits this electrical signal to TMDS RX 1616. TMDS RX 1616 transmits the TMDS3+/− signal as a differential electrical signal to the HDMI sink. PD 1618 converts TMDS3+/− optical signal 1536 to a TMDS3+/− electrical signal and transmits this electrical signal to TMDS RX 1620. TMDS RX 1620 transmits the TMDS3+/− signal as a differential electrical signal to the HDMI sink. Each differential electrical signal pair may be transmitted to the HDMI sink in a manner similar to RX_data+ 942 and RX_data− 944.

In one aspect, low-speed optical signals 1548 (comprising an optical SDA signal, an optical SCL signal, and an optical CEC signal in a specified encoding format) are received by PD array 1622. In one aspect, PD array 1622 includes a plurality of photodetectors, with at least one photodetector corresponding to each optical fiber in optical fiber array 1544. PD array 1622 converts the set of encoded optical signals into a set of encoded electrical signals. This set of encoded electrical signals is decoded by encoder/decoder 1626, which extracts the electrical SDA signal, the electrical SCL signal, and the electrical CEC signal from the set of encoded electrical signals, and transmits these three decoded electrical signals to the HDMI sink.

In one aspect, encoder/decoder 1626 encodes low-speed HDMI electrical signals Utility and HPD, and transmits these encoded signals to VCSEL array 1624. In one aspect, the encoding may include multiplexing (i.e., combining the low-speed HDMI electrical signals onto a single transmission channel), or encoding these signals onto two or more multiple, parallel transmission channels. VCSEL array 1624 may include one or more VCSELs corresponding to the number of transmission channels associated with the low-speed electrical signals. VCSEL array 1624 may convert the low-speed electrical signals into corresponding optical signals and transmit these optical signals over optical fiber array 1546 as low-speed optical signals 1550. In one aspect, optical fiber array 1546 includes an optical fiber for each VCSEL in VCSEL array 1624, and may include an arbitrarily large number of optical fibers necessary to provide an appropriate transmission bandwidth for the low-speed HDMI signals.

In terms of functionality, optical receiver 1602 functions similar to receiver 644, with the difference being that multi-mode optical fiber cables 652 and 656 are replaced by optical fiber array 1544 and 1546, respectively. The individual VCSEL or LED diode and photodetector associated with the low-speed portion of receiver 644 are replaced by VCSEL array 1624 and PD array 1622, respectively. These arrays enable optical receiver 1602 to support a larger bandwidth for low-speed HDMI signaling. Other low-speed HDMI signals supported by optical receiver 1602 may include signals associated with an audio return channel (e.g., ARC or eARC).

In one aspect, +5V DC triggering voltage signal 1504 received from optical transmitter 1502 is routed to the sink. A ground signal GND establishes a common ground between the sink and optical receiver 1602.

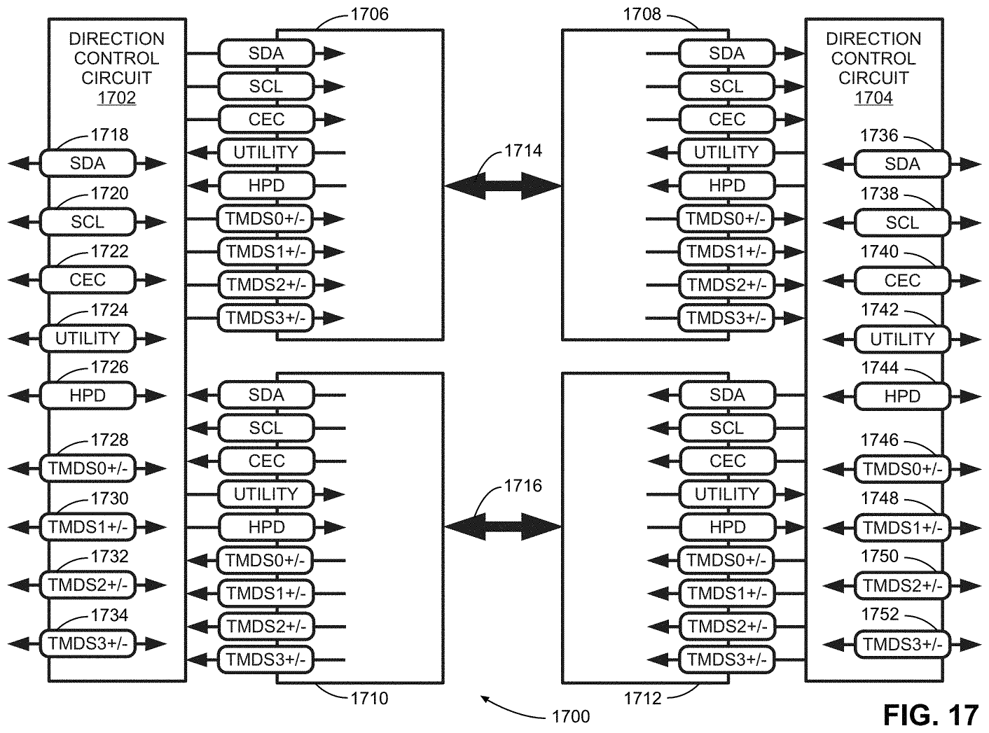

FIG. 17 is a block diagram depicting an embodiment of an optical connector 1700. As depicted, optical connector 1700 includes direction control circuit 1702, optical transmitter 1706, optical receiver 1708, optical receiver 1710, optical transmitter 1712, and direction control circuit 1704. Optical transmitter 1706 and optical receiver 1708 may be connected via communication channel 1714. Optical transmitter 1712 and optical receiver 1710 may be connected via communication channel 1716. Each of direction control circuit 1702 and 1704 may be terminated in an HDMI-compatible electrical connector (i.e., as an HDMI-compatible terminal), and is capable of electrically and mechanically connecting with an HDMI source or and HDMI sink.

In one aspect, optical connector 1700 is a direction-agnostic HDMI connector in the sense that either of direction control circuit 1702 or direction control circuit 1704 can be connected to an HDMI source (e.g., source 802), with the other direction control circuit (i.e., direction control circuit 1704 or direction control circuit 1702, respectively) being connected to an HDMI sink (e.g., sink 808).

In one aspect, each of direction control circuit 1702 and 1704 is configured to automatically determine whether the respective direction control circuit is connected to an HDMI source or an HDMI sink. For example, if direction control circuit 1702 is connected to an HDMI source, direction control circuit 1702 automatically detects that the connection is associated with the HDMI source. At the same time, if direction control circuit 1704 is connected to an HDMI sink, then direction control circuit 1704 automatically detects that the connection is associated with the HDMI sink. In this case, direction control circuit 1702 activates optical transmitter 1706, and direction control circuit 1704 activates optical receiver 1708. Optical transmitter 1712 and optical receiver 1710 are not activated. Optical connector 1700 (specifically, optical transmitter 1706) is now configured to receive SDA signal 1718, SCL signal 1720, CEC signal 1722, TMDS0+/− signal 1728, TMDS1+/− signal 1730, TMDS2+/− signal 1732, and TMDS3+/− signal 1734 as electrical signals from the HDMI source. These electrical signals are transmitted to optical transmitter 1706 via directional control circuit 1702. Optical transmitter 1706 may convert these electrical signals into optical signals and transmit the optical signals to optical receiver 1708 via communication channel 1714.

Optical receiver 1708 converts any optical signals received from optical transmitter 1706 into corresponding electrical signals, and transmits the set of converted electrical signals to the HDMI sink via direction control circuit 1704, as SDA signal 1736, SCL signal 1738, CEC signal 1740, TMDS0+/− signal 1746, TMDS1+/− signal 1748, TMDS2+/− signal 1750, and TMDS3+/− signal 1752.

At the same time, optical connector (specifically, optical receiver 1708) may receive a utility signal 1742 and an HPD signal 1744 as electrical signals from the HDMI sink via direction control circuit 1704. Optical receiver 1708 may convert these electrical signals into optical signals and transmit the optical signals to optical transmitter 1708 via communication channel 1714.

Optical transmitter 1706 converts any optical signals received from optical receiver 1708 into corresponding electrical signals, and transmits the set of converted electrical signals to the HDMI source via direction control circuit 1702, as Utility signal 1724 and HPD signal 1726.

In one aspect, if direction control circuit 1704 is connected to an HDMI source, direction control circuit 1704 automatically detects that the connection is associated with the HDMI source. At the same time, if direction control circuit 1702 is connected to an HDMI sink, then direction control circuit 1702 automatically detects that the connection is associated with the HDMI sink. In this case, direction control circuit 1704 activates optical transmitter 1712, and direction control circuit 1702 activates optical receiver 1710. Optical transmitter 1706 and optical receiver 1708 are not activated. Optical connector 1700 (specifically, optical transmitter 1712) is now configured to receive SDA signal 1736, SCL signal 1738, CEC signal 1740, TMDS0+/− signal 1746, TMDS1+/− signal 1748, TMDS2+/− signal 1750, and TMDS3+/− signal 1752 as electrical signals from the HDMI source. These electrical signals are transmitted to optical transmitter 1712 via directional control circuit 1704. Optical transmitter 1712 may convert these electrical signals into optical signals and transmit the optical signals to optical receiver 1710 via communication channel 1716.

Optical receiver 1712 converts any optical signals received from optical transmitter 1710 into corresponding electrical signals, and transmits the set of converted electrical signals and any other received electrical signals from optical transmitter 1712 to the HDMI sink via direction control circuit 1702, as SDA signal 1718, SCL signal 1720, CEC signal 1722, TMDS0+/− signal 1728, TMDS1+/− signal 1730, TMDS2+/− signal 1732, and TMDS3+/− signal 1734.

At the same time, optical connector (specifically, optical receiver 1710) may receive a utility signal 1724 and an HPD signal 1726 as electrical signals from the HDMI sink via direction control circuit 1702. Optical receiver 1710 may convert these electrical signals into optical signals and transmit the optical signals to optical transmitter 1712 via communication channel 1716.

Optical transmitter 1712 converts any optical signals received from optical receiver 1710 into corresponding electrical signals, and transmits the set of converted electrical signals to the HDMI source via direction control circuit 1704, as Utility signal 1742 and HPD signal 1744.

In one aspect, if direction control circuit 1702 is connected to a source and direction control circuit 1704 is connected to a sink, then direction control circuit 1702 routes a +5V triggering signal and a ground (GND) signal from a source connected to direction control circuit 1702 to optical transmitter 1706. In this case, direction control circuit 1704 connects a +5V triggering signal and a ground (GND) signal from optical receiver 1708 to the sink. These signals may be transmitted via one or more electrical conductors. (The +5V and GND signal connections are not depicted in FIG. 17.)

In one aspect, if direction control circuit 1704 is connected to a source and direction control circuit 1702 is connected to a sink, then direction control circuit 1704 routes a +5V triggering signal and a ground (GND) signal from a source connected to direction control circuit 1704 to optical transmitter 1712. In this case, direction control circuit 1702 connects a +5V triggering signal and a ground (GND) signal from optical receiver 1710 to the sink. These signals may be transmitted via one or more electrical conductors. (The +5V and GND signal connections are not depicted in FIG. 17.)

In one aspect, each of optical transmitter 1706 and optical transmitter 1712 is similar to transmitter 602, and each of optical receiver 1708 and optical receiver 1710 is similar to receiver 604. In this case, each of communication channel 1714 and communication 1716 is comprised of multiple optical fibers.

In one aspect, each of optical transmitter 1706 and optical transmitter 1712 is similar to transmitter 622, and each of optical receiver 1708 and optical receiver 1710 is similar to receiver 624. In this case, each of communication channel 1714 and communication 1716 is comprised of multiple optical fibers for high-speed HDMI signal communication, and one or more conductors for low-speed HDMI signal communication. Each of communication channel 1714 and 1716 also includes a pair of conductors to transmit a +5V triggering signal and a ground (GND) signal from the corresponding optical transmitter (i.e., optical transmitter 1706 and 1712, respectively) to the corresponding optical receiver (i.e., optical receiver 1708 and 1710, respectively).

In one aspect, each of optical transmitter 1706 and optical transmitter 1712 is similar to transmitter 642, and each of optical receiver 1708 and optical receiver 1710 is similar to receiver 644. In this case, each of communication channel 1714 and communication 1716 includes multiple optical fibers for high-speed HDMI signal and low-speed HDMI signal communication. Each of communication channel 1714 and 1716 may also include a conductor that transmits a +5V triggering signal from the corresponding optical transmitter (i.e., optical transmitter 1706 and 1712, respectively) to the corresponding optical receiver (i.e., optical receiver 1708 and 1710, respectively).

In one aspect, each of optical transmitter 1706 and optical transmitter 1712 is similar to transmitter 1302, and each of optical receiver 1708 and optical receiver 1710 is similar to receiver 1402. In this case, each of communication channel 1714 and communication 1716 is comprised of multiple optical fibers (e.g., optical fibers 1310, 1318, 1326, and 1334) for high-speed HDMI signal communication, and optical fiber arrays 1344 and 1346 low-speed HDMI signal communication.

In one aspect, each of optical transmitter 1706 and optical transmitter 1712 is similar to transmitter 1502, and each of optical receiver 1708 and optical receiver 1710 is similar to receiver 1602. In this case, each of communication channel 1714 and communication 1716 is comprised of multiple optical fibers (e.g., optical fibers 1510, 1518, 1526, and 1534) for high-speed HDMI signal communication, and optical fiber arrays 1544 and 1546 low-speed HDMI signal communication. Each of communication channel 1714 and 1716 may also include a conductor that transmits a +5V triggering signal 1504 from the corresponding optical transmitter (i.e., optical transmitter 1706 and 1712, respectively) to the corresponding optical receiver (i.e., optical receiver 1708 and 1710, respectively).

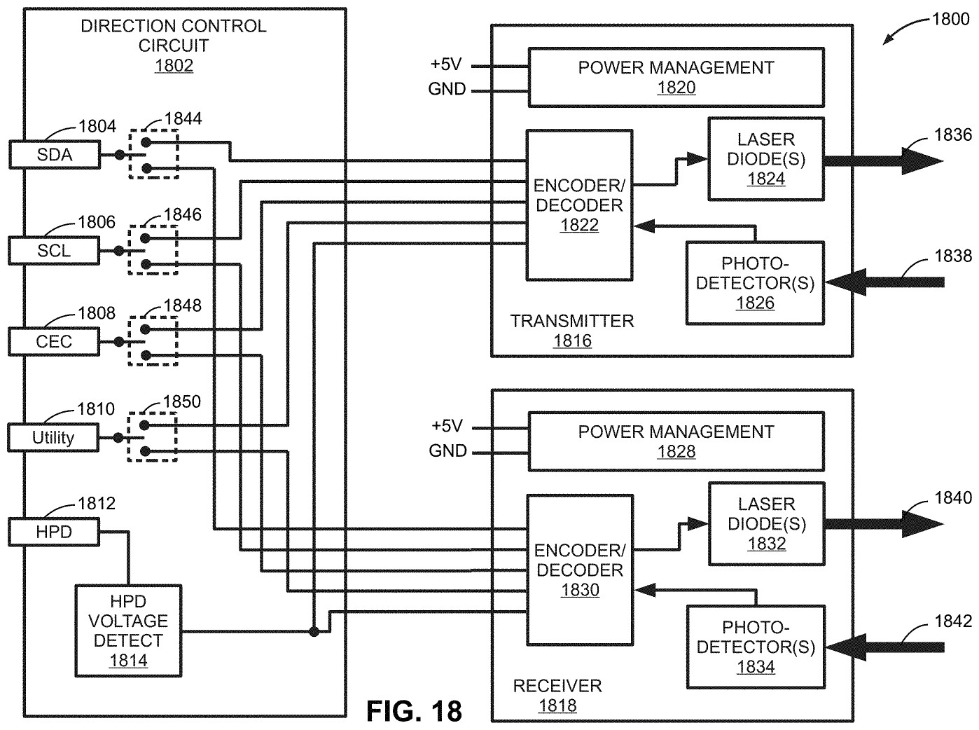

FIG. 18 is a block diagram depicting an embodiment of a direction control circuit low-speed interface 1800. As depicted, direction control circuit low-speed 1800 interface includes direction control circuit 1802, transmitter 1816, receiver 1818, and optical communication channels 1836, 1838, 1840, and 1842. Direction control circuit 1802 further includes SDA terminal 1804, SCL terminal 1806, CEC terminal 1808, Utility terminal 1810, HPD terminal 1812, HPD voltage detect 1814, and low-speed switches 1844, 1846, 1848, and 1850. Transmitter 1816 further includes power management 1820, encoder/decoder 1822, one or more laser diodes 1824, and one or more photodetectors 1826. Receiver 1818 further includes power management 1828, encoder/decoder 1830, one or more laser diodes 1832, and one or more photodetectors 1834. In one aspect, each of low-speed switch 1844 through 1850 is a low-speed single-pole, double-throw (SPDT) switch. In one aspect, laser diodes 1824 and 1832 may be implemented using one or more VCSELs, or some other laser diodes.

In one aspect, direction control circuit 1802 may be similar to direction control circuit 1702. When direction control circuit 1802 is connected to an HDMI receptacle of an HDMI source or an HDMI sink, HPD voltage detect 1814 functions as a hot-plug detection (HPD) circuit. Specifically, HPD voltage detect 1814 monitors a hot-plug voltage associated with the HDMI receptacle. If this voltage is low, then HPD voltage detect 1814 determines that the HDMI connection associated with direction control circuit 1802 is to an HDMI source. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to transmitter 1816. In this mode, encoder/decoder 1822 receives an SDA electrical signal from the HDMI source via SDA terminal 1804 and via switch 1844, an SCL electrical signal from the HDMI source via SCL terminal 1806 and via switch 1846, and an CEC electrical signal from the HDMI source via CEC terminal 1808 via switch 1848.

In one aspect, encoder/decoder 1822 is configured to receive the SDA, SCL and CEC electrical signals, and appropriately encode these signals for transmission. In one aspect, encoder/decoder 1822 maps any received electrical signals to a corresponding number of laser diodes and fiber optic channels, and any received optical signals to a corresponding number of photodetectors. The encoded SDA, SCL and CEC electrical signals are converted into corresponding optical signals by laser diodes 1824, and transmitted over optical communication channel 1836 to a receiver associated with an HDMI sink. In one aspect, optical communication channel 1836 is comprised of one or more optical fibers. Encoder/decoder 1822 may multiplex or encode the SDA, SCL and CEC electrical signals to appropriately map to the number of optical fibers included in optical communication channel 1836. Accordingly, each optical fiber in optical communication channel 1836 may be connected upstream to a single laser diode included in laser diodes 1824. In other words, laser diodes 1824 may include a number of laser diodes that is equal to the number of optical fibers in optical communication channel 1836. Each laser diode converts an electrically-encoded signal (i.e., encoded SDA, SCL, and CEC electrical signals) from encoder/decoder 1822, and converts the associated electrically-encoded signal into a corresponding optical signal for transmission over optical communication channel 1836.

In one aspect, transmitter 1816 is configured to receive HPD and Utility optical signals over optical communication channel 1838. These optical communication signals may be received from a receiver associated with an HDMI sink. In one aspect, the HPD and Utility optical signals are received by photodetectors 1826 and converted into corresponding HPD and Utility electrical signals. The HPD and Utility signals may be encoded in a suitable format. In one aspect, optical communication channel 1838 is comprised of one or more optical fibers. Accordingly, each optical fiber in optical communication channel may be connected downstream to a photodetector included in photodetectors 1826. In other words, photodetectors 1826 may include a number of photodetectors that is equal to the number of optical fibers in optical communication channel 1838. Each photodetector converts an electrically-encoded signal (i.e., encoded HPD and Utility optical signals) from the HDMI sink, and converts the associated optical signal into a corresponding electrical signal.

In one aspect, encoder/decoder 1822 receives the encoded HPD and Utility electrical signals from photodetectors 1826, and decodes the HPD and Utility electrical signals. Encoder/decoder 1822 outputs the decoded HPD and Utility electrical signals. The decoded Utility electrical signal may be transmitted to Utility terminal 1810 via low-speed switch 1850. The decoded HPD electrical signal may be transmitted to HPD terminal 1812. The Utility and HPD signals are transmitted to the HDMI source via Utility terminal 1810 and HPD terminal 1812, respectively.

In one aspect, power management 1820 is configured to provide a +5V triggering voltage and ground signal to the HDMI source. The +5V triggering signal and ground signal function in accordance with the HDMI protocol.

If the voltage monitored by HPD voltage detect 1814 is high, then HPD voltage detect 1814 determines that the HDMI connection associated with direction control circuit 1802 is to an HDMI sink. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to receiver 1818. In this mode, encoder/decoder 1830 receives a Utility electrical signal from the HDMI sink via Utility terminal 1810 and via switch 1850, and an HPD electrical signal from the HDMI sink via HPD terminal 1812.

In one aspect, encoder/decoder 1830 is configured to receive the Utility and HPD electrical signals, and appropriately encode these signals for transmission. In one aspect, encoder/decoder 1830 maps any received electrical signals to a corresponding number of laser diodes and fiber optic channels, and any received optical signals to a corresponding number of photodetectors. The encoded Utility and HPD electrical signals are converted into corresponding optical signals by laser diodes 1832, and transmitted over optical communication channel 1840 to a transmitter associated with an HDMI source. In one aspect, optical communication channel 1840 is comprised of one or more optical fibers. Encoder/decoder 1830 may multiplex or encode the Utility and HPD electrical signals to appropriately map to the number of optical fibers included in optical communication channel 1840. Accordingly, each optical fiber in optical communication channel 1840 may be connected upstream to a single laser diode included in laser diodes 1832. In other words, laser diodes 1832 may include a number of laser diodes that is equal to the number of optical fibers in optical communication channel 1840. Each laser diode converts an electrically-encoded signal (i.e., encoded Utility and HPD electrical signals) from encoder/decoder 1830, and converts the associated electrically-encoded signal into a corresponding optical signal for transmission over optical communication channel 1840.

In one aspect, receiver 1818 is configured to receive SDA, SCL, and CEC optical signals over optical communication channel 1842. These optical communication signals may be received from a transmitter associated with an HDMI source. In one aspect, the SDA, SCL, and CEC optical signals are received by photodetectors 1834 and converted into SDA, SCL, and CEC electrical signals. The SDA, SCL, and CEC signals may be encoded in a suitable format. In one aspect, optical communication channel 1842 is comprised of one or more optical fibers. Accordingly, each optical fiber in optical communication channel may be connected downstream to a photodetector included in photodetectors 1834. In other words, photodetectors 1834 may include a number of photodetectors that is equal to the number of optical fibers in optical communication channel 1842. Each photodetector converts an electrically-encoded signal (i.e., encoded SDA, SCL, and CEC optical signals) from the HDMI source, and converts the associated optical signal into a corresponding electrical signal.

In one aspect, encoder/decoder 1830 receives the encoded SDA, SCL, and CEC electrical signals from photodetectors 1834, and decodes the SDA, SCL, and CEC electrical signals. Encoder/decoder 1830 outputs the decoded SDA, SCL, and CEC signals. The decoded SDA electrical signal may be transmitted to SDA terminal 1804 via low-speed switch 1844. The decoded SCL electrical signal may be transmitted to SCL terminal 1806 via low-speed switch 1846. The decoded CEC electrical signal may be transmitted to CEC terminal 1808 via low-speed switch 1848. These decoded SDA, SCL and CEC signals are transmitted to the HDMI sink, via SDA terminal 1804, SCL terminal 1806, and CEC terminal 1808, respectively.

In one aspect, power management 1828 is configured to provide a +5V triggering voltage and ground signal to the HDMI sink. The +5V triggering signal and ground signal function in accordance with the HDMI protocol.

In one aspect, low-speed switches 1844 through 1850 are any combination of radio-frequency switches, MEMS switches, relay switches, transmission gates, or any other kind of electrical switch. Low-speed switches 1844 through 1850 may be selected to provide minimal degradation in signal transmission quality.

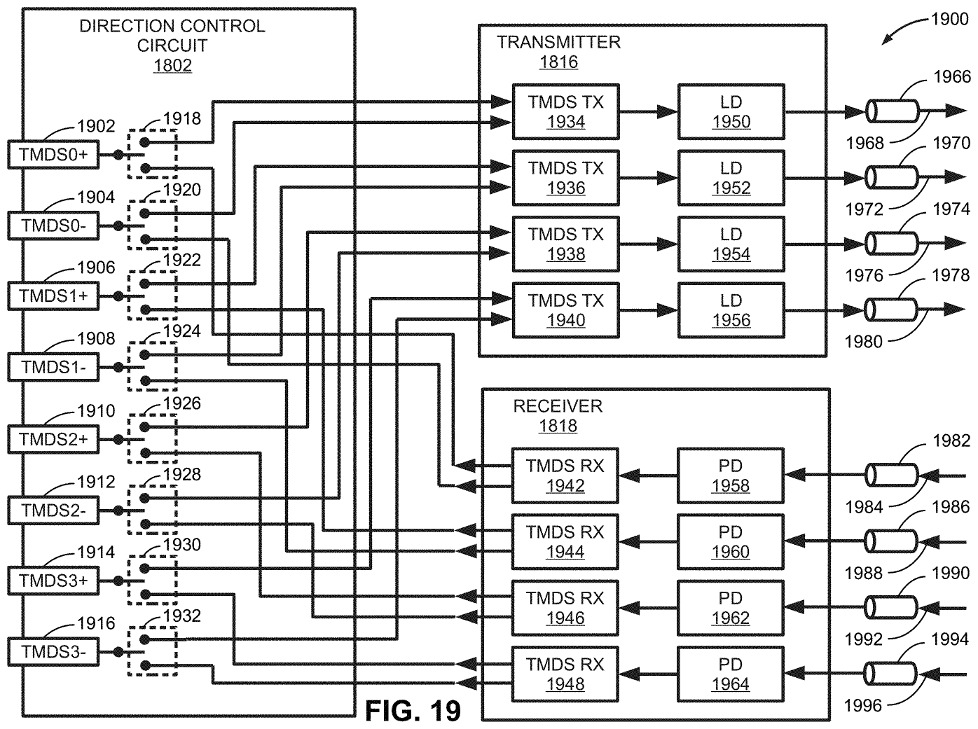

FIG. 19 is a block diagram depicting an embodiment of a direction control circuit high-speed interface 1900. As depicted, direction control circuit high-speed interface 1900 includes direction control circuit 1802, transmitter 1816, receiver 1818, and optical communication channels 1966, 1970, 1974, 1978, 1982, 1986, 1990, and 1994. Direction control circuit 1802 further includes TMDS0+ terminal 1902, TMDS0− terminal 1904, TMDS1+ terminal 1906, TMDS1− terminal 1908, TMDS2+ terminal 1910, TMDS2− terminal 1912, TMDS3+ terminal 1914, and TMDS3− terminal 1916. Direction control circuit 1802 further includes high-speed switches 1918, 1920, 1922, 1924, 1926, 1928, 1930, and 1932. In one aspect, each of high-speed switch 1918 through 1932 is a high-speed single-pole double-throw (SPDT) switch. Transmitter 1816 further includes TMDS optoelectronic transmitters TMDS TX 1934, TMDS TX 1936, TMDS TX 1938, and TMDS TX 1940. Transmitter 1816 further includes laser diodes LD 1950, LD 1952, LD 1954, and LD 1956. Receiver 1818 further includes TMDS optoelectronic receivers TMDS RX 1942, TMDS RX 1944, TMDS RX 1946, and TMDS RX 1948. Receiver 1818 further includes photodetectors PD 1958, PD 1960, PD 1962, and PD 1964. In one aspect, laser diodes LD 1950, LD 1952, LD 1954 and LD 1956 may be implemented using one or more VCSELs, or some other laser diodes.

In one aspect, direction control circuit high-speed interface 1900 is a high-speed counterpart of direction control circuit low-speed interface 1800. Direction control circuit 1802, transmitter 1816, and receiver 1818 may include all of the respective low-speed and high-speed components depicted in FIGS. 18 and 19.

In one aspect, if the HPD voltage monitored by HPD voltage detect 1814 is low, then HPD voltage detect 1814 determines that the HDMI connection associated with direction control circuit 1802 is to an HDMI source. In this case, each of high-speed switch 1918, 1920, 1922, 1924, 1926, 1928, 1930 and 1932 is switched by direction control circuit 1802 to connect TMDS0+ terminal 1902, TMDS0− terminal 1904, TMDS1+ terminal 1906, TMDS1− terminal 1908, TMDS2+ terminal 1910, TMDS2− terminal 1912, TMDS3+ terminal 1914, and TMDS3− terminal 1916 respectively, to transmitter 1816. In this mode:
TMDS TX 1934 receives a TMDS0+ and TMDS0− HDMI differential electrical signal pair from the HDMI source via TMDS0+ terminal 1902 and via switch 1918, and via TMDS0− terminal 1904 and via switch 1920, respectively.
TMDS TX 1936 receives a TMDS1+ and TMDS1− HDMI differential electrical signal pair from the HDMI source via TMDS1+ terminal 1906 and via switch 1922, and via TMDS1− terminal 1908 and via switch 1924, respectively.
TMDS TX 1938 receives a TMDS2+ and TMDS2− HDMI differential electrical signal pair from the HDMI source via TMDS2+ terminal 1910 and via switch 1926, and via TMDS2− terminal 1912 and via switch 1928, respectively.
TMDS TX 1940 receives a TMDS3+ and TMDS3− HDMI differential electrical signal pair from the HDMI source via TMDS3+ terminal 1914 and via switch 1930, and via TMDS3− terminal 1916 and via switch 1932, respectively.

In one aspect, each of TMDS TX 1934 through 1940 is a TMDS optoelectronic transmitter that is configured to perform signal conditioning such that the associated output signal is capable of driving a laser diode. Functionally:
TMDS TX 1934 converts the input TMDS0+/− HDMI differential electrical signal pair into a single-ended TMDS0 electrical signal that is conditioned to drive laser diode 1950. Laser diode 1950 converts the single-ended TMDS0 electrical signal into a TMDS0 optical signal 1968, and transmits TMDS0 optical signal 1968 over optical communication channel 1966.
TMDS TX 1936 converts the input TMDS1+/− HDMI differential electrical signal pair into a single-ended TMDS1 electrical signal that is conditioned to drive laser diode 1952. Laser diode 1952 converts the single-ended TMDS1 electrical signal into a TMDS1 optical signal 1972, and transmits TMDS1 optical signal 1972 over optical communication channel 1970.
TMDS TX 1938 converts the input TMDS2+/− HDMI differential electrical signal pair into a single-ended TMDS2 electrical signal that is conditioned to drive laser diode 1954. Laser diode 1954 converts the single-ended TMDS2 electrical signal into a TMDS2 optical signal 1976, and transmits TMDS2 optical signal 1976 over optical communication channel 1974.
TMDS TX 1940 converts the input TMDS3+/− HDMI differential electrical signal pair into a single-ended TMDS3 electrical signal that is conditioned to drive laser diode 1956. Laser diode 1956 converts the single-ended TMDS3 electrical signal into a TMDS3 optical signal 1980, and transmits TMDS3 optical signal 1980 over optical communication channel 1978.

In one aspect, if the HPD voltage monitored by HPD voltage detect 1814 is high, then HPD voltage detect 1814 determines that the HDMI connection associated with direction control circuit 1802 is to an HDMI sink. In this case, each of high-speed switch 1918, 1920, 1922, 1924, 1926, 1928, 1930 and 1932 is switched by direction control circuit 1802 to connect TMDS0+ terminal 1902, TMDS0− terminal 1904, TMDS1+ terminal 1906, TMDS1− terminal 1908, TMDS2+ terminal 1910, TMDS2− terminal 1912, TMDS3+ terminal 1914, and TMDS3− terminal 1916 respectively, to receiver 1818. In this mode:
Photodetector 1958 receives a TMDS0 optical signal 1984 over optical communication channel 1982. Photodetector 1958 converts TMDS0 optical signal 1984 into a single-ended TMDS0 electrical signal and transmits this single-ended TMDS0 electrical signal to TMDS RX 1942.
Photodetector 1960 receives a TMDS1 optical signal 1988 over optical communication channel 1986. Photodetector 1960 converts TMDS1 optical signal 1988 into a single-ended TMDS1 electrical signal and transmits this single-ended TMDS1 electrical signal to TMDS RX 1944.
Photodetector 1962 receives a TMDS2 optical signal 1992 over optical communication channel 1990. Photodetector 1962 converts TMDS2 optical signal 1992 into a single-ended TMDS2 electrical signal and transmits this single-ended TMDS2 electrical signal to TMDS RX 1946.
Photodetector 1964 receives a TMDS3 optical signal 1996 over optical communication channel 1994. Photodetector 1964 converts TMDS3 optical signal 1996 into a single-ended TMDS3 electrical signal and transmits this single-ended TMDS3 electrical signal to TMDS RX 1948.

In one aspect, each of TMDS RX 1942 through 1948 is a TMDS optoelectronic receiver that is configured to condition an electrical signal output by each of PD 1958 through 1964 (respectively) and transmit associated differential signal pairs to high-speed switches 1918 through 1932. Functionally:

TMDS RX 1942 receives a single-ended TMDS0 electrical signal from photodetector 1958, and converts the single-ended TMDS0 electrical signal into a differential TMDS0+/− electrical signal pair. Of this signal pair, TMDS RX 1942 transmits the TMDS0+ signal to TMDS0+ terminal 1902 via high-speed switch 1918. TMDS RX 1942 also transmits the TMDS0− signal to TMDS0− terminal 1904 via high-speed switch 1920.

TMDS RX 1944 receives a single-ended TMDS1 electrical signal from photodetector 1960, and converts the single-ended TMDS1 electrical signal into a differential TMDS1+/− electrical signal pair. Of this signal pair, TMDS RX 1944 transmits the TMDS1+ signal to TMDS1+ terminal 1906 via high-speed switch 1922. TMDS RX 1944 also transmits the TMDS1− signal to TMDS1− terminal 1908 via high-speed switch 1924.

TMDS RX 1946 receives a single-ended TMDS2 electrical signal from photodetector 1962, and converts the single-ended TMDS2 electrical signal into a differential TMDS2+/− electrical signal pair. Of this signal pair, TMDS RX 1946 transmits the TMDS2+ signal to TMDS2+ terminal 1910 via high-speed switch 1926. TMDS RX 1946 also transmits the TMDS2− signal to TMDS2− terminal 1912 via high-speed switch 1928.

TMDS RX 1948 receives a single-ended TMDS3 electrical signal from photodetector 1964, and converts the single-ended TMDS3 electrical signal into a differential TMDS3+/− electrical signal pair. Of this signal pair, TMDS RX 1948 transmits the TMDS3+ signal to TMDS3+ terminal 1914 via high-speed switch 1930. TMDS RX 1948 also transmits the TMDS3− signal to TMDS3− terminal 1916 via high-speed switch 1932.

All the TMDS0+/−, TMDS1+/−, TMDS2+/−, and TMDS3+/− electrical signals are transmitted from the respective terminals to the HDMI sink.

In one aspect, each of optical communication channel 1966, 1970, 1974, 1978, 1982, 1986, 1990, and 1994 is comprised of one or more optical fibers.

In one aspect, high-speed switches 1918 through 1932 are any combination of radio-frequency switches, MEMS switches, relay switches, transmission gates, or any other kind of electrical switch. High-speed switches 1844 through 1850 may be selected to provide minimal degradation in signal transmission quality.

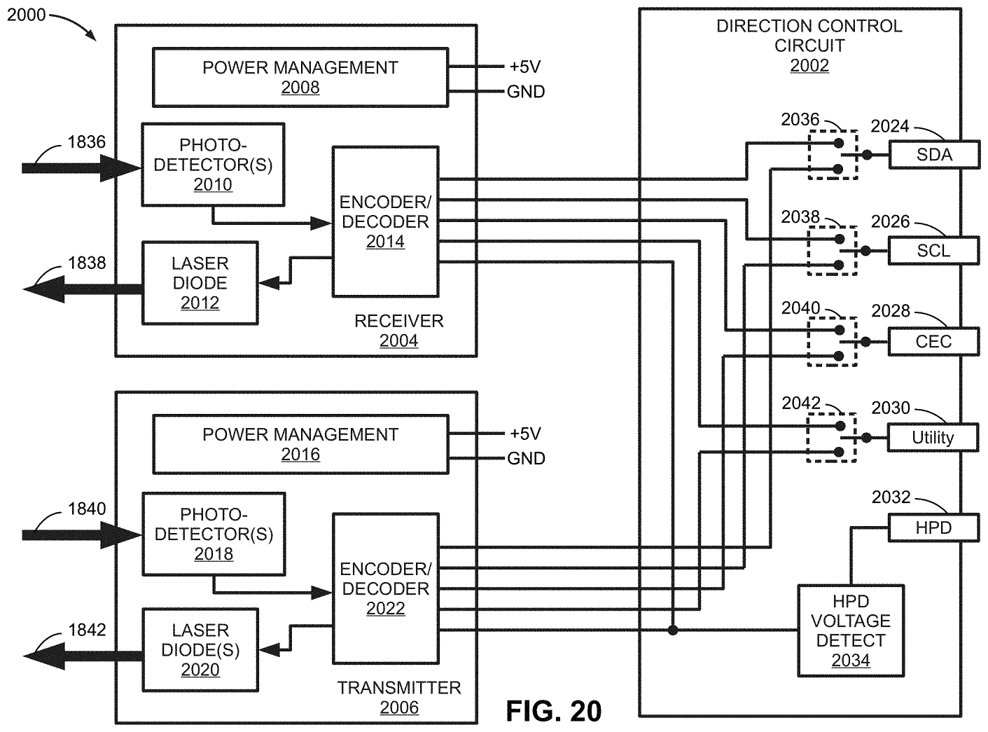

FIG. 20 is a block diagram depicting an embodiment of a direction control circuit low-speed interface 2000. As depicted, direction control circuit low-speed 2000 interface includes direction control circuit 2002, transmitter 2006, receiver 2004, and optical communication channels 1836, 1838, 1840, and 1842. Direction control circuit 2002 further includes SDA terminal 2024, SCL terminal 2026, CEC terminal 2028, Utility terminal 2030, HPD terminal 2032, HPD voltage detect 2034, and low-speed switches 2036, 2038, 2040, and 2042. Transmitter 2006 further includes power management 2016, encoder/decoder 2022, one or more laser diodes 2020, and one or more photodetectors 2018. Receiver 2004 further includes power management 2008, encoder/decoder 2014, one or more laser diodes 2012, and one or more photodetectors 2010. In one aspect, each of low-speed switch 2036 through 2042 is a low-speed single-pole, double-throw (SPDT) switch. In one aspect, laser diodes 2012 and 2020 may be implemented using one or more VCSELs, or some other laser diodes.

In one aspect, direction control circuit 2002 may be similar to direction control circuit 1704. When direction control circuit 2002 is connected to an HDMI receptacle of an HDMI source or an HDMI sink, HPD voltage detect 2034 functions as a hot-plug detection (HPD) circuit. Specifically, HPD voltage detect 2034 monitors a hot-plug voltage associated with the HDMI receptacle. If this voltage is high, then HPD voltage detect 2034 determines that the HDMI connection associated with direction control circuit 2002 is to an HDMI sink. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to receiver 2004. In this mode, encoder/decoder 2014 receives a Utility electrical signal from the HDMI sink via Utility terminal 2030 and via switch 2042, and an HPD electrical signal from the HDMI sink via HPD terminal 2032.

In one aspect, encoder/decoder 2014 is configured to receive the Utility and HPD electrical signals, and appropriately encode these signals for transmission. In one aspect, encoder/decoder 2014 maps any received electrical signals to a corresponding number of laser diodes and fiber optic channels, and any received optical signals to a corresponding number of photodetectors. The encoded Utility and HPD electrical signals are converted into corresponding optical signals by laser diodes 2012, and transmitted over optical communication channel 1838 to a transmitter associated with an HDMI source. In one aspect, optical communication channel 1838 is comprised of one or more optical fibers. Encoder/decoder 2014 may multiplex or encode the Utility and HPD electrical signals to appropriately map to the number of optical fibers included in optical communication channel 1838. Accordingly, each optical fiber in optical communication channel 1838 may be connected upstream to a single laser diode included in laser diodes 2012. In other words, laser diodes 2012 may include a number of laser diodes that is equal to the number of optical fibers in optical communication channel 1838. Each laser diode converts an electrically-encoded signal (i.e., encoded Utility and HPD electrical signals) from encoder/decoder 2014, and converts the associated electrically-encoded signal into a corresponding optical signal for transmission over optical communication channel 1838.

In one aspect, receiver 2004 is configured to receive SDA, SCL, and CEC optical signals over optical communication channel 1836. These optical communication signals may be received from a transmitter associated with an HDMI source. In one aspect, the SDA, SCL, and CEC optical signals are received by photodetectors 2010 and converted into SDA, SCL, and CEC electrical signals. The SDA, SCL, and CEC signals may be encoded in a suitable format. In one aspect, optical communication channel 1836 is comprised of one or more optical fibers. Accordingly, each optical fiber in optical communication channel may be connected downstream to a photodetector included in photodetectors 2010. In other words, photodetectors 2010 may include a number of photodetectors that is equal to the number of optical fibers in optical communication channel 1836. Each photodetector converts an electrically-encoded signal (i.e., encoded SDA, SCL, and CEC optical signals) from the HDMI source, and converts the associated optical signal into a corresponding electrical signal.

In one aspect, encoder/decoder 2014 receives the encoded SDA, SCL, and CEC electrical signals from photodetectors 2010, and decodes the SDA, SCL, and CEC electrical signals. Encoder/decoder 2014 outputs the decoded SDA, SCL, and CEC signals. The decoded SDA electrical signal may be transmitted to SDA terminal 2024 via low-speed switch 2036. The decoded SCL electrical signal may be transmitted to SCL terminal 2026 via low-speed switch 2038. The decoded CEC electrical signal may be transmitted to CEC terminal 2028 via low-speed switch 2040. These decoded SDA, SCL and CEC signals are transmitted to the HDMI sink, via SDA terminal 2024, SCL terminal 2026, and CEC terminal 2028, respectively.

In one aspect, power management 2008 is configured to provide a +5V triggering voltage and ground signal to the HDMI sink. The +5V triggering signal and ground signal function in accordance with the HDMI protocol.

If the voltage monitored by HPD voltage detect 2034 is low, then HPD voltage detect 2034 determines that the HDMI connection associated with direction control circuit 2002 is to an HDMI source. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to transmitter 2006. In this mode, encoder/decoder 2022 receives an SDA electrical signal from the HDMI source via SDA terminal 2024 and via switch 2036, an SCL electrical signal from the HDMI source via SCL terminal 2026 and via switch 2038, and an CEC electrical signal from the HDMI source via CEC terminal 2028 via switch 2040.

In one aspect, encoder/decoder 2022 is configured to receive the SDA, SCL and CEC electrical signals, and appropriately encode these signals for transmission. In one aspect, encoder/decoder 2022 maps any received electrical signals to a corresponding number of laser diodes and fiber optic channels, and any received optical signals to a corresponding number of photodetectors. The encoded SDA, SCL and CEC electrical signals are converted into corresponding optical signals by laser diodes 2020, and transmitted over optical communication channel 1842 to a receiver associated with an HDMI sink. In one aspect, optical communication channel 1842 is comprised of one or more optical fibers. Encoder/decoder 2022 may multiplex or encode the SDA, SCL and CEC electrical signals to appropriately map to the number of optical fibers included in optical communication channel 1842. Accordingly, each optical fiber in optical communication channel 1842 may be connected upstream to a single laser diode included in laser diodes 2020. In other words, laser diodes 2020 may include a number of laser diodes that is equal to the number of optical fibers in optical communication channel 1842. Each laser diode converts an electrically-encoded signal (i.e., encoded SDA, SCL, and CEC electrical signals) from encoder/decoder 2022, and converts the associated electrically-encoded signal into a corresponding optical signal for transmission over optical communication channel 1842.

In one aspect, transmitter 2006 is configured to receive HPD and Utility optical signals over optical communication channel 1840. These optical communication signals may be received from a receiver associated with an HDMI sink. In one aspect, the HPD and Utility optical signals are received by photodetectors 2018 and converted into corresponding HPD and Utility electrical signals. The HPD and Utility signals may be encoded in a suitable format. In one aspect, optical communication channel 1840 is comprised of one or more optical fibers. Accordingly, each optical fiber in optical communication channel may be connected downstream to a photodetector included in photodetectors 2018. In other words, photodetectors 2018 may include a number of photodetectors that is equal to the number of optical fibers in optical communication channel 1840. Each photodetector converts an electrically-encoded signal (i.e., encoded HPD and Utility optical signals) from the HDMI sink, and converts the associated optical signal into a corresponding electrical signal.

In one aspect, encoder/decoder 2022 receives the encoded HPD and Utility electrical signals from photodetectors 2018, and decodes the HPD and Utility electrical signals. Encoder/decoder 2022 outputs the decoded HPD and Utility electrical signals. The decoded Utility electrical signal may be transmitted to Utility terminal 2030 via low-speed switch 2042. The decoded HPD electrical signal may be transmitted to HPD terminal 2032. The Utility and HPD signals are transmitted to the HDMI source via Utility terminal 2030 and HPD terminal 2032, respectively.

In one aspect, power management 2016 is configured to provide a +5V triggering voltage and ground signal to the HDMI source. The +5V triggering signal and ground signal function in accordance with the HDMI protocol.

In one aspect, low-speed switches 2036 through 2042 are any combination of radio-frequency switches, MEMS switches, relay switches, transmission gates, or any other kind of electrical switch. Low-speed switches 2036 through 2042 may be selected to provide minimal degradation in signal transmission quality.

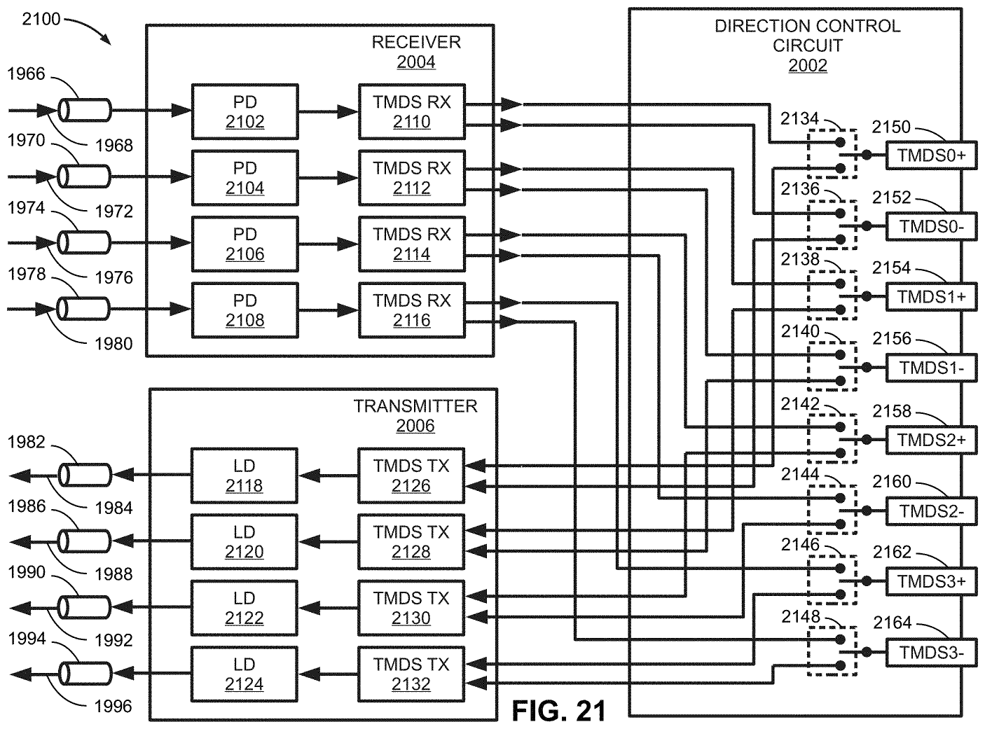

FIG. 21 is a block diagram depicting an embodiment of a direction control circuit high-speed interface 2100. As depicted, direction control circuit high-speed interface 2100 includes direction control circuit 2002, transmitter 2006, receiver 2004, and optical communication channels 1966, 1970, 1974, 1978, 1892, 1896, 1990, and 1994. Direction control circuit 2002 further includes TMDS0+ terminal 2150, TMDS0− terminal 2152, TMDS1+ terminal 2154, TMDS1− terminal 2156, TMDS2+ terminal 2158, TMDS2− terminal 2160, TMDS3+ terminal 2162, and TMDS3− terminal 2164. Direction control circuit 2002 further includes high-speed switches 2134, 2136, 2138, 2140, 2142, 2144, 2146, and 2148. In one aspect, each of high-speed switch 2134 through 2148 is a high-speed single-pole double-throw (SPDT) switch. Transmitter 2006 further includes TMDS optoelectronic transmitters TMDS TX 2126, TMDS TX 2128, TMDS TX 2130, and TMDS TX 2132. Transmitter 2006 further includes laser diodes LD 2118, LD 2120, LD 2122, and LD 2124. Receiver 2004 further includes TMDS optoelectronic receivers TMDS RX 2110, TMDS RX 2112, TMDS RX 2114, and TMDS RX 2116. Receiver 2004 further includes photodetectors PD 2102, PD 2104, PD 2106, and PD 2108. In one aspect, laser diodes LD 2118, LD 2120, LD 2122 and LD 2124 may be implemented using one or more VCSELs, or some other laser diodes.

In one aspect, direction control circuit high-speed interface 2100 is a high-speed counterpart of direction control circuit low-speed interface 2000. Direction control circuit 2002, transmitter 2006, and receiver 2004 may include all of the respective low-speed and high-speed components depicted in FIGS. 20 and 21.

In one aspect, if the HPD voltage monitored by HPD voltage detect 2034 is high, then HPD voltage detect 2034 determines that the HDMI connection associated with direction control circuit 2002 is to an HDMI sink. In this case, each of high-speed switch 2134, 2136, 2138, 2140, 2142, 2144, 2146 and 2148 is switched by direction control circuit 2002 to connect TMDS0+ terminal 2150, TMDS0− terminal 2152, TMDS1+ terminal 2154, TMDS1− terminal 2156, TMDS2+ terminal 2158, TMDS2− terminal 2160, TMDS3+ terminal 2162, and TMDS3− terminal 2164 respectively, to receiver 2004. In this mode:
Photodetector 2102 receives TMDS0 optical signal 1968 over optical communication channel 1966. Photodetector 2102 converts TMDS0 optical signal 1968 into a single-ended TMDS0 electrical signal and transmits this single-ended TMDS0 electrical signal to TMDS RX 2110.
Photodetector 2104 receives TMDS1 optical signal 1972 over optical communication channel 1970. Photodetector 2104 converts TMDS1 optical signal 1972 into a single-ended TMDS1 electrical signal and transmits this single-ended TMDS1 electrical signal to TMDS RX 2112.
Photodetector 2016 receives TMDS2 optical signal 1976 over optical communication channel 1974. Photodetector 2106 converts TMDS2 optical signal 1976 into a single-ended TMDS2 electrical signal and transmits this single-ended TMDS2 electrical signal to TMDS RX 2114.
Photodetector 2018 receives TMDS3 optical signal 1980 over optical communication channel 1978. Photodetector 2108 converts TMDS3 optical signal 1980 into a single-ended TMDS3 electrical signal and transmits this single-ended TMDS3 electrical signal to TMDS RX 2116.

In one aspect, each of TMDS RX 2110 through 2116 is a TMDS optoelectronic receiver that is configured to condition an electrical signal output by each of PD 2102 through 2108 (respectively) and transmit associated differential signal pairs to high-speed switches 2134 through 2148. Functionally:

TMDS RX 2110 receives a single-ended TMDS0 electrical signal from photodetector 2102, and converts the single-ended TMDS0 electrical signal into a differential TMDS0+/− electrical signal pair. Of this signal pair, TMDS RX 2110 transmits the TMDS0+ signal to TMDS0+ terminal 2150 via high-speed switch 2134. TMDS RX 2110 also transmits the TMDS0− signal to TMDS0− terminal 2152 via high-speed switch 2136.

TMDS RX 2112 receives a single-ended TMDS1 electrical signal from photodetector 2104, and converts the single-ended TMDS1 electrical signal into a differential TMDS1+/− electrical signal pair. Of this signal pair, TMDS RX 2112 transmits the TMDS1+ signal to TMDS1+ terminal 2154 via high-speed switch 2138. TMDS RX 2112 also transmits the TMDS1− signal to TMDS1− terminal 2156 via high-speed switch 2140.

TMDS RX 2114 receives a single-ended TMDS2 electrical signal from photodetector 2106, and converts the single-ended TMDS2 electrical signal into a differential TMDS2+/− electrical signal pair. Of this signal pair, TMDS RX 2114 transmits the TMDS2+ signal to TMDS2+ terminal 2158 via high-speed switch 2142. TMDS RX 2114 also transmits the TMDS2− signal to TMDS2− terminal 2160 via high-speed switch 2144.

TMDS RX 2116 receives a single-ended TMDS3 electrical signal from photodetector 2108, and converts the single-ended TMDS3 electrical signal into a differential TMDS3+/− electrical signal pair. Of this signal pair, TMDS RX 2116 transmits the TMDS3+ signal to TMDS3+ terminal 2162 via high-speed switch 2146. TMDS RX 2116 also transmits the TMDS3− signal to TMDS3− terminal 2164 via high-speed switch 2148.

All the TMDS0+/−, TMDS1+/−, TMDS2+/−, and TMDS3+/− electrical signals are transmitted from the respective terminals to the HDMI sink.

In one aspect, if the HPD voltage monitored by HPD voltage detect 2034 is low, then HPD voltage detect 2034 determines that the HDMI connection associated with direction control circuit 2002 is to an HDMI source. In this case, each of high-speed switch 2134, 2136, 2138, 2140, 2142, 2144, 2146 and 2148 is switched by direction control circuit 2002 to connect TMDS0+ terminal 2150, TMDS0− terminal 2152, TMDS1+ terminal 2154, TMDS1− terminal 2156, TMDS2+ terminal 2158, TMDS2− terminal 2160, TMDS3+ terminal 2162, and TMDS3− terminal 2164 respectively, to transmitter 2006. In this mode:
TMDS TX 2126 receives a TMDS0+ and TMDS0− HDMI differential electrical signal pair from the HDMI source via TMDS0+ terminal 2150 and via switch 2134, and via TMDS0− terminal 2152 and via switch 2136, respectively.
TMDS TX 2128 receives a TMDS1+ and TMDS1− HDMI differential electrical signal pair from the HDMI source via TMDS1+ terminal 2154 and via switch 2138, and via TMDS1− terminal 2156 and via switch 2140, respectively.
TMDS TX 2130 receives a TMDS2+ and TMDS2− HDMI differential electrical signal pair from the HDMI source via TMDS2+ terminal 2158 and via switch 2142, and via TMDS2− terminal 2160 and via switch 2144, respectively.
TMDS TX 2132 receives a TMDS3+ and TMDS3− HDMI differential electrical signal pair from the HDMI source via TMDS3+ terminal 2162 and via switch 2146, and via TMDS3− terminal 2164 and via switch 2148, respectively.

In one aspect, each of TMDS TX 2126 through 2132 is a TMDS optoelectronic transmitter that is configured to perform signal conditioning such that the associated output signal is capable of driving a laser diode. Functionally:
TMDS TX 2126 converts the input TMDS0+/− HDMI differential electrical signal pair into a single-ended TMDS0 electrical signal that is conditioned to drive laser diode 2118. Laser diode 2118 converts the single-ended TMDS0 electrical signal into TMDS0 optical signal 1984, and transmits TMDS0 optical signal 1984 over optical communication channel 1982.
TMDS TX 2128 converts the input TMDS1+/− HDMI differential electrical signal pair into a single-ended TMDS1 electrical signal that is conditioned to drive laser diode 2120. Laser diode 2120 converts the single-ended TMDS1 electrical signal into TMDS1 optical signal 1988, and transmits TMDS1 optical signal 1988 over optical communication channel 1986.
TMDS TX 2130 converts the input TMDS2+/− HDMI differential electrical signal pair into a single-ended TMDS2 electrical signal that is conditioned to drive laser diode 2122. Laser diode 2122 converts the single-ended TMDS2 electrical signal into TMDS2 optical signal 1992, and transmits TMDS2 optical signal 1992 over optical communication channel 1990.
TMDS TX 2132 converts the input TMDS3+/− HDMI differential electrical signal pair into a single-ended TMDS3 electrical signal that is conditioned to drive laser diode 2124. Laser diode 2124 converts the single-ended TMDS3 electrical signal into TMDS3 optical signal 1996, and transmits TMDS3 optical signal 1996 over optical communication channel 1994.

In one aspect, high-speed switches 2134 through 2148 are any combination of radio-frequency switches, MEMS switches, relay switches, transmission gates, or any other kind of electrical switch. Low-speed switches 2134 through 2148 may be selected to provide minimal degradation in signal transmission quality.

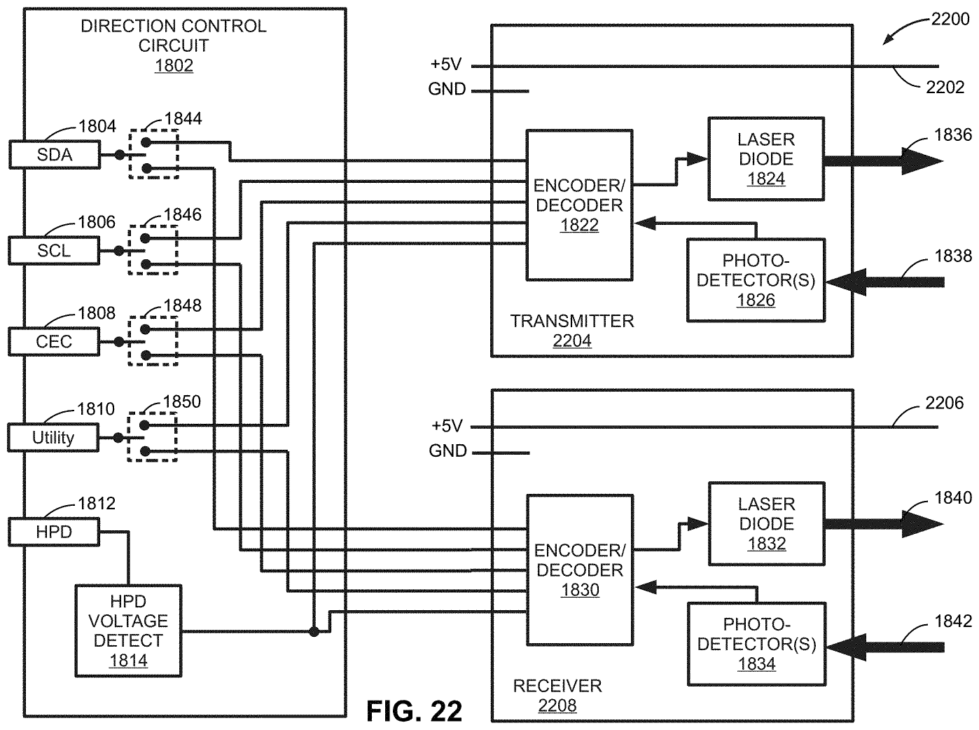

FIG. 22 is a block diagram depicting an embodiment of a direction control circuit low-speed interface 2200. As depicted, direction control circuit low-speed 2200 interface includes direction control circuit 1802, transmitter 2204, receiver 2208, and optical communication channels 1836, 1838, 1840, and 1842. Direction control circuit 1802 further includes SDA terminal 1804, SCL terminal 1806, CEC terminal 1808, Utility terminal 1810, HPD terminal 1812, HPD voltage detect 1814, and low-speed switches 1844, 1846, 1848, and 1850. Transmitter 2204 further includes encoder/decoder 1822, one or more laser diodes 1824, and one or more photodetectors 1826. Receiver 2208 further includes encoder/decoder 1830, one or more laser diodes 1832, and one or more photodetectors 1834. In one aspect, each of low-speed switch 1844 through 1850 is a low-speed single-pole, double-throw (SPDT) switch.

In one aspect, direction control circuit 1802 may be similar to direction control circuit 1702. When direction control circuit 1802 is connected to an HDMI receptacle of an HDMI source or an HDMI sink, HPD voltage detect 1814 functions as a hot-plug detection (HPD) circuit. Specifically, HPD voltage detect 1814 monitors a hot-plug voltage associated with the HDMI receptacle. If this voltage is low, then HPD voltage detect 1814 determines that the HDMI connection associated with direction control circuit 1802 is to an HDMI source. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to transmitter 2204. In this mode, encoder/decoder 1822 receives an SDA electrical signal from the HDMI source via SDA terminal 1804 and via switch 1844, an SCL electrical signal from the HDMI source via SCL terminal 1806 and via switch 1846, and an CEC electrical signal from the HDMI source via CEC terminal 1808 via switch 1848.

In one aspect, encoder/decoder 1822 is configured to receive the SDA, SCL and CEC electrical signals, and appropriately encode these signals for transmission. The encoded SDA, SCL and CEC electrical signals are converted into corresponding optical signals by laser diodes 1824, and transmitted over optical communication channel 1836 to a receiver associated with an HDMI sink. In one aspect, optical communication channel 1836 is comprised of one or more optical fibers. Encoder/decoder 1822 may multiplex or encode the SDA, SCL and CEC electrical signals to appropriately map to the number of optical fibers included in optical communication channel 1836. Accordingly, each optical fiber in optical communication channel 1836 may be connected upstream to a single laser diode included in laser diodes 1824. In other words, laser diodes 1824 may include a number of laser diodes that is equal to the number of optical fibers in optical communication channel 1836. Each laser diode converts an electrically-encoded signal (i.e., encoded SDA, SCL, and CEC electrical signals) from encoder/decoder 1822, and converts the associated electrically-encoded signal into a corresponding optical signal for transmission over optical communication channel 1836.

In one aspect, transmitter 2204 is configured to receive HPD and Utility optical signals over optical communication channel 1838. These optical communication signals may be received from a receiver associated with an HDMI sink. In one aspect, the HPD and Utility optical signals are received by photodetectors 1826 and converted into corresponding HPD and Utility electrical signals. The HPD and Utility signals may be encoded in a suitable format. In one aspect, optical communication channel 1838 is comprised of one or more optical fibers. Accordingly, each optical fiber in optical communication channel may be connected downstream to a photodetector included in photodetectors 1826. In other words, photodetectors 1826 may include a number of photodetectors that is equal to the number of optical fibers in optical communication channel 1838. Each photodetector converts an electrically-encoded signal (i.e., encoded HPD and Utility optical signals) from the HDMI sink, and converts the associated optical signal into a corresponding electrical signal.

In one aspect, encoder/decoder 1822 receives the encoded HPD and Utility electrical signals from photodetectors 1826, and decodes the HPD and Utility electrical signals. Encoder/decoder 1822 outputs the decoded HPD and Utility electrical signals. The decoded Utility electrical signal may be transmitted to Utility terminal 1818 via low-speed switch 1850. The decoded HPD electrical signal may be transmitted to HPD terminal 1812. The Utility and HPD signals are transmitted to the HDMI source via Utility terminal 1810 and HPD terminal 1812, respectively.

In one aspect, a +5V signal 2202 and associated ground (GND) triggering signal are transmitted by transmitter 2204 to a connected HDMI sink.

If the voltage monitored by HPD voltage detect 1814 is high, then HPD voltage detect 1814 determines that the HDMI connection associated with direction control circuit 1802 is to an HDMI sink. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to receiver 2208. In this mode, encoder/decoder 1822 receives a Utility electrical signal from the HDMI sink via Utility terminal 1810 and via switch 1850, and an HPD electrical signal from the HDMI sink via HPD terminal 1812.

In one aspect, encoder/decoder 1830 is configured to receive the Utility and HPD electrical signals, and appropriately encode these signals for transmission. The encoded Utility and HPD electrical signals are converted into corresponding optical signals by laser diodes 1832, and transmitted over optical communication channel 1840 to a transmitter associated with an HDMI source. In one aspect, optical communication channel 1840 is comprised of one or more optical fibers. Encoder/decoder 1830 may multiplex or encode the Utility and HPD electrical signals to appropriately map to the number of optical fibers included in optical communication channel 1840. Accordingly, each optical fiber in optical communication channel 1840 may be connected upstream to a single laser diode included in laser diodes 1832. In other words, laser diodes 1832 may include a number of laser diodes that is equal to the number of optical fibers in optical communication channel 1840. Each laser diode converts an electrically-encoded signal (i.e., encoded Utility and HPD electrical signals) from encoder/decoder 1830, and converts the associated electrically-encoded signal into a corresponding optical signal for transmission over optical communication channel 1840.

In one aspect, receiver 2208 is configured to receive SDA, SCL, and CEC optical signals over optical communication channel 1842. These optical communication signals may be received from a transmitter associated with an HDMI source. In one aspect, the SDA, SCL, and CEC optical signals are received by photodetectors 1834 and converted into SDA, SCL, and CEC electrical signals. The SDA, SCL, and CEC signals may be encoded in a suitable format. In one aspect, optical communication channel 1842 is comprised of one or more optical fibers. Accordingly, each optical fiber in optical communication channel may be connected downstream to a photodetector included in photodetectors 1834. In other words, photodetectors 1834 may include a number of photodetectors that is equal to the number of optical fibers in optical communication channel 1842. Each photodetector converts an electrically-encoded signal (i.e., encoded SDA, SCL, and CEC optical signals) from the HDMI source, and converts the associated optical signal into a corresponding electrical signal.

In one aspect, encoder/decoder 1830 receives the encoded SDA, SCL, and CEC electrical signals from photodetectors 1834, and decodes the SDA, SCL, and CEC electrical signals. Encoder/decoder 1830 outputs the decoded SDA, SCL, and CEC signals. The decoded SDA electrical signal may be transmitted to SDA terminal 1804 via low-speed switch 1844. The decoded SCL electrical signal may be transmitted to SCL terminal 1806 via low-speed switch 1846. The decoded CEC electrical signal may be transmitted to CEC terminal 1808 via low-speed switch 1848. These decoded SDA, SCL and CEC signals are transmitted to the HDMI sink, via SDA terminal 1804, SCL terminal 1806, and CEC terminal 1808, respectively.

In one aspect, a +5V signal 2206 and associated ground (GND) triggering signal are received by receiver 2208 from a connected HDMI source.

In one aspect, direction control circuit low-speed interface 2200 may be combined with direction control circuit high-speed interface 1900 to implement a combination of direction control circuit 1702, transmitter 1706, and receiver 1710.

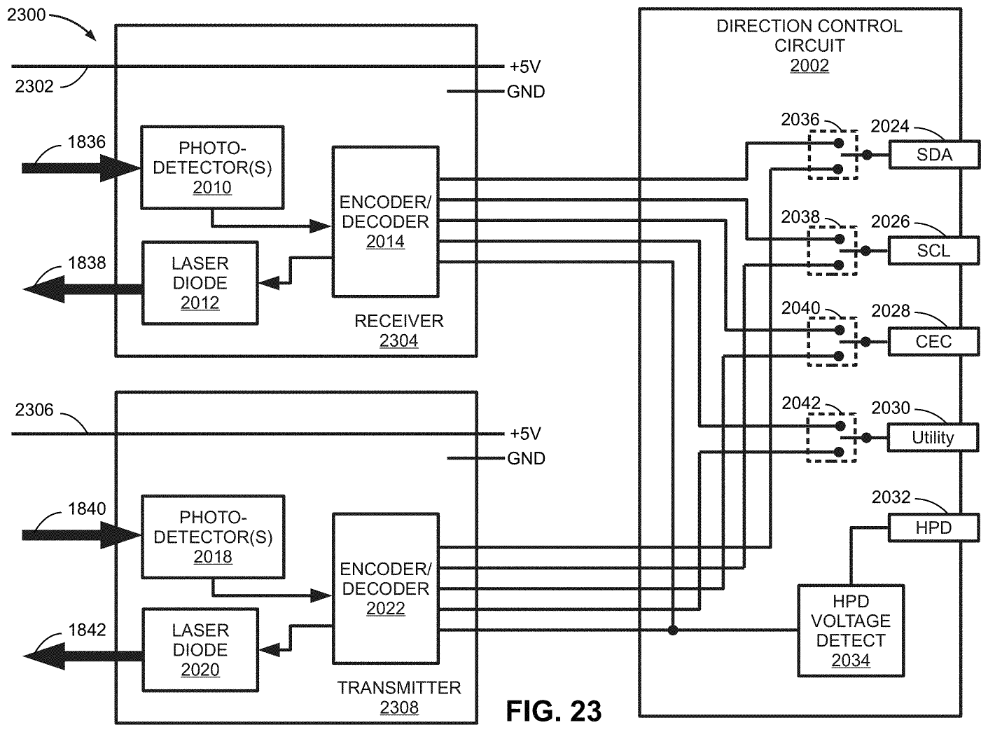

FIG. 23 is a block diagram depicting an embodiment of a direction control circuit low-speed interface 2300. As depicted, direction control circuit low-speed 2300 interface includes direction control circuit 2002, transmitter 2308, receiver 2304, and optical communication channels 1836, 1838, 1840, and 1842. Direction control circuit 2002 further includes SDA terminal 2024, SCL terminal 2026, CEC terminal 2028, Utility terminal 2030, HPD terminal 2032, HPD voltage detect 2034, and low-speed switches 2036, 2038, 2040, and 2042. Transmitter 2308 further includes encoder/decoder 2022, one or more laser diodes 2020, and one or more photodetectors 2018. Receiver 2304 further includes encoder/decoder 2014, one or more laser diodes 2012, and one or more photodetectors 2010. In one aspect, each of low-speed switch 2036 through 2042 is a low-speed single-pole, double-throw (SPDT) switch.

In one aspect, direction control circuit 2002 may be similar to direction control circuit 1704. When direction control circuit 2002 is connected to an HDMI receptacle of an HDMI source or an HDMI sink, HPD voltage detect 2034 functions as a hot-plug detection (HPD) circuit. Specifically, HPD voltage detect 2034 monitors a hot-plug voltage associated with the HDMI receptacle. If this voltage is high, then HPD voltage detect 2034 determines that the HDMI connection associated with direction control circuit 2002 is to an HDMI sink. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to receiver 2304. In this mode, encoder/decoder 2014 receives a Utility electrical signal from the HDMI sink via Utility terminal 2030 and via switch 2042, and an HPD electrical signal from the HDMI sink via HPD terminal 2032.

In one aspect, encoder/decoder 2014 is configured to receive the Utility and HPD electrical signals, and appropriately encode these signals for transmission. In one aspect, encoder/decoder 2014 maps any received electrical signals to a corresponding number of laser diodes and fiber optic channels, and any received optical signals to a corresponding number of photodetectors. The encoded Utility and HPD electrical signals are converted into corresponding optical signals by laser diodes 2012, and transmitted over optical communication channel 1838 to a transmitter associated with an HDMI source. In one aspect, optical communication channel 1838 is comprised of one or more optical fibers. Encoder/decoder 2014 may multiplex or encode the Utility and HPD electrical signals to appropriately map to the number of optical fibers included in optical communication channel 1838. Accordingly, each optical fiber in optical communication channel 1838 may be connected upstream to a single laser diode included in laser diodes 2012. In other words, laser diodes 2012 may include a number of laser diodes that is equal to the number of optical fibers in optical communication channel 1838. Each laser diode converts an electrically-encoded signal (i.e., encoded Utility and HPD electrical signals) from encoder/decoder 2014, and converts the associated electrically-encoded signal into a corresponding optical signal for transmission over optical communication channel 1838.

In one aspect, receiver 2304 is configured to receive SDA, SCL, and CEC optical signals over optical communication channel 1836. These optical communication signals may be received from a transmitter associated with an HDMI source. In one aspect, the SDA, SCL, and CEC optical signals are received by photodetectors 2010 and converted into SDA, SCL, and CEC electrical signals. The SDA, SCL, and CEC signals may be encoded in a suitable format. In one aspect, optical communication channel 1836 is comprised of one or more optical fibers. Accordingly, each optical fiber in optical communication channel may be connected downstream to a photodetector included in photodetectors 2010. In other words, photodetectors 2010 may include a number of photodetectors that is equal to the number of optical fibers in optical communication channel 1836. Each photodetector converts an electrically-encoded signal (i.e., encoded SDA, SCL, and CEC optical signals) from the HDMI source, and converts the associated optical signal into a corresponding electrical signal.

In one aspect, encoder/decoder 2014 receives the encoded SDA, SCL, and CEC electrical signals from photodetectors 2010, and decodes the SDA, SCL, and CEC electrical signals. Encoder/decoder 2014 outputs the decoded SDA, SCL, and CEC signals. The decoded SDA electrical signal may be transmitted to SDA terminal 2024 via low-speed switch 2036. The decoded SCL electrical signal may be transmitted to SCL terminal 2026 via low-speed switch 2038. The decoded CEC electrical signal may be transmitted to CEC terminal 2028 via low-speed switch 2040. These decoded SDA, SCL and CEC signals are transmitted to the HDMI sink, via SDA terminal 2024, SCL terminal 2026, and CEC terminal 2028, respectively.

In one aspect, a +5V signal 2302 and associated ground (GND) triggering signal are received by receiver 2304 from a connected HDMI source.

If the voltage monitored by HPD voltage detect 2034 is low, then HPD voltage detect 2034 determines that the HDMI connection associated with direction control circuit 2002 is to an HDMI source. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to transmitter 2308. In this mode, encoder/decoder 2022 receives an SDA electrical signal from the HDMI source via SDA terminal 2024 and via switch 2036, an SCL electrical signal from the HDMI source via SCL terminal 2026 and via switch 2038, and an CEC electrical signal from the HDMI source via CEC terminal 2028 via switch 2040.

In one aspect, encoder/decoder 2022 is configured to receive the SDA, SCL and CEC electrical signals, and appropriately encode these signals for transmission. In one aspect, encoder/decoder 2022 maps any received electrical signals to a corresponding number of laser diodes and fiber optic channels, and any received optical signals to a corresponding number of photodetectors. The encoded SDA, SCL and CEC electrical signals are converted into corresponding optical signals by laser diodes 2020, and transmitted over optical communication channel 1842 to a receiver associated with an HDMI sink. In one aspect, optical communication channel 1842 is comprised of one or more optical fibers. Encoder/decoder 2022 may multiplex or encode the SDA, SCL and CEC electrical signals to appropriately map to the number of optical fibers included in optical communication channel 1842. Accordingly, each optical fiber in optical communication channel 1842 may be connected upstream to a single laser diode included in laser diodes 2020. In other words, laser diodes 2020 may include a number of laser diodes that is equal to the number of optical fibers in optical communication channel 1842. Each laser diode converts an electrically-encoded signal (i.e., encoded SDA, SCL, and CEC electrical signals) from encoder/decoder 2022, and converts the associated electrically-encoded signal into a corresponding optical signal for transmission over optical communication channel 1842.

In one aspect, transmitter 2308 is configured to receive HPD and Utility optical signals over optical communication channel 1840. These optical communication signals may be received from a receiver associated with an HDMI sink. In one aspect, the HPD and Utility optical signals are received by photodetectors 2018 and converted into corresponding HPD and Utility electrical signals. The HPD and Utility signals may be encoded in a suitable format. In one aspect, optical communication channel 1840 is comprised of one or more optical fibers. Accordingly, each optical fiber in optical communication channel may be connected downstream to a photodetector included in photodetectors 2018. In other words, photodetectors 2018 may include a number of photodetectors that is equal to the number of optical fibers in optical communication channel 1840. Each photodetector converts an electrically-encoded signal (i.e., encoded HPD and Utility optical signals) from the HDMI sink, and converts the associated optical signal into a corresponding electrical signal.

In one aspect, encoder/decoder 2022 receives the encoded HPD and Utility electrical signals from photodetectors 2018, and decodes the HPD and Utility electrical signals. Encoder/decoder 2022 outputs the decoded HPD and Utility electrical signals. The decoded Utility electrical signal may be transmitted to Utility terminal 2030 via low-speed switch 2042. The decoded HPD electrical signal may be transmitted to HPD terminal 2032. The Utility and HPD signals are transmitted to the HDMI source via Utility terminal 2030 and HPD terminal 2032, respectively.

In one aspect, a +5V signal 2306 and associated ground (GND) triggering signal are transmitted by transmitter 2308 to a connected HDMI sink.

In one aspect, direction control circuit low-speed interface 2300 may be combined with direction control circuit high-speed interface 2100 to implement a combination of direction control circuit 1704, receiver 1708, and transmitter 1712.

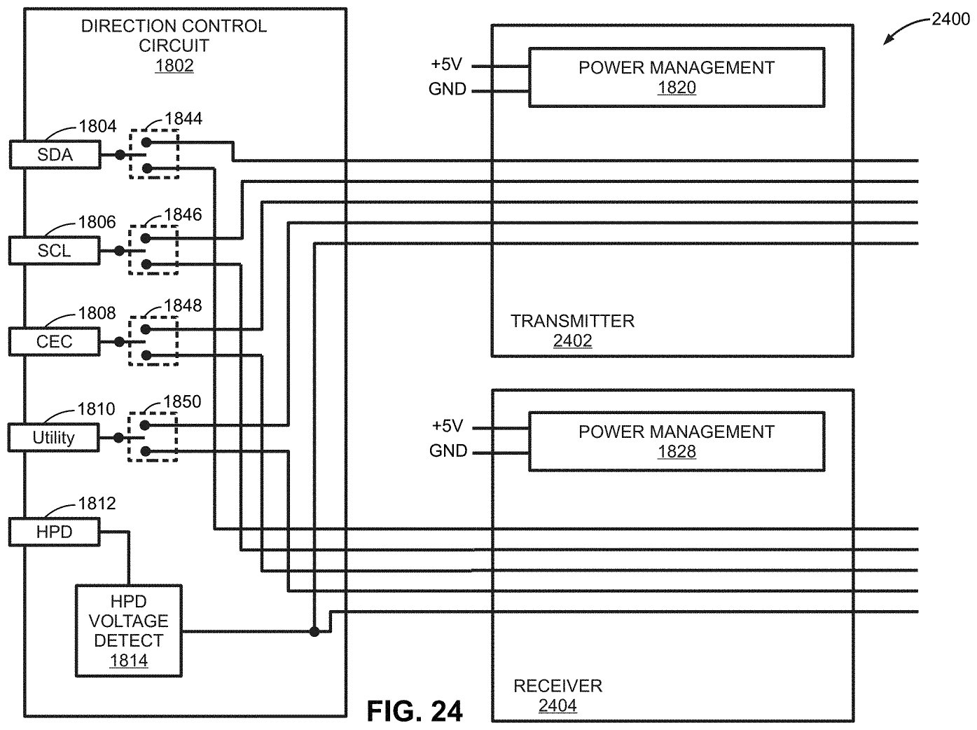

FIG. 24 is a block diagram depicting an embodiment of a direction control circuit low-speed interface 2400. As depicted, direction control circuit low-speed 2400 interface includes direction control circuit 1802, transmitter 2402, and receiver 2404. Direction control circuit 1802 further includes SDA terminal 1804, SCL terminal 1806, CEC terminal 1808, Utility terminal 1810, HPD terminal 1812, HPD voltage detect 1814, and low-speed switches 1844, 1846, 1848, and 1850. Transmitter 2402 further includes power management 1820. Receiver 2404 further includes power management 1828. In one aspect, each of low-speed switch 1844 through 1850 is a low-speed single-pole, double-throw (SPDT) switch.

In one aspect, direction control circuit 1802 may be similar to direction control circuit 1702. When direction control circuit 1802 is connected to an HDMI receptacle of an HDMI source or an HDMI sink, HPD voltage detect 1814 functions as a hot-plug detection (HPD) circuit. Specifically, HPD voltage detect 1814 monitors a hot-plug voltage associated with the HDMI receptacle. If this voltage is low, then HPD voltage detect 1814 determines that the HDMI connection associated with direction control circuit 1802 is to an HDMI source. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to transmitter 2402. In this mode, an SDA electrical signal from the HDMI source via SDA terminal 1804 and via switch 1844, an SCL electrical signal from the HDMI source via SCL terminal 1806 and via switch 1846, and an CEC electrical signal from the HDMI source via CEC terminal 1808 via switch 1848 are each transmitted via an electrical conductor (e.g., an electrically-conducting wire), to a receiver. The set of electrical conductors transmitting the electrical SDA, SCL, and CEC signals may be routed through transmitter 2402.

In one aspect, transmitter 2402 receives HPD and Utility electrical signals via one or more electrical conductors. The Utility and HPD signals are transmitted to the HDMI source via Utility terminal 1810 and HPD terminal 1812, respectively.

In one aspect, a +5V and associated ground (GND) triggering signal are transmitted by transmitter 2402 to a connected HDMI sink.

If the voltage monitored by HPD voltage detect 1814 is high, then HPD voltage detect 1814 determines that the HDMI connection associated with direction control circuit 1802 is to an HDMI sink. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to receiver 2404. In this mode, receiver 2404 receives a Utility electrical signal from the HDMI sink via Utility terminal 1810 and via switch 1850, and an HPD electrical signal from the HDMI sink via HPD terminal 1812. The Utility electrical signal and the HPD electrical signal may be transmitted using two or more electrical conductors to an HDMI transmitter. In one aspect, the electrical conductors are routed through receiver 2404.

In one aspect, receiver 2404 is configured to receive SDA, SCL, and CEC electrical signals via a plurality of electrical conductors. For example, each of the SDA, SCL, and CEC electrical signal may be received over a single electrical conductor. The SDA electrical signal may be transmitted to SDA terminal 1804 via low-speed switch 1844. The SCL electrical signal may be transmitted to SCL terminal 1806 via low-speed switch 1846. The CEC electrical signal may be transmitted to CEC terminal 1808 via low-speed switch 1848. These SDA, SCL and CEC signals are transmitted to the HDMI sink, via SDA terminal 1804, SCL terminal 1806, and CEC terminal 1808, respectively.

In one aspect, power management 1828 is configured to provide a +5V triggering voltage and ground signal to the HDMI sink. The +5V triggering signal and ground signal function in accordance with the HDMI protocol.

In one aspect, direction control circuit low-speed interface 2400 may be combined with direction control circuit high-speed interface 1900 to implement a combination of direction control circuit 1702, transmitter 1706, and receiver 1710.

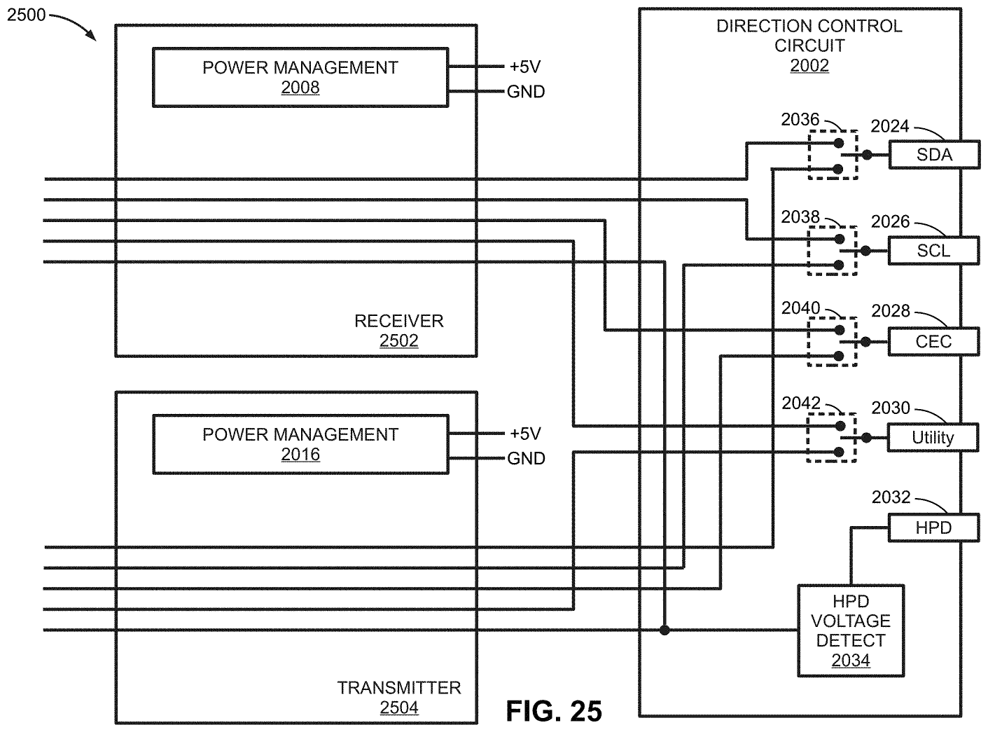

FIG. 25 is a block diagram depicting an embodiment of a direction control circuit low-speed interface 2500. As depicted, direction control circuit low-speed 2500 interface includes direction control circuit 2002, transmitter 2504, and receiver 2502. Direction control circuit 2002 further includes SDA terminal 2024, SCL terminal 2026, CEC terminal 2028, Utility terminal 2030, HPD terminal 2032, HPD voltage detect 2034, and low-speed switches 2036, 2038, 2040, and 2042. Transmitter 2504 further includes power management 2016. Receiver 2502 further includes power management 2008. In one aspect, each of low-speed switch 2036 through 2042 is a low-speed single-pole, double-throw (SPDT) switch.

In one aspect, direction control circuit 2002 may be similar to direction control circuit 1704. When direction control circuit 2002 is connected to an HDMI receptacle of an HDMI source or an HDMI sink, HPD voltage detect 2034 functions as a hot-plug detection (HPD) circuit. Specifically, HPD voltage detect 2034 monitors a hot-plug voltage associated with the HDMI receptacle. If this voltage is high, then HPD voltage detect 2034 determines that the HDMI connection associated with direction control circuit 2002 is to an HDMI sink. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to receiver 2502. In this mode, receiver 2502 receives a Utility electrical signal from the HDMI sink via Utility terminal 2030 and via switch 2042, and an HPD electrical signal from the HDMI sink via HPD terminal 2032. Receiver 2502 transmits the Utility and HPD electrical signals via two or more conductors to a transmitter. In one aspect, each of the Utility and HPD electrical signals is transmitted over a separate conductor.

In one aspect, receiver 2502 is configured to receive SDA, SCL, and CEC electrical signals via a plurality of electrical conductors. For example, each of the SDA, SCL, and CEC electrical signal may be received over a single electrical conductor. The SDA electrical signal may be transmitted to SDA terminal 2024 via low-speed switch 2036. The SCL electrical signal may be transmitted to SCL terminal 2026 via low-speed switch 2038. The CEC electrical signal may be transmitted to CEC terminal 2028 via low-speed switch 2040. These SDA, SCL and CEC signals are transmitted to the HDMI sink, via SDA terminal 2024, SCL terminal 2026, and CEC terminal 2030, respectively.

In one aspect, power management 2008 is configured to provide a +5V triggering voltage and ground signal to the HDMI sink. The +5V triggering signal and ground signal function in accordance with the HDMI protocol.

If the voltage monitored by HPD voltage detect 2034 is low, then HPD voltage detect 2034 determines that the HDMI connection associated with direction control circuit 2002 is to an HDMI source. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to transmitter 2504. In this mode, transmitter 2504 receives an SDA electrical signal from the HDMI source via SDA terminal 2024 and via switch 2036, an SCL electrical signal from the HDMI source via SCL terminal 2026 and via switch 2038, and an CEC electrical signal from the HDMI source via CEC terminal 2028 via switch 2040.

In one aspect, transmitter 2504 receives HPD and Utility electrical signals via one or more electrical conductors. The Utility and HPD signals are transmitted to the HDMI source via Utility terminal 2030 and HPD terminal 2032, respectively.

In one aspect, power management 2016 is configured to provide a +5V triggering voltage and ground signal to the HDMI source. The +5V triggering signal and ground signal function in accordance with the HDMI protocol.

In one aspect, direction control circuit low-speed interface 2500 may be combined with direction control circuit high-speed interface 1900 to implement a combination of direction control circuit 1704, transmitter 1708, and receiver 1712.

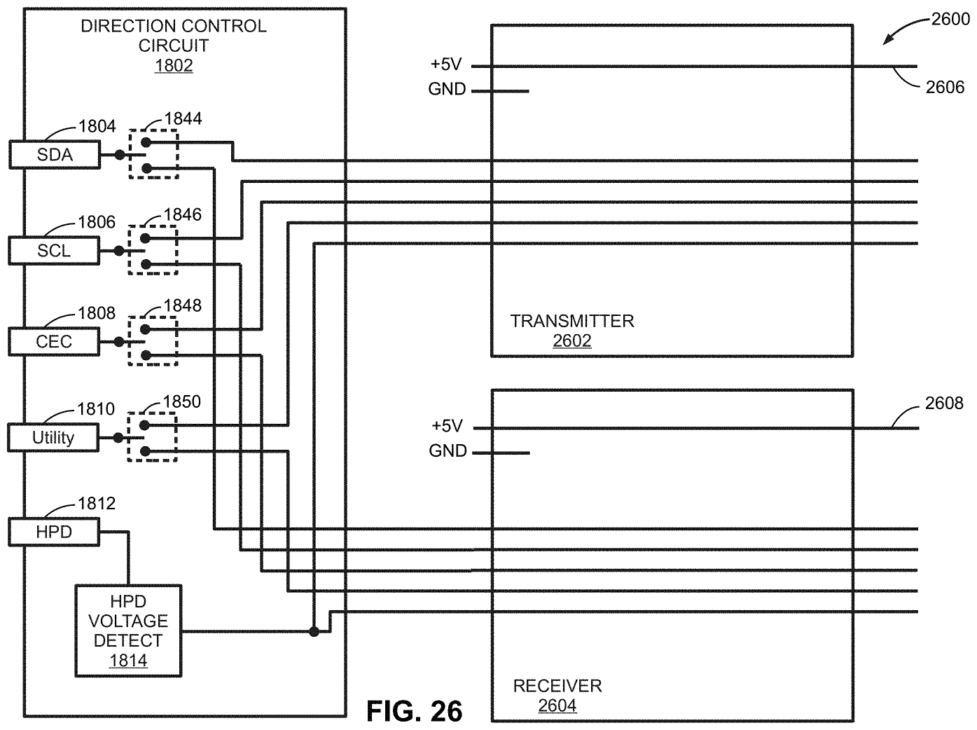

FIG. 26 is a block diagram depicting an embodiment of a direction control circuit low-speed interface 2600. As depicted, direction control circuit low-speed 2600 interface includes direction control circuit 1802, transmitter 2602, and receiver 2604. Direction control circuit 1802 further includes SDA terminal 1804, SCL terminal 1806, CEC terminal 1808, Utility terminal 1810, HPD terminal 1812, HPD voltage detect 1814, and low-speed switches 1844, 1846, 1848, and 1850. In one aspect, each of low-speed switch 1844 through 1850 is a low-speed single-pole, double-throw (SPDT) switch.

In one aspect, direction control circuit 1802 may be similar to direction control circuit 1702. When direction control circuit 1802 is connected to an HDMI receptacle of an HDMI source or an HDMI sink, HPD voltage detect 1814 functions as a hot-plug detection (HPD) circuit. Specifically, HPD voltage detect 1814 monitors a hot-plug voltage associated with the HDMI receptacle. If this voltage is low, then HPD voltage detect 1814 determines that the HDMI connection associated with direction control circuit 1802 is to an HDMI source. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to transmitter 2602. In this mode, an SDA electrical signal from the HDMI source via SDA terminal 1804 and via switch 1844, an SCL electrical signal from the HDMI source via SCL terminal 1806 and via switch 1846, and an CEC electrical signal from the HDMI source via CEC terminal 1808 via switch 1848 are each transmitted via an electrical conductor (e.g., an electrically-conducting wire), to a receiver. The set of electrical conductors transmitting the electrical SDA, SCL, and CEC signals may be routed through transmitter 2602.

In one aspect, transmitter 2602 receives HPD and Utility electrical signals via one or more electrical conductors. The Utility and HPD signals are transmitted to the HDMI source via Utility terminal 1810 and HPD terminal 1812, respectively.

In one aspect, a +5V and associated ground (GND) triggering signal are transmitted by transmitter 2604 to a connected HDMI sink.

If the voltage monitored by HPD voltage detect 1814 is high, then HPD voltage detect 1814 determines that the HDMI connection associated with direction control circuit 1802 is to an HDMI sink. In this case, each of low-speed switch 1844, 1846, 1848 and 1850 is switched by direction control circuit 1802 to connect SDA terminal 1804, SCL terminal 1806, CEC terminal 1808, and Utility terminal 1810 respectively, to receiver 2604. In this mode, receiver 2604 receives a Utility electrical signal from the HDMI sink via Utility terminal 1810 and via switch 1850, and an HPD electrical signal from the HDMI sink via HPD terminal 1812. The Utility electrical signal and the HPD electrical signal may be transmitted using two or more electrical conductors to an HDMI transmitter. In one aspect, the electrical conductors are routed through receiver 2604.

In one aspect, receiver 2604 is configured to receive SDA, SCL, and CEC electrical signals via a plurality of electrical conductors. For example, each of the SDA, SCL, and CEC electrical signal may be received over a single electrical conductor. The SDA electrical signal may be transmitted to SDA terminal 1804 via low-speed switch 1844. The SCL electrical signal may be transmitted to SCL terminal 1806 via low-speed switch 1846. The CEC electrical signal may be transmitted to CEC terminal 1808 via low-speed switch 1848. These SDA, SCL and CEC signals are transmitted to the HDMI sink, via SDA terminal 1804, SCL terminal 1806, and CEC terminal 1808, respectively.

In one aspect, a +5V and associated ground (GND) triggering signal are received by receiver 2604 from a connected HDMI source.

In one aspect, direction control circuit low-speed interface 2600 may be combined with direction control circuit high-speed interface 1900 to implement a combination of direction control circuit 1702, transmitter 1706, and receiver 1710.

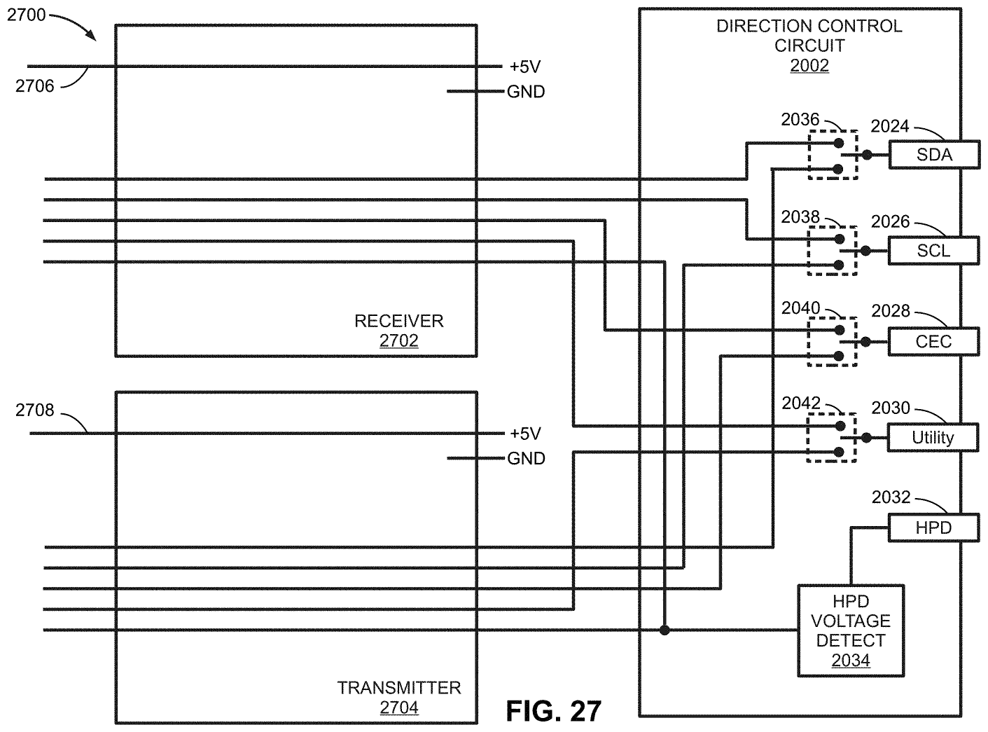

FIG. 27 is a block diagram depicting an embodiment of a direction control circuit low-speed interface 2700. As depicted, direction control circuit low-speed 2700 interface includes direction control circuit 2002, transmitter 2704, and receiver 2702. Direction control circuit 2002 further includes SDA terminal 2024, SCL terminal 2026, CEC terminal 2028, Utility terminal 2030, HPD terminal 2032, HPD voltage detect 2034, and low-speed switches 2036, 2038, 2040, and 2042. In one aspect, each of low-speed switch 2036 through 2042 is a low-speed single-pole, double-throw (SPDT) switch.

In one aspect, direction control circuit 2002 may be similar to direction control circuit 1704. When direction control circuit 2002 is connected to an HDMI receptacle of an HDMI source or an HDMI sink, HPD voltage detect 2034 functions as a hot-plug detection (HPD) circuit. Specifically, HPD voltage detect 2034 monitors a hot-plug voltage associated with the HDMI receptacle. If this voltage is high, then HPD voltage detect 2034 determines that the HDMI connection associated with direction control circuit 2002 is to an HDMI sink. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to receiver 2702. In this mode, receiver 2702 receives a Utility electrical signal from the HDMI sink via Utility terminal 2030 and via switch 2042, and an HPD electrical signal from the HDMI sink via HPD terminal 2032. Receiver 2702 transmits the Utility and HPD electrical signals via two or more conductors to a transmitter. In one aspect, each of the Utility and HPD electrical signals is transmitted over a separate conductor.

In one aspect, receiver 2702 is configured to receive SDA, SCL, and CEC electrical signals via a plurality of electrical conductors. For example, each of the SDA, SCL, and CEC electrical signal may be received over a single electrical conductor. The SDA electrical signal may be transmitted to SDA terminal 2024 via low-speed switch 2036. The SCL electrical signal may be transmitted to SCL terminal 2026 via low-speed switch 2038. The CEC electrical signal may be transmitted to CEC terminal 2028 via low-speed switch 2040. These SDA, SCL and CEC signals are transmitted to the HDMI sink, via SDA terminal 2024, SCL terminal 2026, and CEC terminal 2028, respectively.

In one aspect, a +5V signal 2706 and associated ground (GND) triggering signal are received by receiver 2702 from a connected HDMI source.

If the voltage monitored by HPD voltage detect 2034 is low, then HPD voltage detect 2034 determines that the HDMI connection associated with direction control circuit 2002 is to an HDMI source. In this case, each of low-speed switch 2036, 2038, 2040 and 2042 is switched by direction control circuit 2002 to connect SDA terminal 2024, SCL terminal 2026, CEC terminal 2028, and Utility terminal 2030 respectively, to transmitter 2504. In this mode, transmitter 2704 receives an SDA electrical signal from the HDMI source via SDA terminal 2024 and via switch 2036, an SCL electrical signal from the HDMI source via SCL terminal 2026 and via switch 2038, and an CEC electrical signal from the HDMI source via CEC terminal 2028 via switch 2040.

In one aspect, transmitter 2704 receives HPD and Utility electrical signals via one or more electrical conductors. The Utility and HPD signals are transmitted to the HDMI source via Utility terminal 2030 and HPD terminal 2032, respectively.

In one aspect, a +5V signal 2708 and associated ground (GND) triggering signal are transmitted by transmitter 2704 to a connected HDMI sink.

In one aspect, direction control circuit low-speed interface 2700 may be combined with direction control circuit high-speed interface 1900 to implement a combination of direction control circuit 1704, transmitter 1708, and receiver 1712.

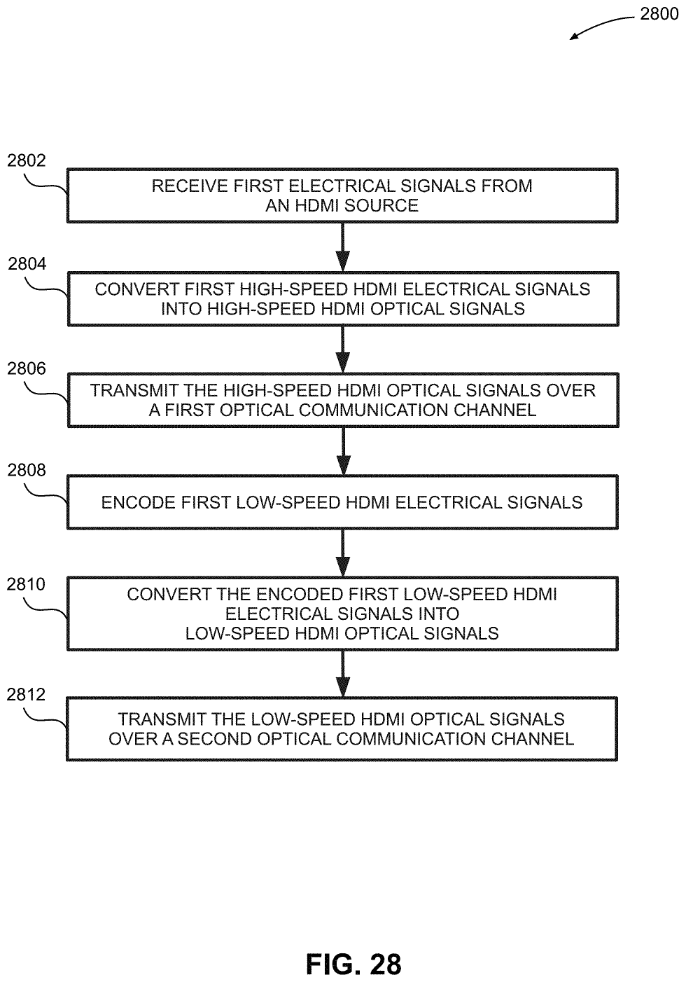

FIG. 28 is a flow diagram depicting a method 2800 to transmit high-speed HDMI optical signals and low-speed HDMI optical signals. Method 2800 may include receiving first electrical signals from an HDMI source (2802). For example, receiver 1706 may receive high-speed and low-speed HDMI electrical signals (e.g., SDA, SCL, and CEC low-speed HDMI electrical signals, and TMDS0/1/2/3+—high-speed HDMI electrical signals).

Method 2800 may include converting the first high-speed HDMI electrical signals into high-speed HDMI optical signals (2804). For example, a combination of TMDS TX 1306 and VCSEL 1308 through TMDS TX 1330 and VCSEL 1332 may convert high-speed HDMI electrical signals (i.e., TMDS differential signals) into corresponding optical signals.

Method 2800 may include transmitting the high-speed HDMI optical signals over a first optical communication channel (2806). For example, optical transmitter 1302 may transmit high-speed HDMI optical signals over an optical communication channel comprising optical communication channels 1310, 1318, 1326, and 1334.

Method 2800 may include encoding the first low-speed HDMI electrical signals (2808). For example, encoder/decoder 1338 may encode SDA, SCL, and CEC HDMI low-speed electrical signals received from an HDMI source.

Method 2800 may include converting the encoded first low-speed HDMI electrical signals into low-speed HDMI optical signals (2810). For example, VCSEL array 1340 may convert encoded SDA, SCL, and CEC HDMI electrical signals into corresponding low-speed HDMI optical signals.

Method 2800 may include transmitting the low-speed HDMI optical signals over a second optical communication channel (2012). For example, VCSEL array 1340 may transmit the SDA, SCL, and CEC HDMI optical signals over optical fiber array 1344.

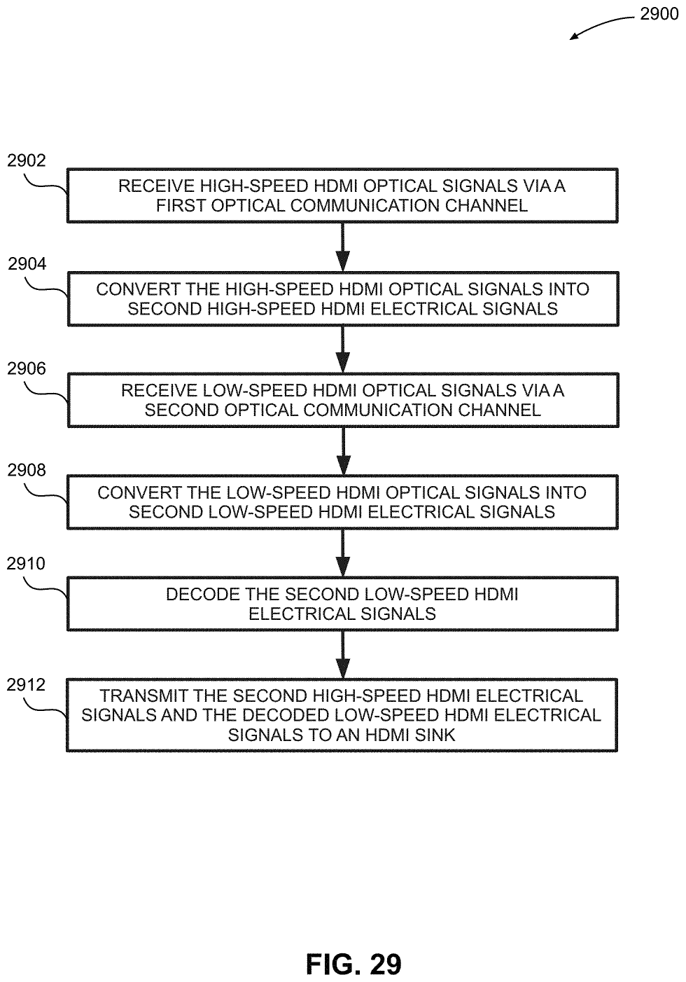

FIG. 29 is a flow diagram depicting a method 2900 to receive high-speed HDMI optical signals and low-speed HDMI optical signals. Method 2900 may include receiving high-speed HDMI optical signals via a first optical communication channel (2902). For example, receiver 1402 may receive high-speed HDMI optical signals (i.e., TMDS optical signals) over an optical communication channel comprising optical communication channels 1310, 1318, 1326, and 1334.

Method 2900 may include converting the high-speed HDMI optical signals into second high-speed HDMI electrical signals (2904). For example, a combination of photodetector 1406 and TMDX RX 1408 through photodetector 1418 through TMDS RX 1420 may convert high-speed HDMI optical signals into TMDS0/1/2/3+/− differential electrical signals.

Method 2900 may include receiving low-speed HDMI optical signals via a second optical communication channel (2906). For example, optical receiver 1402 may receive optical SDA, SCL, and CEC signals via optical fiber array 1344.

Method 2900 may include converting the low-speed HDMI optical signals into second low-speed HDMI electrical signals (2908). For example, photodetector array 1422 may convert the optical SDA, SCL and CEC signals to a corresponding set of SDA, SCL, and CEC electrical signals. In one aspect, this set of SDA, SCL and CEC electrical signals is encoded in a specific format.

Method 2900 may include decoding the second low-speed HDMI electrical signals (2910). For example, encoder/decoder 1426 may decode the encoded SDA, SCL and CEC electrical signals to generated decoded SDA, SCL, and CEC electrical signals.

Method 2900 may include transmitting the second high-speed HDMI electrical signals and the decoded low-speed HDMI electrical signals to an HDMI sink (2912). For example, the TMDS electrical signals output by TMDS RX 1408 through TMDS RX 1420 may transmitted to an HDMI sink. Also, the SDA, SCL and CEC electrical signals output by receiver 1402 may be transmitted to the HDMI sink.

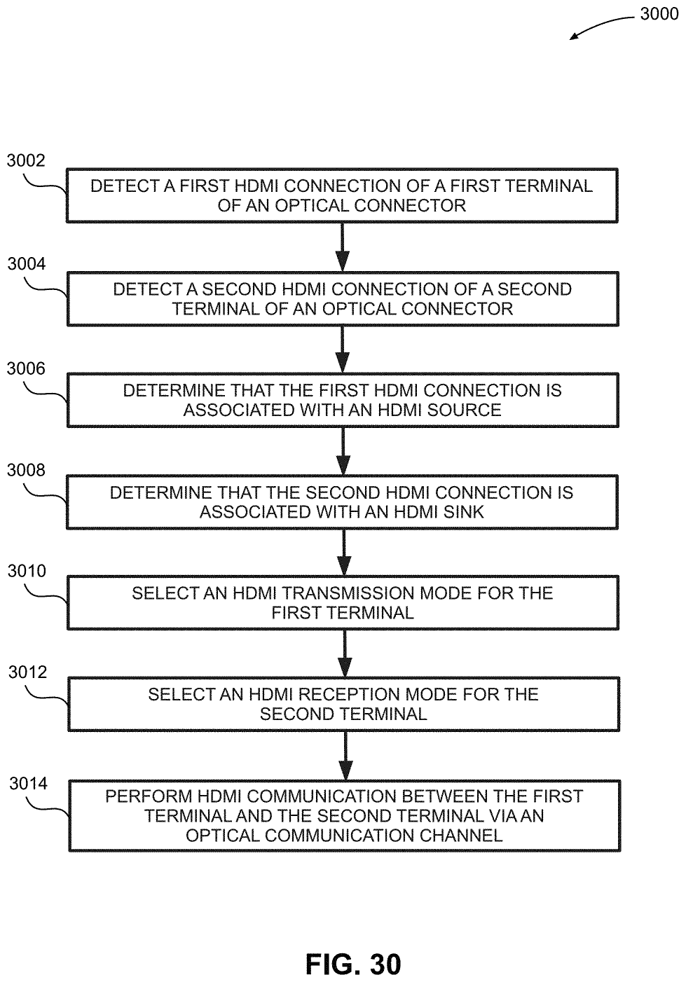

FIG. 30 is a flow diagram depicting a method 3000 to perform HDMI communication via an optical communication channel. Method 3000 may include detecting a first HDMI connection of a first terminal of an optical connector (3002). For example, direction control circuit 1702 may detect an HDMI connection of an HDMI terminal associated with direction control circuit 1702. The HDMI terminal associated with direction control circuit 1702 may be selectable between a transmission mode and a reception mode.

Method 3000 may include detecting a second HDMI connection of a second terminal of an optical connector (3004). For example, direction control circuit 1704 may detect an HDMI connection of an HDMI terminal associated with direction control circuit 1704. The HDMI terminal associated with direction control circuit 1704 may be selectable between a transmission mode and a reception mode.

Method 3000 may include determining that the first HDMI connection is associated with an HDMI source (3006). For example, direction control circuit 1702 may determine that the first HDMI connection is associated with an HDMI source.

Method 3000 may include determining that the second HDMI connection is associated with an HDMI sink (3008). For example, direction control circuit 1704 may determine that the second HDMI connection is associated with an HDMI sink.

Method 3000 may include selecting an HDMI transmission mode for the first terminal (3010). For example, responsive to determining that the first HDMI connection is associated with the HDMI source, direction control circuit 1702 may select an HDMI transmission mode (i.e., a mode where the first terminal transmits one or more high-speed and low-speed HDMI signals) for the first terminal. This process may also include, for example, configuring the low-speed and high-speed switches associated with direction control circuit 1702 into an HDMI transmission mode. This process may also include activating optical transmitter 1706.

Method 3000 may include selecting an HDMI reception mode for the second terminal (3012). For example, responsive to determining that the second HDMI connection is associated with the HDMI sink, direction control circuit 1704 may select an HDMI reception mode (i.e., a mode where the first terminal receives one or more high-speed and low-speed HDMI signals) for the second terminal. This process may also include, for example, configuring the low-speed and high-speed switches associated with direction control circuit 1704 into an HDMI reception mode. This process may also include activating optical receiver 1708.

Method 3000 may include performing HDMI optical communication between the first terminal and the second terminal via an optical communication channel (3014). For example, direction control circuits 1702 and 1704 may be configured such that HDMI optical communication is performed using optical transmitter 1706 and optical receiver 1708, via communication channel 1714.

As will be understood, the system and methods described herein can operate for interaction with devices such as servers, desktop computers, laptops, tablets, game consoles, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

What is claimed is:

1. A method comprising:
detecting a first HDMI connection of a first terminal of an optical connector, the first terminal being selectable between a transmission mode and a reception mode;
detecting a second HDMI connection of a second terminal of the optical connector, the second terminal being selectable between a transmission mode and a reception mode;
determining that the first HDMI connection is associated with an HDMI source;
determining that the second HDMI connection is associated with an HDMI sink;
responsive to determining that the first HDMI connection is associated with the HDMI source, selecting an HDMI transmission mode for the first terminal;
responsive to determining that the second HDMI connection is associated with the HDMI sink, selecting an HDMI reception mode for the second terminal; and
performing HDMI optical communication between the first terminal and the second terminal via an optical communication channel.

2. The method of claim 1, wherein the HDMI optical communication comprises:
the first terminal receiving first HDMI electrical signals from the HDMI source;
the first terminal converting the first HDMI electrical signals into first HDMI optical signals;
the first terminal transmitting the first HDMI optical signals over the optical communication channel;
the second terminal receiving the first HDMI optical signals over the optical communication channel;
the second terminal converting the first HDMI optical signals into corresponding second HDMI electrical signals; and
the second terminal transmitting the second HDMI electrical signals to the HDMI sink.

3. The method of claim 2, wherein the first HDMI electrical signals include high-speed HDMI electrical signals and low-speed HDMI electrical signals.

4. The method of claim 2, wherein the converting the first HDMI electrical signals into first HDMI optical signals is performed by a laser diode.

5. The method of claim 2, wherein the converting the first HDMI optical signals into corresponding second HDMI electrical signals is performed by a photodetector.

6. The method of claim 1, wherein the HDMI optical communication comprises:
the second terminal receiving third HDMI electrical signals from the HDMI sink;
the second terminal converting the third HDMI electrical signals into second HDMI optical signals;
the second terminal transmitting the second HDMI optical signals over a reverse optical communication channel;
the first terminal receiving the second HDMI optical signals over the reverse optical communication channel;
the first terminal converting the second HDMI optical signals into corresponding fourth HDMI electrical signals; and
the first terminal transmitting the fourth HDMI electrical signals to the HDMI source.

7. The method of claim 6, wherein the third HDMI electrical signals are low-speed HDMI electrical signals.

8. The method of claim 6, wherein the converting the third HDMI electrical signals into second HDMI optical signals is performed by a laser diode.

9. The method of claim 6, wherein the converting the second HDMI optical signals into corresponding fourth HDMI electrical signals is performed by a photodetector.

10. An optical connector comprising:
a first terminal comprising:
a first direction control circuit; and
a first optical transmitter electrically connected to the first direction control circuit;
a second terminal comprising:
a second direction control circuit; and
a second optical receiver electrically connected to the second direction control circuit; and
a first optical communication channel optically connecting the first optical transmitter to the second optical receiver, wherein the first direction control circuit detects a first HDMI connection of the first terminal, wherein the first terminal is selectable between a transmission mode and a reception mode, wherein the second direction control circuit detects a second HDMI connection of the second terminal, wherein the second terminal is selectable between a transmission mode and a reception mode, wherein the first direction control circuit determines that the first HDMI connection is associated with an HDMI source, wherein the second direction control circuit determines that the second HDMI connection is associated with an HDMI sink, wherein responsive to determining that the first HDMI connection is associated with the HDMI source, the first direction control circuit selects an HDMI transmission mode for the first terminal, wherein responsive to determining that the second HDMI connection is associated with the HDMI sink, the second direction control circuit selects an HDMI reception mode for the second terminal, and wherein the first optical transmitter and the second optical receiver perform HDMI optical communication via the first optical communication channel.

11. The optical cable of claim 10, wherein the first direction control circuit receives first HDMI electrical signals from the HDMI source, wherein the first direction control circuit transmits the first HDMI electrical signals to the first optical transmitter, wherein the first optical transmitter converts the first HDMI electrical signals into first HDMI optical signals, wherein the first optical transmitter transmits the first HDMI optical signals over the first optical communication channel, wherein the second optical receiver receives the first HDMI optical signals over the first optical communication channel, wherein the second optical receiver converts the first HDMI optical signals into corresponding second HDMI electrical signals, wherein the second optical receiver transmits the second HDMI electrical signals to the second direction control circuit, and wherein the second direction control circuit transmits the second HDMI electrical signals to the HDMI sink.

12. The optical cable of claim 11, further comprising a laser diode included in the first optical transmitter, wherein the laser diode converts the first HDMI electrical signals into the first HDMI optical signals.

13. The optical cable of claim 11, further comprising a photodetector included in the second optical receiver, wherein the photodetector converts the first HDMI optical signals into the second HDMI electrical signals.

14. The optical cable of claim 11, wherein the first HDMI electrical signals include high-speed HDMI signals and low-speed HDMI signals.

15. The optical cable of claim 14, wherein each of the first direction control circuit and the second direction control circuit includes one or more high-speed switches configured to transmit the respective high-speed HDMI signals, and one or more low-speed switches configured to transmit the respective low-speed HDMI signals.

16. The optical cable of claim 14, wherein the high-speed switches and low-speed switches are implemented as any combination of radio-frequency switches, MEMS switches, relay switches, and transmission gates.

17. The optical cable of claim 10, further comprising:
a first optical receiver included in the first terminal and electrically connected to the first direction control circuit;
a second optical transmitter included in the second terminal and electrically connected to the second direction control circuit; and
a second optical communication channel optically connecting the second optical transmitter to the first optical receiver, wherein the second direction control circuit receives third HDMI electrical signals from the HDMI sink, wherein the second direction control circuit transmits the third HDMI electrical signals to the second optical transmitter, wherein the second optical transmitter converts the third HDMI electrical signals into second HDMI optical signals, wherein the second optical transmitter transmits the second HDMI optical signals over the second optical communication channel, wherein the first optical receiver receives the second HDMI optical signals over the second optical communication channel, wherein the first optical receiver converts the second HDMI optical signals into corresponding fourth HDMI electrical signals, wherein the first optical receiver transmits the fourth HDMI electrical signals to the first direction control circuit, and wherein the first direction control circuit transmits the fourth HDMI electrical signals to the HDMI source.

18. The optical cable of claim 17, further comprising a laser diode included in the second optical transmitter, wherein the laser diode converts the third HDMI electrical signals into the second HDMI optical signals.

19. The optical cable of claim 17, further comprising a photodetector included in the first optical receiver, wherein the photodetector converts the second HDMI optical signals into the fourth HDMI electrical signals.

20. The optical cable of claim 17, wherein the third HDMI electrical signals low-speed HDMI signals.
